(19) United States
(12) Patent Application Publication
(10) Pub. No.: US 2013/0315972 A1
(43) Pub. Date: Nov. 28, 2013

(54) COMPOSITIONS AND METHODS FOR ANTIMICROBIAL METAL NANOPARTICLES

(71) Applicant: AGIENIC, INC., Wilmington, DE (US)

(72) Inventors: Nicholas R. Krasnow, Tucson, AZ (US); Lori L. Adams, Oro Valley, AZ (US); John P. Cronin, Tucson, AZ (US); Ryan J. Reeser, Tucson, AZ (US); Anoop Agrawal, Tucson, AZ (US); Donald R. Uhlmann, Tucson, AZ (US)

(73) Assignee: AGIENIC, INC., Wilmington, DE (US)

(21) Appl. No.: 13/685,379

(22) Filed: Nov. 26, 2012

Related U.S. Application Data
(63) Continuation-in-part of application No. 13/480,367, filed on May 24, 2012.

(51) Int. Cl. A01N 25/12; A01N 59/20; A01N 59/16

(52) U.S. Cl. CPC A01N 25/12; A01N 59/16; A01N 59/20
USPC 424/409; 424/618; 424/405; 424/638

(57) ABSTRACT

Compositions having antimicrobial activity contain particles comprising at least one inorganic copper salt; and at least one functionalizing agent in contact with the particles, the functionalizing agent stabilizing the particle in a carrier such that an antimicrobially effective amount of ions are released into the environment of a microbe. The average size of the particles ranges from about 1000 nm to about 3 nm. Preferred copper salts include copper iodide, copper bromide and copper chloride, most preferred being copper iodide. Preferred functionalizing agents comprise materials with a molecular weight of 60 or above, which include amino acids, other acidic materials, thiols, hydrophilic polymers, emulsions of hydrophobic polymers and surfactants. The functionalized particles are preferably made by a grinding process.

### CROSS REFERENCE TO RELATED APPLICATIONS

This application is a continuation-in-part of our co-pending U.S. application Ser. No. 13/480,367, filed May 24, 2012, which application in turn claims priority to U.S. Provisional Patent Application Ser. No. 61/519,523, filed May 24, 2011 and U.S. Provisional Patent Application Ser. No. 61/582,322 filed Dec. 31, 2011, the contents of which are incorporated herein by reference in their entirety.

### FIELD OF THE INVENTION

The invention relates to functionalized antimicrobial compositions comprising fine particles of inorganic copper salts, their preparation, combinations of fine copper-based particles with metal and other metal salt nanoparticles, application of the compositions to surfaces and methods of preparation and use.

### BACKGROUND OF THE INVENTION

The antimicrobial effect of various metals and their salts has been known for centuries. Hippocrates wrote that silver had beneficial healing and anti-disease properties, and the Phoenicians stored water, wine, and vinegar in silver bottles to prevent spoiling. In the early 20th century, silver coins were put in milk bottles to prolong the milk's freshness. Its germicidal effects increased its value in utensils and as jewelry. The exact process of silver's germicidal effect is still not entirely understood, although theories exist. One of these is the “oligodynamic effect,” which qualitatively explains the effect on some microorganisms, but cannot explain antiviral effects. Silver is widely used in topical gels and impregnated into bandages because of its wide-spectrum antimicrobial activity.

The oligodynamic effect is demonstrated by other metals, specifically gold, silver, copper, zinc, and bismuth. Copper is one such metal. Copper has long been used as a biostatic surface to line the bottoms of ships to protect against barnacles and mussels. It was originally used in pure form, but has since been superseded by brass and other alloys due to their lower cost and higher durability. Bacteria will not grow on a copper surface because it is biostatic. Copper alloys have become important netting materials in the aquaculture industry for the fact that they are antimicrobial and prevent biofouling and have strong structural and corrosion-resistant properties in marine environments. Organic compounds of copper are useful for preventing fouling of ships' hulls. Copper alloy touch surfaces have recently been investigated as antimicrobial surfaces in hospitals for decreasing transmission of nosocomial infections.

The antimicrobial properties of silver stem from the chemical properties of its ionized form, Ag⁺, and several mechanisms have been proposed to explain this effect. For example, silver ions form strong molecular bonds with other substances used by bacteria to respire, such as enzymes containing sulfur, nitrogen, and oxygen. When the Ag⁺ ion forms a complex with these biomolecules, they are rendered inactive, depriving them of necessary activity and eventually leading to the bacteria's death. Silver ions can also complex with bacterial DNA, impairing the ability of the microorganisms to reproduce. The mechanism for copper ions, on the other hand, is not so well understood. Numerous scientific investigations have focused on the role of the metal form of copper, and have concluded that multiple mechanisms may be possible for copper's antimicrobial effect, including increased production of reactive oxidation species such as singlet oxygen and hydroxide radicals, covalent binding of copper metal to reactive sites in enzymes and co-factors, interference with lipid bilayer transport proteins, and interaction of copper ions with moieties of microorganisms analogous to what have been proposed for silver ions.

It is clear that silver and its various compounds and salts have been the overwhelming favorite in terms of its use as an antimicrobial agent. However, silver in the form of the silver halides silver iodide, silver bromide and silver chloride is well-known to be light-sensitive and was used for many years in photography. Copper, aside from its use in preserving marine objects such as ship hulls, has not generally been used in antimicrobial compounds.

Provision of the oligodynamic metal species in the form of fine particles, including the form of nanoparticles, avoids problems such as settling of the particles in solutions—but introduces a complication in trying to estimate the solubility for a given small particle size or the concentration of free ions produced by contact of specific aqueous solutions with a given set of nanometal particles, in addition to the ubiquitous issue of agglomeration. Use of oligodynamic metal species in the form of nanoparticles introduces a further observation—viz., based on several reports in the literature, such particles may under some (generally unspecified) conditions be taken up by the outer membranes of pathogens and transported into the bodies of the pathogens. In many cases, it is expected that this observation would be advantageous for the antimicrobial effectiveness of the metal species.

It is presently unknown under what precise conditions does such penetration by specific nanoparticles of oligodynamic materials take place; and it is certainly unknown what conditions (including particle size and chemistry) promote or mitigate against such penetration. What is needed are better broad-spectrum antimicrobial compositions that may better target oligodynamic metal compounds to microbes and other pathogens.

### SUMMARY OF THE INVENTION

The inventors associated with this patent have made the surprising discovery that particles of certain copper salts have much greater efficacy against a broad range of microbes, including viruses, molds and fungi, than similar silver-based antimicrobial particles. In particular, it has been discovered that copper salts including the copper halide copper iodide (“CuI”), when formulated in accordance with the teachings herein, is surprisingly effective as a broad-spectrum, fast-acting antimicrobial agent.

Another aspect of this surprising discovery is the finding that functionalizing the surfaces of the antimicrobial particles increases both their efficacy and their utility by making them compatible with many types of articles of manufacture and the processes used to make such articles. Further, it has been found that appropriate choice of the functionalization may provide additional properties such as UV stabilization, color, etc. In addition, it has been found that surface functionalization also assists in controlling the size of the particles during their manufacture and in enhancing stability of these particles in the media into which they are incorporated.

Yet another aspect of this surprising discovery is the finding of making the functionalized particles by a wet grinding operation wherein the functionalization materials are incorporated into the grinding medium or incorporated soon after the grinding operation. There are many advantages of the grinding process which include: (a) increased yield both in terms of amount and the concentration of the particles produced; (b) scalability on an industrial scale, (c) reduced waste both in terms of hazardous chemicals and solvents and also in terms of additional equivalents of starting materials that are typically required in chemical synthesis methods; (d) reduced energy requirements in terms of simplified processes and lower need for handling, removal and drying of solvents relative to the amount of the material produced; (e) reduced cost of production while adopting “clean and green” manufacturing methods due to elimination or lower use of hazardous chemicals and lower energy requirements; (f) increased versatility of the wet grinding method in terms of chemistry of the functionalizing agent that is used; (g) new capability of being able to use more than one functionalization agent with different properties; (h) imparting additional attributes to the antimicrobial materials via the functionalization agents; (i) enhanced ability to tune/control the size of the resulting particles from a few nanometers to 1,000 nm or above; (j) increased ability to produce fine particles without introducing undesirable amounts of functionalization agents.

A first embodiment of the invention is directed to a composition having antimicrobial activity comprising particles comprising at least one copper salt; and at least one functionalizing agent in contact with the particles, the functionalizing agent stabilizing the particles in a carrier such that an antimicrobially effective amount of ions are released into the environment of a microbe. The functionalizing agent acts to complex the particles thereby stabilizing them in the liquid. Preferably, the molecular weight of the functionalizing agent is greater than 60. In some embodiments, the carrier is a liquid, which may be water-based or oil-based. In the liquid carrier embodiment, the particles are suspended by the liquid carrier in solution. In other embodiments the carrier is a solid such as a solid coating or a thermosetting or a thermoplastic. In another embodiment, the surface functionalized particles may be dried to a solid form. Yet in another embodiment, the solidified form of the particles and the functionalization agents, should result in composite particles containing a number of functionalized particles with an average size of greater than 1 microns, preferably greater than 10 microns and most preferably greater than 100 microns. In a further embodiment, additional ingredients may be added to the liquid suspensions before drying so that this additive assists in and provides a body to form the composite particles. In a further embodiment, when these composite particles are redispersed in a liquid or a solid matrix, the composite particles break up into smaller particles and redisperse uniformly in the matrix. In another embodiment, the copper salt comprises a copper halide salt. In other embodiments the halide is selected from the group consisting of iodide, bromide and chloride, and a particularly preferred embodiment is copper iodide (CuI). Preferably the average size of such particles ranges from about 1000 nm to as small as 3 nm. In further embodiments, the particles have average sizes of less than about 300 nm, 100 nm, 30 nm or even less than about 10 nm. In yet further embodiments, the copper halide has a solubility of less than 100 mg/liter in water, or even less than 15 mg/liter in water.

Another embodiment is directed to a composition having antimicrobial activity comprising particles comprising at least one copper salt selected from the group consisting of to CuI, CuBr and CuCl and having an average size of about 1000 nm or less; at least one functionalizing agent in contact with said particles, said functionalizing agent being present in a preferred weight ratio (functionalization agent to inorganic copper salt) of from about 100:1 to about 1:100, and a preferred range being from 20:1 to 1:20.

Embodiments of the invention include functionalizing agents that can include an amino acid, a thiol, a polymer especially a hydrophilic polymer, hydrophobic polymers (especially emulsions of such polymers), surfactants, or a ligand-specific binding agent, or combinations of these agents. Preferred embodiments of amino acid agents include aspartic acid, leucine and lysine; and preferred embodiments of thiol agents include aminothiol, thioglycerol, thioglycine, thiolactic acid, thiomalic acid, thiooctic acid and thiosilane.

Preferred embodiments of hydrophilic polymers include polyvinylpyrollidone, polyethyleneglycol; polyethyleneimine; polyoxyethylenes and their copolymers; polyacrylic acid; polyacrylamide; carboxymethyl cellulose; dextrans and other polysaccharides; starches; guar, xantham and other gums and thickeners; collagen; gelatins; boric acid ester of glycerin and other biological polymers; and copolymers comprising at least one of the monomers which form the said hydrophilic polymers and polymeric blends comprising at least one of the said hydrophilic polymers.

Preferred embodiments of the surfactants include anionic, amphoteric and non-ionic surfactants, and most preferred are anionic surfactants. Other preferred polymers include polyurethanes, acrylic polymers, epoxies, silicones and fluorosilicones, particularly when used as emulsions and solutions during surface modification. Preferred embodiments of the invention utilize copper halides such as CuI, CuBr and CuCl, and most preferred utilize CuI. Other embodiments include more than one type of functionalizing agent, and some preferred combinations include non-polymeric surfactants along with polymers which may be selected from both hydrophobic and hydrophillic materials. Yet further embodiments of the invention include compositions additionally comprising at least one of a silver particle or a silver halide particle. The silver or silver halide particle may be functionalized with a member selected from the group consisting of an amino acid, a thiol, surfactant, a hydrophilic polymer, hydrophobic polymer or a ligand-specific agent. Further embodiments of the silver halide include a halide chosen from iodide, bromide and chloride.

Another embodiment of the invention described herein is a composition having antimicrobial activity made according to the process comprising the steps of obtaining CuI powder; dissolving the CuI powder in a polar nonaqueous solvent; adding an amount of functionalizing agent sufficient to stabilize said CuI in the polar, nonaqueous solvent; removing the solvent sufficient to dry said stabilized CuI particles whereby a functionalizing agent-complexed CuI particle powder is formed; dispersing the functionalizing agent-complexed CuI particle powder in an aqueous solution having a pH of from about 1 to about 6 to form CuI particles stabilized in water; and optionally drying the stabilized CuI particles sufficient to remove the water. Another optional step is to neutralize the pH of the dispersion prior to the optional drying step.

In a further embodiment of the invention, metal compound particles including copper compound powders may also be formed by grinding, particularly wet grinding. Wet grinding is carried out in a liquid medium (aqueous or non-aqueous), where the medium further comprises the surface modifying (functionalization) agents. Another variation in the grinding method is the use of water or water with an acid additive to which a surface functionalization agent is added after the grinding operation is completed.

In a still further embodiment of the invention, the grinding of the antimicrobial compounds in the liquid medium is carried out using beads which are agitated. The beads are preferably less than 1 mm in size and more preferably in a range of about 0.04 to 0.5 mm; In another embodiment of the invention, the beads have a hardness greater than that of the particles being ground by at least 2 units or more on the Moh's scale, preferably at least 3 units or more on Moh's scale. A further embodiment of the invention is directed to a method of inhibiting the growth of microbes on the surface of an article of manufacture comprising coating the antimicrobial composition comprising functionalized particles of a cuprous compound upon the surface in an amount effective to inhibit growth of a microbe. In another embodiment, the functionalized particles thus employed are particles of CuI.

A further embodiment of the invention is a method of inhibiting growth of a microbe comprising the steps of contacting the environs of a microbe with an effective amount of a composition comprising a particle comprising at least one copper salt having an average size of less than about 100 nm; and at least one functionalizing agent in contact with the particle, the functionalizing agent stabilizing the particle in solution such that an antimicrobially effective amount of ions are released into the environment of a microbe.

A further embodiment of the invention is directed to a composition having antimicrobial activity comprising a mixed-metal halide particle comprising at least two different metal cations in the halide particle, and at least one functionalizing agent in contact with the mixed-metal halide particle, the functionalizing agent stabilizing the particle in suspension such that an antimicrobially effective amount of ions are released into the environment of a microbe. The preferred two different metal cations comprise copper cations and at least one type of non-copper cations, and the most preferred comprise copper cations and silver cations. In still further embodiments, the mixed metal halide particles comprise at least two different anions; and in yet further embodiments, the mixed metal halide particles comprise at least two different cations as well as at least two different anions.

A further embodiment of the invention is directed to a composition having antimicrobial activity comprising a mixture of particles comprising particles of an copper salt and particles of at least a second inorganic metal compound; and at least one functionalizing agent in contact with said mixture of particles, said functionalizing agent stabilizing said mixture of particles in a carrier such that an antimicrobially effective amount of ions are released into the environment of the microbe. Preferably the size of such particles is less than about 300 nm; and preferably the copper salt is a copper halide, most preferably copper iodide.

A further embodiment of the invention is directed to a composition having antimicrobial activity made according to the process comprising the steps of forming functionalized particles of a cuprous compound; dispersing the functionalized particles of the cuprous compound particles in a suspending medium; adding a quantity of the dispersed particles of the cuprous compound to a manufacturing precursor; and forming an article of manufacture at least partially from the manufacturing precursor whereby the copper iodide particles are dispersed throughout said article. Preferably the size of such particles is less than about 300 nm. In some cases, the article may be a coating which is applied to a separate article of manufacture to provide antimicrobial benefits. In yet another embodiment the functionalized particles of the cuprous compound are particles of CuI.

A further embodiment of the invention is directed to a composition having antimicrobial activity comprising at least two antimicrobially active ingredients, wherein the first of said ingredients comprises a functionalized copper halide nanoparticle having an average size of less than about 300 nm. The composition also comprises one or more different functionalized metal or inorganic metal compound nanoparticles having antimicrobial activity. Further, the functionalized metal and inorganic metal compounds of the composition may further comprise metals selected from the group consisting of selenium, bismuth, silver, zinc, copper, gold and compounds thereof.

A further embodiment of the invention is directed to a composition having antimicrobial activity comprising one or more metal halides selected from the group consisting of copper halide and silver halide; and a porous carrier particle in which the metal halide or halides is infused, the carrier particle supporting the metal halide such that an antimicrobially effective amount of ions are released into the environment of the microbe. Said carrier particles are preferably porous particles with average size pores in the range of about 2-100 nm, most preferably in the range of about 4-20 nm. Said carrier particles can also have infused metal particles in addition to the infused halide particles. A preferred copper halide is copper iodide.

In another embodiment of the invention, the porous carrier particles containing one or more of copper halide, copper thiocyanate, silver metal and silver halide may be incorporated in matrix materials used as coatings or solid bodies having desirable antimicrobial activity. A preferred copper halide is copper iodide.

In a further embodiment of the invention, the present antimicrobial compositions, whether functionalized particles comprising copper halide nanoparticles or porous carrier particles containing copper halide or copper halide and silver halide nanoparticles or copper halide and silver metal particles may be combined with polymer-containing coating solutions which may be applied by end users to obtain antimicrobial activity in the coated objects. A preferred copper halide is copper iodide.

A further embodiment of the invention is directed to a composition having antimicrobial activity comprising a functionalized copper halide selected from the group consisting of copper iodide, copper bromide, copper chloride and copper thiocyanate; and a porous carrier particle in which said copper halide is infused, said carrier particle supporting said copper halide such that an antimicrobially effective amount of ions are released into the environment of said microbe. A preferred copper halide is copper iodide.

Yet a further embodiment of the invention is directed to an antimicrobial composition comprising one or more antibacterial materials and/or analgesics and further comprising functionalized particles of at least one metal halide, said particles having a preferred average size of less than about 1000 nm. The at least one metal halide is selected from the group consisting of copper halide and silver halide, and the halides are selected from the group consisting of iodide, chloride and bromide. A preferred metal halide is copper iodide. A further embodiment of this invention is directed to organic copper compounds, preferably cuprous salts. A preferred cuprous salt is copper thiocyanate.

A further embodiment of this invention is directed to an antimicrobial composition of coatings and solid bodies wherein the antimicrobial additives cause none or marginal change in their color appearance when they are added to these objects. These antimicrobial materials comprise functionalized particles of at least one copper halide or other inorganic or organic salts of copper, or of at least one metal halide or other salts of copper or silver infused into porous particles. These metal halides and salts should preferably be only faintly colored, This determination is made on bulk powders of these salts and halides for color on a L*a*b* scale. The L* values of the more desirable materials is preferably greater than 60 and more preferably greater than 70. L*a*b* scale is a standard way of quantifying color established in 1976 by the International Commission on Illumination (usually abbreviated CIE for its French name, Commission internationale de l'eclairage). In addition it is also preferred that such salts have low water solubility, preferably less than 100 mg/liter or more preferably less than 15 mg/liter.

Other embodiments are directed to a composition having antimicrobial activity comprising a metal halide selected from the group consisting of copper halide and silver halide; and porous carrier particles in which said metal halide is infused, said carrier particles supporting said metal halide such that an antimicrobially effective amount of ions are released into the environment of said microbe. In another embodiment, such compositions are incorporated into a product of manufacture so as to impart antimicrobial properties to said product by releasing antimicrobially effective amounts of ions into the environment of a microbe. When porous carrier particles are employed, such particles are selected from the group consisting of silica particles, porous polymeric resins, and porous non-ion exchange ceramic particles. The preferred porous non-ion exchange ceramic particles are nano-porous. Said copper halide has a solubility of less than about 100 mg/liter in water, preferably less than about 15 mg/liter in water; and the preferred copper halide is CuI. In another embodiment, the said composition may additionally comprise a silver metal. In said composition, the said silver halides are selected from the group consisting of AgI, AgBr, and AgCl.

Another embodiment comprises a composition having antimicrobial activity comprising: a copper halide; preferably CuI, and porous carrier particles in which said copper halide is infused, said carrier particles supporting said copper halide such that an antimicrobially effective amount of ions are released into the environment of said microbe. A further embodiment comprises a composition having antimicrobial activity comprising a plurality of metal halides comprising copper halide and silver halide; and porous carrier particles in which said metal halides are infused, said carrier particles supporting said metal halides such that an antimicrobially effective amount of ions are released into the environment of said microbe. In a further embodiment, the porous particles may comprise metals in addition to metal halides, such that an antimicrobially effective amount of ions both from the metal and the metal halide are released into the environment of said microbe, a preferred metal is silver. In a further embodiment such porous particles are incorporated into a product of manufacture so as to impart antimicrobial properties to said product by releasing antimicrobially effective amounts of ions into the environment of a microbe.

In an additional embodiment, these compositions further include porous carrier particles which are selected from the group consisting of silica particles, porous polymeric resins, and ceramic particles, the metal halides are selected from compositions comprising at least one of silver and copper halides, preferably copper halides. In a further embodiment, the preferred compositions of copper halides have a solubility of less than about 100 mg/liter in water and preferably solubility of less than about 15 mg/liter in water. In a still further embodiment, the preferred copper halide is copper iodide. In another embodiment, preferred silver halides are selected from the group consisting of AgI, AgBr, and AgCl. In a further embodiment, the size of the porous particles should preferably be less than about 100 μm and more preferably from about 0.5 to about 20 μm. In an additional embodiment, the pore size of the porous particles preferably ranges from about 2 to about 20 nm and more preferably ranges from about 4 to about 15 nm. In a further embodiment, the surface area of the porous particles is greater than about 20 m²/g and more preferably greater than about 100 m²/g.

Other embodiments are directed to a composition having antimicrobial activity comprising a mixture of particles comprising particles of an inorganic copper salt and particles of at least a second inorganic metal compound; and at least one functionalizing agent in contact with said mixture of particles, said functionalizing agent stabilizing said mixture of particles in a carrier such that an antimicrobially effective amount of ions are released into the environment of said microbe. The carrier may be a liquid, either aqueous and oil based. In other embodiments, the functionalized particles may be incorporated in a carrier which is a solid matrix. In further embodiments, the said inorganic copper salt comprises a copper halide salt and the said the metal for the second metal compound is selected from the group consisting of silver, gold, copper, zinc and bismuth or alloys thereof, and preferably is a silver compound. In yet a further embodiment, said second inorganic metal compound is a metal halide salt wherein the halide is selected from the group consisting of iodide, bromide and chloride. In another embodiment, said mixture of particles have an average size of from about 1000 nm to about 3 nm. Further, said mixtures of particles preferably have a solubility of less than about 100 ppm in water and more preferably have a solubility of less than about 15 ppm in water.

In yet another embodiment, said functionalizing agent is selected from the group consisting of an amino acid, a thiol, a hydrophilic polymer, a hydrophobic polymer, a amphiphilic polymer, surfactants and a target-specific ligand or mixtures thereof. The said hydrophobic polymer is preferably selected from the group consisting of polyurethanes, acrylic polymers, epoxies, silicones and fluorosilicones; and the composition of said hydrophilic polymer is preferably selected from the group consisting of polyvinylpyrrolidone, polyethyleneglycol, polyethyleneimine; polyoxyethylenes and their copolymers; polyacrylic acid; polyacrylamide; carboxymethyl cellulose; dextrans and other polysaccharides; starches; guar, xantham and other gums and thickeners; collagen; gelatins; boric acid ester of glycerin and other biological polymers; and copolymers comprising at least one of the monomers which form the said hydrophilic polymers and polymeric blends comprising at least one of the said hydrophilic polymers. In another embodiment, the said functionalizing agent complexes said mixture of particles.

In a further embodiment, said functionalized mixture of particles incorporate copper and silver compounds and release copper and silver cations into the environment of a microbe. In yet further embodiment, said functionalized mixture of particles releases copper and silver cations in an amount sufficient to inhibit the growth of or kill said microbes. In another embodiment, said inorganic copper salts and said second inorganic metal compound particles are selected from the group consisting of CuI, CuBr, CuCl, AgI, AgBr and AgCl. In a further embodiment said functionalized mixture of particles incorporate a copper salt and a second copper compound.

An additional embodiment is directed to a composition having antimicrobial activity comprising: a mixture of particles comprising particles of a copper halide and particles of a silver halide; and at least one functionalizing agent in contact with said mixture of particles, said particles stabilizing said mixture of particles in a carrier such that an antimicrobially effective amount of ions are released into the environment of said microbe.

Other embodiments of the invention are directed to a composition having antimicrobial activity made according to the process comprising the steps of obtaining CuI powder; dissolving said CuI powder in a polar nonaqueous solvent; adding an amount of functionalizing agent sufficient to stabilize said CuI in the polar, nonaqueous solvent; removing the solvent sufficient to dry said stabilized CuI particles whereby a functionalizing agent-complexed CuI particle powder is formed; dispersing the functionalizing agent-complexed CuI particle powder in an aqueous solution having a pH of from about 0.5 to about 6 to form CuI particles stabilized in water; and optionally drying said stabilized CuI particles sufficient to remove the water.

In further embodiments, the composition of the said polar solvent is a polar aprotic solvent which is preferably selected from the group consisting of acetonitrile and dimethylformamide. In another embodiment, said functionalizing agent is selected from the group consisting of amino acids, thiols, hydrophilic polymers, amphiphilic polymers, surfactants and mixtures thereof. In a further embodiment, said hydrophilic polymer is selected from the group consisting of polyvinylpyrrolidone, polyethyleneglycol polyethyleneimine; polyoxyethylenes and their copolymers; polyacrylic acid; polyacrylamide; carboxymethyl cellulose; dextrans and other polysaccharides; starches; guar, xantham and other gums and thickeners; collagen; gelatins; boric acid ester of glycerin and other biological polymers; and copolymers comprising at least one of the monomers which form the said hydrophilic polymers and polymeric blends comprising at least one of the said hydrophilic polymers. In another embodiment, said functionalizing agent complexes said copper iodide particles. In yet another embodiment, said functionalized copper iodide particles release copper cations into the external environment of the microbes. In a further embodiment, said functionalized copper iodide particles release copper cations in an amount sufficient to inhibit the growth of microbes or kill these microbes.

In another embodiment, the said ratio of polymeric functionalizing to particle is from about 1:100 to about 100:1 by weight and a preferred range being 1:20 to 20:1. In another embodiment, the functionalized particle has an average size range of from about 1000 nm to about 3 nm. Yet another embodiment comprises the added step of neutralizing said aqueous dispersion prior to the optional drying step 1

In a further embodiment, a composition having antimicrobial activity is made according to the process comprising the steps of: obtaining CuI powder; dissolving said CuI powder in a polar nonaqueous solvent; adding an amount of polymer comprising PEG and/or PVP and their blends and copolymers sufficient to stabilize said CuI in the polar, nonaqueous solvent; removing the solvent sufficiently to dry said stabilized CuI particles whereby a polymer-complexed CuI particle powder is formed; dispersing the polymer-complexed CuI particle powder in an aqueous solution having a pH of from about 0.5 to about 6 to from CuI particles stabilized in water whereby a polymer-complexed CuI particle; and optionally drying said stabilized CuI particles sufficient to remove the water.

Another embodiment is directed to a composition having antimicrobial activity made according to the process comprising the steps of obtaining a copper compound or a silver compound which is selected from the group consisting of a copper halide, silver halide, copper oxide, silver oxide and copper thiocyanate; grinding said compound in the presence of a functionalizing agent in a fluid medium so as to surface functionalize the ground particles; obtaining said particles in a range of about 1,000 to 3 nm; and optionally removing the fluid to dry said functionalized material particles. In a further embodiment, the halide is CuI, CuBr, CuCl, AgBr, AgI and AgCl and the oxide is Cu₂O and Ag₂O. In yet another embodiment, said functionalizing agent is selected from the group consisting of amino acids, thiols, hydrophilic polymers, hydrophobic polymers, amphiphilic polymers, monomers, surfactants, emulsions of hydrophobic polymers and mixtures thereof. In yet a further embodiment, the preferred surfactants are nonionic, amphoteric and anionic, with the more preferred being anionic surfactants. In another embodiment, the said fluid medium is aqueous. In a further embodiment the said medium is nonaqueous. In further embodiment, said compositions comprising ground functionalized particles are added to an article of manufacture to provide antimicrobial characteristics.

Another embodiment is directed to a composition having antimicrobial activity comprising: a mixed-metal halide particle wherein said particle comprises copper and at least a second metal as cations; at least one functionalizing agent in contact with said mixed-metal halide particle, said functionalizing agent stabilizing said particle in a carrier such that an antimicrobially effective amount of ions are released into the environment of a microbe. In a further embodiment, the said carrier is a liquid which may be water-based or oil-based wherein the said particles are suspended and are complexed by said functionalizing agent. In a further embodiment the functionalized particles are incorporated in a carrier which is a solid matrix. In a still-further embodiment, the said halide is iodide. In another embodiment, said mixed-metal halide particle has an average size range of from about 1000 nm to about 3 nm. In yet another embodiment, said mixed-metal halide particle has a solubility of less than about 100 ppm in water and more preferably said mixed-metal halide particle has a solubility of less than about 15 ppm in water. In a further embodiment, said functionalizing agent is selected from the group consisting of an amino acid, a thiol, a hydrophilic polymer, a hydrophobic polymer, an amphiphilic polymer, surfactants a target-specific ligand and mixtures thereof. In a further embodiment, the said hydrophilic polymer is selected from the group consisting of polyvinylpyrrolidone, polyethyleneglycol polyethyleneimine; polyoxyethylenes and their copolymers; polyacrylic acid; polyacrylamide; carboxymethyl cellulose; dextrans and other polysaccharides; starches; guar, xantham and other gums and thickeners; collagen; gelatins; boric acid ester of glycerin and other biological polymers; and copolymers comprising at least one of the monomers which form the said hydrophilic polymers and polymeric blends comprising at least one of the said hydrophilic polymers. In yet another embodiment, the said second metal comprises silver. In a further embodiment, said functionalized mixed-metal halide particle releases copper and silver cations into the environment of a microbe. In further embodiment said functionalized mixed-metal halide particle releases copper and silver cations in an amount sufficient to inhibit the growth of or kill said microbes. In yet a further embodiment, said mixed-metal halides are selected from the group consisting of Cu—AgI, Cu—AgBr and Cu—AgCl. and the weight ratio of Cu:Ag ranges from about 10:90 to about 90:10. Another embodiment is directed to a composition having antimicrobial activity comprising: a mixed-metal halide particle comprising copper iodide and a silver halide; at least one functionalizing agent in contact with said mixed-metal halide particle, said functionalizing agent stabilizing said particle in a carrier such that an antimicrobially effective amount of copper and silver ions are released into the environment of a microbe. In a further embodiment the mixed halides are selected from those mixtures where more than one anion is used. In an additional embodiment, mixed halides comprise mixtures of both anions and cations. In a yet further embodiment, the anions are selected from Cl, Br and I and the cations are selected from Cu and Ag.

Another embodiment is directed to a method of inhibiting the growth of or killing microbes comprising the steps of contacting a microbial environment with an effective amount of a composition comprising: particles comprising at least one inorganic copper salt; at least one functionalizing agent in contact with said particles, said functionalizing agent stabilizing said particles in a carrier such that an antimicrobially effective amount of ions are released into the microbial environment. In a further embodiment the said carrier is a liquid which may be water- or oil-based in which the functionalized particles are suspended. In another embodiment, the functionalized particles are incorporated in a solid matrix. In a further embodiment, the said inorganic copper salt comprises a copper halide salt.

In yet another embodiment, contacting a microbial environment comprises dispersing said composition in a monomer or polymer in a carrier in an antimicrobially effective amount, and then applying said carrier to a surface capable of being protected against the presence of microbes. In yet another embodiment, contacting a microbial environment comprises dispersing said composition in a liquid in an antimicrobially effective amount, and then contacting a surface capable of being protected against the presence of microbes with said dispersion. In another embodiment, contacting a microbial environment comprises dispersing said composition in a melt-blend, extrudable or injection moldable polymer. A further embodiment comprises the step of combining said dispersion with other melt-blend, extrudable or injection moldable-capable polymers, and then manufacturing an article from said composition dispersed in said melt-blend, extrudable or injection-moldable polymer. In another embodiment, the composition contains at least about 12 ppm of the antimicrobially-effective composition. In a further embodiment, the halide is iodide.

In another embodiment, said particles have an average size range of from about 1000 nm to about 3 nm. In another embodiment said inorganic copper salt has a solubility of less than about 100 mg/liter in water and preferably the said inorganic copper salt has a solubility of less than about 15 mg/liter in water. In another embodiment, the said functionalizing agent is selected from the group consisting of amino acids, thiols, hydrophilic polymers, hydrophobic polymers, amphiphilic polymers, surfactants, ligand-specific binding agents and combinations thereof. In a further embodiment the said amino acid is selected from any of aspartic acid, leucine and lysine. In another embodiment, the said thiol is selected from the group consisting of aminothiol, thioglycerol, thioglycine, thiolactic acid, thiomalic acid, thiooctic acid and thiosilane; In a further embodiment, the said hydrophilic polymer is selected from the group consisting of polyvinylpyrrolidone, polyethyleneglycol polyethyleneimine; polyoxyethylenes and their copolymers; polyacrylic acid; polyacrylamide; carboxymethyl cellulose; dextrans and other polysaccharides; starches; guar, xantham and other gums and thickeners; collagen; gelatins; boric acid ester of glycerin and other biological polymers; and copolymers comprising at least one of the monomers which form the said hydrophilic polymers and polymeric blends comprising at least one of the said hydrophilic polymers. and copolymers and blends comprising at least one of the monomers which faun the said polymers, the said hydrophobic polymer is selected from the group consisting of polyurethanes, acrylic polymers, epoxies, silicones and fluorosilicones,

Another embodiment is directed to a method of inhibiting growth of or killing microbes comprising the steps of contacting a microbial environment with an effective amount of a composition comprising: particles comprising at least one inorganic copper salt selected from the group consisting of CuI, CuBr and CuCl and having an average size of less than about 1000 nm; at least one functionalizing agent in contact with said particles, said functionalizing agent being present about 100:1 to about 1:100, and a preferred range being from 20:1 to 1:20.

Another embodiment of the invention is directed to a method of inhibiting growth of or killing bacteria comprising the steps of contacting a bacterial environment with an effective amount of a composition comprising particles comprising at least one inorganic copper salt; at least one functionalizing agent in contact with said particles, said functionalizing agent stabilizing said particles in a carrier such that an antibacterially effective amount of ions are released into the bacterial environment.

### BRIEF DESCRIPTION OF THE DRAWINGS

FIG. 1 is a bar chart showing the growth and/or inhibition of Bacillus cereus spores when treated with various combinations of functionalized nanoparticles of the invention.

FIG. 2 is a bar chart showing the effectiveness of CuI against the growth of Bacillus cereus spores.

FIG. 3 is a plot of kill rate (Log₁₀ reduction) of Pseudomonas aeruginosa against time obtained using functionalized particles of the present invention incorporated as disclosed into various fabrics. Samples were tested both initially and after washing 3 times and 10 times in ordinary household detergent. “Sample 0×” indicates it was never washed; “Sample 3×” was washed three times; and Sample “10×” ten times. Uncoated cloth was the control.

FIG. 4 is a bar chart of Pseudomonas aeruginosa over a 5 hour period measuring OD600 and response to various metal nanoparticles of the invention, of solid bodies coated with functionalized particles.

FIG. 5 is a plot of Optical Density (OD, Y-axis) against P. aeruginosa growth and/or inhibition by copper iodide particles and Ag—CuI mixed metal halides, and a control.

FIG. 6 is a plot of Optical Density (OD, Y-axis) against S. aureus growth and/or inhibition by copper iodide particles and Ag—CuI mixed metal halides, and a control.

### DETAILED DESCRIPTION OF EMBODIMENTS OF THE INVENTION

### 1. Introduction

The present invention is concerned broadly with compositions and particles of oligodynamic metals and their compounds, and with combinations of such compositions and particles with other known antimicrobials, with particles provided with functionalized surfaces, with the application of such particles to the surfaces of solid bodies, with the incorporation of such particles in coating solutions to be applied to polymeric, ceramic or metallic bodies thereby imbuing in such coated bodies and bodies with particle-containing surfaces desired antimicrobial activity, with solid bodies containing functionalized particles which have desirable antimicrobial properties, and with combinations of the present functionalized antimicrobial particles with known antimicrobial agents to achieve enhanced antimicrobial activity.

The inventors associated with this patent have made the surprising discovery that particles made of certain metal salts have much greater efficacy against a broad range of bacteria, viruses, molds and fungi than known silver-only based antimicrobial particles. In particular, it has been discovered that the copper halide salt, copper iodide (“CuI”), when formulated in accordance with the teachings herein, is surprisingly effective as a broad-spectrum, fast-acting antimicrobial agent. Therefore, a first embodiment of the invention is directed to a composition having antimicrobial activity comprising a particle comprising at least one inorganic copper salt, the particle preferably having an average size of less than about 1000 nm; and at least one functionalizing agent in contact with the particle, the functionalizing agent stabilizing the particles in a carrier such that an antimicrobially effective amount of ions are released into the environs of the microbe.

As discussed below, the functionalizing agent may have several functions. One function is stabilizing the particle in a carrier (in liquids) so that particles do not agglomerate and are uniformly distributed. In addition the functionalizing agent may also assist in releasing antimicrobially effective amounts of ions into the environment of a microbe, and may further provide improved compatibility with a variety of matrix materials in addition to other benefits.

Some embodiments of the invention include inorganic copper salts. Copper halides such as copper bromide and copper chloride comprise other embodiments, but copper iodide is the embodiment that has been studied the most and is preferred. Copper (I) halide particles are only sparingly soluble in water, so they will tend to agglomerate (“clump”) in water unless they are somehow dispersed. In one embodiment, the particles are functionalized by modifying their surface chemistry so that they are more stable in solution, are more attracted to microbes and other pathogenic organisms, and are more compatible when added as antimicrobial agents to other surface coating formulations such as paints, resins and moldable plastic articles of manufacture.

Functionalizing agents may include one or more of the following species: polymers especially hydrophilic and hydrophobic polymers, monomers, surfactants, plasticizers, amino acids, thiols, glycols, esters, carbohydrates, microbe-specific ligands and mixtures thereof. Embodiments of functionalizing agents include polyurethanes and water soluble polymers such as polyvinylpyrrolidone (PVP) and polyethylene glycol (PEG), polyethyleneimine (PEI); polyoxyethylenes and their copolymers; polyacrylic acid; polyacrylamide; carboxymethyl cellulose; dextrans and other polysaccharides; starches; guar, xantham and other gums and thickeners; collagen; gelatins; boric acid ester of glycerin and other biological polymers; and copolymers comprising at least one of the monomers which form the said hydrophilic polymers and polymeric blends comprising at least one of the said hydrophilic polymers, which stabilize CuI nanoparticles, facilitate dispersion in carriers, and also help adherence to the external microbial surfaces thereby bringing the copper ions into close proximity to their target. Functionalizing agents may also include hydrophobic polymers which are used as emulsions and solutions to modify the particulate surfaces. Both of these factors, the nature of the metal halide and the qualities of the functionalizing agent, are material to the overall efficacy of the antimicrobial composition.

### 2. Defined Terms

The term “amino acids” includes any of the twenty naturally-occurring amino acids known to be critical to human health, but also any non-standard amino acids. An amino acid is conventionally defined as H₂NCHRCOOH where the R group may be any organic substituent. Preferred embodiments of the current invention include a subset including aspartic acid, leucine and lysine which have demonstrated utility in stabilizing the particles in a carrier, although other amino acids may have also have utility as functionalizing agents.

The term “amount of functionalizing agent sufficient to stabilize a metal salt in the solvent” refers to the amount, on a weight-to-weight basis, of any suitable functionalizing agent mentioned herein capable of holding in suspension a metal salt in an aqueous or nonaqueous environment so that the metal salt will not settle out of solution (in the case of a liquid composition including monomeric compositions) or more viscous media (such as an ointment, cream, or polymer).

The term “amount sufficient to inhibit the growth of microbes” in one embodiment is determined by the effect upon a microbe's growth as tested in an assay. The growth-inhibiting amount will vary depending upon the type of metal salt, the particular functionalizing agent, the concentration of the particle in the functionalizing agent, the size of the particles, the solubility of the articles in water, the pH, the genus and species of the bacterium, fungus, spore or other pathogen, etc. One conventional measure is the Minimum Inhibitory Concentration (or MIC₅₀) of an agent required to inhibit the growth of 50% of the starting population. The related term “minimum amount sufficient to kill a microbe” is also determined empirically. A conventional measurement is the Minimum Bactericidal Concentration to kill 50%, or MBC₅₀. The antimicrobial effectiveness can also be evaluated by measuring the decrease in microbial populations as a function of time or by measuring the change in optical density of microbial populations exposed to the antimicrobial agents vs. without such exposure.

The term “amphiphilic polymers” is directed to water-soluble polymers that have both hydrophilic and hydrophobic moieties which makes them capable of solvating the two disparate phases. Some examples of amphiphilic polymers include but are not limited to block copolymers, including those block copolymers where at least one block is selected from the hydrophilic polymer list, and at least one block may be selected from the list of the hydrophobic polymer list. Other examples are PVP-block-polypropyleneoxide-block; polyethyleneoxide-block-polypropyleneoxide-block-polyethyleneoxide-block; polyethyleneoxide-block-polypropylene oxide-block.

Monomers include those materials which when polymerized form polymers. These may comprise of groups which polymerize by condensation or by addition methods or have groups capable of undergoing polymerization by either or by other polymerization methods known to the art. As an example, one may have an acrylic or a methacrylic monomer which polymerizes by addition polymerization, and may also have other groups in this monomer such as carboxylic acid, hydroxy, isocyanate and amino groups which may be able to participate in condensation polymerization. These monomers have the ability to functionalize the surfaces of the particles being formed. Further, when such functionalized particles are added in matrices comprising monomers, then upon polymerization the monomers in the matrix and the monomers present as surface functionalizers react together. This reaction promotes better dispersion and adhesion between the functionalized particles and the matrix

The term “an average size of less than about XX nm”, where “XX” is a variable for the number of nanometers, is defined herein as the average particle size, as measured by any conventional means such as dynamic light scattering or microscopy, of a sampling of particles wherein the average is less than about XX nanometers in diameter, assuming for purposes of the calculation that the irregular particles have an approximate diameter, that is, that they are approximately spherical. This assumption is purely for the calculation of average particle size, due to the particles often being non-spherical in shape. Methods used to measure particle size include dynamic light scattering, scanning electron microscopy or transmission electron microscopy.

Embodiments of the present invention have demonstrated a range of average particle sizes from about 1000 nm to about 3 nm, including average particle sizes of less than about 1,000 nm, less than about 300 nm, less than about 100 nm, less than about 30 nm, and less than about 10 nm. Smaller particle sizes in general may be preferred for certain applications, but the average size relates to the release rate characteristics of the ions from the particles, so particle size and release rate are interdependent. Embodiments of the invention may also be made in other shapes, for example sheets or rods where some of the dimensions may be several microns, in which case the average size of such objects would be measured in relation to their smallest dimension being less than about 1000 nm, 300 nm, 100 nm, 30 nm and less than 10 nm. In the case of a fiber, the smallest dimension is its cross-section diameter; in the case of a sheet it is usually its thickness.

The term “anti-bacterial effect” means the killing of, or inhibition or stoppage of the growth and/or reproduction of bacteria.

The term “anti-fungal effect” means the killing of, or inhibition or stoppage of the growth and/or reproduction of molds and/or fungi.

The term “antimicrobial effect” is broadly construed to mean inhibition or stoppage of the normal cellular processes required for continued life, or continued growth of any of the microorganisms in the classes of bacteria, viruses, mold, fungus or spores. “Antimicrobial effect” includes killing of any individual or group of bacteria, viruses, mold, fungus or spores.

An “antimicrobially effective amount” of any agent mentioned herein as having an antimicrobial effect is a concentration of the agent sufficient to inhibit the normal cellular processes including maintenance and growth of a bacterium, virus, mold, fungus, spore, biofilm or other pathogenic species. Antimicrobially effective amounts are measured herein by use of assays that measure the reduction in growth or decline in their populations of a microbe. One measure of reduction is to express the decrease in population in logarithmic scale typical of a specific microbial species. That is, a 1 log reduction is equivalent to a 90% reduction versus a control, a 2 log reduction is a 99% reduction, etc.

The term “anti-spore effect” means the killing of, or inhibition or stoppage of the growth and/or reproduction of spores.

The term “anti-viral effect” means the killing of, or inhibition or stoppage of the growth and/or reproduction of viruses.

The term “carrier” as used herein is a medium for containing and applying the functionalized inorganic metal salt particles so that they may be incorporated into surfaces so that ions from the metal salts will become available to contact and thereby kill or inhibit microbes that may be or become present on the surface. A carrier may be a liquid carrier, a semi-liquid carrier, or a solid carrier, or it may change states during the processes of dissolution and application. For purposes of exemplification, in the case of a liquid carrier such as an aqueous liquid, a dry powder comprising metal halide particles functionalized with a polymer (such as PVP) may be added to the water and will dissolve or disperse in the carrier due to the physical and/or chemical characteristics of the polymer, such that the particle-polymer complex is dispersed uniformly. The water carrier may then be evaporated from the surface to which it was applied, leaving a uniform layer of particle-polymer from which ions may be made available to the surface over time.

The same considerations apply where additional additives may be added to the carrier, e.g., polymer emulsions, where upon evaporation of carrier (water), a film is formed of this polymer comprising well dispersed functionalized metal salt particles. As an example, many acrylic and urethane polymeric aqueous emulsions are used for a variety of coating applications such as furniture and trim varnishes, floor finishes and paints. These typically comprise surfactants to disperse the hydrophobic polymers in the aqueous media. Functionalized metal salt particles may be added to these polymers, or the antimicrobial particles may be formed or reduced in size in the presence of these emulsions so that the content of the emulsions functionalize the particles as they are formed.

The functionalization materials along with the shape and other characteristics of the antimicrobial material (metal salts) may impart a leafing property, which means as the carrier in these coatings dries out, surface tension causes these particles to rise to the surface, thus naturally providing a higher concentration of antimicrobial material on the surface of such coatings.

Similar relevancy applies to a hydrophobic liquid carrier such as an oil-based paint or an epoxy resin. Carriers may be a monomer, or may be optionally supplemented with a monomer that is added into the mix of the removable carrier and functionalized particles, and then during processing the monomer polymerizes (with or without crosslinking) which may be accompanied by the evaporation of the carrier if present to form a polymerized product with functionalized particles dispersed therein.

In the case of a solid carrier such as when incorporating functionalized particles in a solid plastic, the same dry powder particle-polymer complex can be added to plastic powders or pellets, and then the plastic is brought to a molten state, where all the components are mixed (or melt blended). The surface functionalization of the particles facilitates one or more of several desirable attributes, such as providing a more uniform dispersion of the particles (less agglomeration); producing better adhesion of the particles to the plastic so as to not compromise physical properties of the plastic or the product made from it; and providing a pathway for the ions from the metal salt to be released and travel to the surfaces where microbes may be present. In this case, the carrier or the plastic does not evaporate but is an integral part of the final product after it changes its state from a liquid to a solid.

Some solid plastic materials derive their properties by being multiphasic (having two or more phases). For example, polymer blends and alloys of two different polymers, or block and graft polymers in solid state typically form multiple phases to derive their unique physical and chemical properties. When such multiphasic plastics are used, the functionalization of the functionalized particles may be so tailored that it is more compatible with one of these phases and thus distributes the particles preferentially in that phase, or may be tailored to preferentially position the particles at the interphase area of these phases.

A “copper halide salt” is a member of the copper metal family combined with any of the halides, typically defined in the Periodic Table of the Elements as fluorine, chlorine, bromine and iodine. Of these, preferred embodiments of the invention commonly include iodide, bromide and chloride, and most preferred is the iodide Copper halide salts may include both copper (I) and (II) varieties, for example Cu(I)Cl and Cu(II)Cl₂.

The term “emulsion” refers to those stabilized fluid suspensions or polymeric latex fluids, where in a fluid, particles or droplets of an incompatible material are stabilized through the use of surfactants.

The term “environs of a microbe” is any 1) surface actually or capable of being inhabited by a microbe that may thereafter be contacted by a human, or 2) in the case of an aerosol, any liquid droplet that may now or in the future contain a microbe whether on a surface or suspended in air, or 3) in the case of a water-borne microbe, any body of liquid that may carry a microbe now or in the future.

The terms “external environment of a microbe” and “internal environment of a microbe” refer to the immediate environment external to the microbe, that is, the liquid, gel or solid the microbe inhabits, and the internal volume of a microbe, respectively. The external environment of a microbe is often that of a liquid (usually aqueous) in order for the microbe to live, and for the antimicrobial metal salt or its constituent ions to be communicated to the microbe. The external environment does not need to be liquid, however, but must provide for the transmission of the antimicrobial agent to come into proximity of the microbe, where it can then be taken up by any of several different mechanisms.

The term “functionalization” means modification of the surface chemistry of the particles to effectuate any one or more of the following: 1) improve their interaction with other materials, especially with microbial species and 2) to improve their interaction and uniformity of distribution with constituents of coatings and bulk materials, and 3) to provide increased stability for the particles dispersed in liquid suspension.

The term “functionalizing agent” may include in a first embodiment a variety of polymeric species, such as polyvinyl pyrrolidone (PVP), polyethylene glycol (PEG), polyurethane polymers, acrylic polymers, or polymers with ionic moieties, or combinations thereof. The functionalization agents may also play additional roles, they may modify the pH of the solution and hence bind differently to the particles, or they may act as reducing agents (as in the case of PVP). The polymers may be hydrophilic or hydrophobic.

Functionalization may also be carried out in a second embodiment using small molecule (non-polymeric) species such as amino acids (or combinations of amino acids), peptides and polypeptides. In a third embodiment thiols (or combinations of thiols) also have demonstrated utility. Other embodiments include carbohydrates, glycols, esters, silanes, surfactants, monomers and their combinations. In yet another embodiment, functionalization may involve adding a ligand or group of ligands to the particle so that it specifically binds to a receptor or other biological target on a microbe. One may also use combinations of the above functionalizing agents in the same functionalizing formulation to affect a targeted approach for specific genus and species of microbes.

The term “hydrophilic polymer” refers to water-soluble polymers having an affinity or ability to complex the nanoparticles of copper salts shown herein. Examples of functionalizing agent compositions include, but are not limited to, polyurethanes, including polyether polyurethanes, polyester polyurethanes, polyurethaneureas, and their copolymers; polyvinylpyrrolidones and their copolymers (e.g., with vinyl acetate and/or caprolactum); polyvinyl alcohols; polyethyleneoxide, polyethylene glycols and their copolymers; polypropylene glycols and their copolymers; polyethyleneimine, polyoxyethylenes and their copolymers; polyacrylic acid; polyacrylamide; poly(diallyldimethylammonium) chloride, carboxymethyl cellulose; cellulose and its derivatives; dextrans and other polysaccharides; starches; guar; xantham and other gums and thickeners; collagen; gelatins; boric acid ester of glycerin and other biological polymers. Particular embodiments of hydrophilic polymers include polyvinyl pyrrolidone, polyethyleneglycol and copolymers and blends comprising at least one of the monomers which form the aforementioned polymers.

The term “hydrophobic polymers” refers to water-insoluble polymers similarly having an affinity or ability to complex the nanoparticles of copper salts shown herein, but being having a hydrophobic nature. Some examples of hydrophobic polymers include but are not limited to polytetrafluoroethylene, polyvinylchloride, polyvinylacetate, cellulose acetate, poly(ethylene terephthalate), silicone, polyesters, polyamides, polyurethanes, to polyurethaneureas, styrene block copolymers, polyoxymethylene, polymethyl methacrylate, polyacrylates, acrylic-butadiene-styrene copolymers, polyethylene, polystyrene, polypropylene, polypropylene oxide, polyisoprene, acrylonitrile rubber, epoxies, polyester epoxies, and mixtures, or copolymers thereof.

The term “inorganic copper salt” includes relatively water insoluble, inorganic copper compounds. Inorganic copper salt is an ionic copper compound where copper cations along with anions of other inorganic materials form this compound. Typically these compounds release copper ions (Cu⁺ or Cu⁺⁺) when such salt is put in proximity to water. Those copper salts are preferred that have low water solubility, i.e., solubility lower than 100 mg/liter and preferably less than 15 mg/liter. Some of the preferred copper salts are cuprous halides and cuprous oxide.

An organic cuprous salt which is relatively water insoluble, and is useful for this invention is cuprous thiocyanate.

The term “polar aprotic solvent” includes those liquids having a dielectric constant greater than about 15 that have no labile protons. Non-limiting examples including acetone, acetonitrile, dimethylformamide and dimethylsulfoxide.

The term “polar nonaqueous solvent” includes those liquids (except for water) having a dielectric constant greater than about 15. Non-limiting examples include alcohols such as methanol, ethanol, butanol and propanol, and acids such as formic acid.

The term “releases copper cations” generally refers to the making available of copper cations in the immediate environment of a microbe from the functionalized metal salt. In one embodiment, release may occur by dissolution of copper ions from a copper halide particle, for example. In another embodiment, release may be mediated by a functionalizing agent such as PVP which complexes the copper cation until the PVP contacts a microbe thereby transferring the cation to the external environment of the microbe. Any number of mechanisms could account for the release of the copper cations, and the invention is not to be restricted to any mechanism. Also of potential for antimicrobial effect is the release of anions from the copper halide particles, for example triiodide anion (I₃⁻) is a known antimicrobial agent.

The term “stabilizing said particle in a carrier” means to maintain the functionalized particle dispersed and separate from other particles in the liquid carrier such that agglomeration and/or settling out of suspension is inhibited. The stability of a dispersion is measured according to its “shelf life,” or time period over which there is no appreciable settling out of suspension of the dispersed element. Stabilized particles have a longer shelf life as compared to particles of similar shape and size which are not stabilized. Typically for similar particles in similar solvents stabilized with similar materials used at concentrations proportional to the surface area of the particles, the shelf life of larger particles may be lower than the shelf life of the smaller particles. It should be noted that in some cases a few large particles are formed which may settle fast, however as long as appreciable amounts of the particles remain dispersed, that would still be a stable dispersion. Shelf lives preferably of at least eight hours, more preferably at least 30 days, and most preferably at least 180 days are contemplated for the functionalized compounds and particles of the invention hereunder.

The dispersions or liquid suspensions may be intermediate products or may be the end products in which the antimicrobial materials are used. Examples of the latter include low viscosity liquids such as those used for liquid sprays to treat surfaces suspected of having a microbial problem in a specific area; or as examples of the former, the low viscosity liquids may be used as intermediates to be added to paint formulations to make them antimicrobial. The functionalized metal salt nanoparticles of the current invention may also be used in high viscosity liquid suspensions such as creams and gels for topical use. In end-use products, higher suspension stability is preferred and in intermediates, the stability has to be sufficient for the process in which this intermediate is used. The terms “dispersion” and “suspension” are used interchangeably throughout this specification.

The term “surfactants” means nonionic, cationic, anionic or amphoteric surfactants, some specific examples are Brij, Tween, Triton X-100, Sodium dodecyl sulfate (SDS), sodium capryl sulfonate, sodium lauryl sulfate, cetyltrimethylammonium chloride or cetyltrimethylammonium bromide. A large variety of surfactants are commercially available. Preferred surfactants are nonionic, amphoteric and anionic, and most preferred are anionic surfactants. So long as the surfactant stabilizes the particles of the invention, it falls within the spirit and scope of the claims.

The term “thiol” generally refers to a chemical having an —SH substituent. Embodiments of the invention include thiols such as aminothiol, thioglycerol, thioglycine, thiolactic acid, thiomalic acid, thiooctic acid and thiosilane. Other thiols useful in the invention have the capability of complexing metal halides.

### 3. The Compositions

a. Oligodynamic Metals

In one embodiment of the invention, the preferred material compositions comprise at least one metal halide and the combination of one or more metals with at least one metal halide. Preferred metals are copper, zinc, silver and their alloys, and preferred metal halides are copper halides, especially copper iodide. Compositions may include alloys comprising at least one of silver, copper and zinc. Example of these alloys are those of silver+copper, copper+tin (bronze) and copper+zinc (brass is an alloy of copper and zinc with typical copper concentrations in the range of 40 to 90% by weight, and may have additional elements, e.g., as in phosphor bronze). These alloys may provide better stability of particles in the processing or in end use applications against oxidation or non-desirable surface reactions.

b. Copper Salts

The copper salt embodiments of the present invention include copper salts, both inorganic and organic copper salts, with limited water solubility. By way of exemplification the following copper compounds are illustrative but not limiting: Copper(II) iodate; Copper(I) iodide; Copper(I) chloride; Copper(I) bromide; Copper(I) oxide; Copper(I) acetate; Copper(I) sulfide; and Copper(I) thiocyanate.

The copper salts may have a range of water solubility characteristics. However, it is preferred that the copper salts of the present invention have low water solubility so that they may have slow and predictable copper cation release characteristics. In some formulations it may be desirable to also add Cu(II) or more soluble salts so that some fraction of Cu ions are quickly available. Cu(I) cations have shown the most efficacy against the various microbes tested. At room temperature, copper salt solubilities of less than about 100 mg/liter are preferred, and more preferred are copper salts having water solubilities less than about 15 mg/liter. In many applications lower water solubility is important, particularly where antimicrobial products come in contact with body fluids and water and long term efficacy is required. In some metal halides with high water solubility, a high concentration of ions are released over a short period of time; and this may lead to toxicity. In addition, the human to body also regulates the concentrations of several elements (labeled as micronutrients. Interestingly both elements of copper iodide, i.e., copper and iodine, belong to this class of elements. On the one hand, the low solubility of copper iodide allows one to make products with high efficacy where such efficacy is retained for a long time, and further, due to body regulative functions it is also not toxic at the levels at which it is an effective antimicrobial agent.

Other embodiments of copper (I) salts that may be useful in the present invention include halides where some of the copper has been substituted with other cations which may be other metals (forming mixed halide materials), or a given halide may be substituted with other anions. Alternatively, the substitution may be organic in nature, examples of such substitutions include e.g., AgCuI₂, CH₃NCuI₂, Rb₃Cu₇Cl₁₀, RbCu₃Cl₄, CsCu₉I₁₀, CsCu₉Br₁₀, Rb₄Cu₁₆I₇Cl₁₃ and RbCu₄Cl₃I₂. In general one may express these mixed halide copper salts as PₛCuₜX₍ₛ₊ₜ₎, where P is the organic or a metal cation and X is a halide, preferably selected from one or more of Cl, Br and I.

c. Copper Halides

Halide salts are particularly preferred, since in addition to the copper ions, these salts also contain anions have antimicrobial affects. For example both chlorine and iodine ions are used as antimicrobial agents in several cleaning and medical applications. Copper iodide (CuI), like most “binary” (containing only two elements) metal halides, is an inorganic material and forms a zinc blende crystal lattice structure. It can be formed from a simple substitution reaction in water with copper acetate and sodium or potassium iodide. The product, CuI, simply precipitates out of solution since it is sparingly soluble (0.020 mg/100 mL at 20° C.) in water. Copper iodide powder can be purchased in bulk from numerous vendors. A grade with over 98% purity is particularly preferred.

Copper bromide (CuBr) is also an inorganic material having the same crystal structure as CuI. It is commonly prepared by the reduction of cupric salts with sulfite in the presence of bromide. For example, the reduction of copper(II) bromide with sulfite yields copper(I) bromide and hydrogen bromide. CuBr is also sparingly soluble in water but has a solubility greater than that of CuI. Further, as discussed below, on the basis of coloration, CuBr is less preferred as its powder has a lower L* value.

Copper chloride shares the same crystal structure with CuBr and CuI and has a solubility of 62 mg/100 mL. It can be made by the reaction of mercury(II) chloride and copper metal.

Copper(I) fluoride disproportionates immediately into Cu(II) fluoride unless it is stabilized by complexation, so CuF is not a very useful copper halide particle source. Cu(II) fluoride is soluble in water and so it is not a source of Cu(I) cations, but is a source of Cu(II) cations.

For many (but not all) applications, the appearance and color of the coatings or the bulk products is important. For these applications the antimicrobial material should not change the appearance significantly. Some examples of these are paints and varnishes for buildings, fixtures and furniture, coatings for cosmetics use, incorporation in molded articles, and coatings and bulk incorporation in fibers for textiles, carpets, gaskets, etc. Thus it is preferred that the additives are colorless or pale in color. Typically the coloration of these materials can be assessed from bulk powders. In general for applications where appearance is important, the color of the bulk powder should preferably meet certain requirements as discussed in the next section relating to the L*a*b* color coordinates.

c. Non-Copper Salts

In addition to being antimicrobial, preferred metal salts have low water solubility (less than 100 mg/liter or more preferably less than 15 mg/liter at 25° C.). When low water solubility antimicrobial materials are added to coatings or bulk materials, they provide an efficacy that lasts for long periods. The materials of the present invention may be combined with other antimicrobials in a product. These other antimicrobials may include salts with greater water solubility and even water-soluble salts in cases where one wants to provide a quick as well as a sustained antimicrobial efficacy.

Besides low water solubility, there are also other desirable attributes of the materials. These include the colorless or weakly colored materials, stability in atmosphere, and stability to temperature for both processing and in use.

Table 1a shows water solubility of a few select metal halides and other salts.

TABLE 1a
Water solubility of selected metal salts at room temperature

| Material | Water solubility (mg/L) |
|---|---|
| AgI | 2.2E−03 |
| AgBr | 1.4E−01 |
| AgCl | 1.9E+00 |
| CuBr | 1.1E+01 |
| CuI | 2.2E−01 |
| CuCl₂ | 7.0E+05 |
| CuCl | 6.2E+01 |
| CuSCN | 8.4E−03 |
| ZnI₂ | 4.5E+06 |
| ZnBr₂ | 4.5E+06 |
| ZnCl₂ | 4.3E+06 |
| BiI₃ | 7.8E+00 |

Table 1b shows the color coordinates of various copper, silver and some other halides. The color coordinates of various powders were measured on the Colorimeter model UltraScan XE (from Hunterlab, Reston, Va.) in RSIN reflectance mode using the small, 0.375 inch aperture. A glass slide was covered with a piece of double sided tape and a small amount of the powder as received from Sigma Aldrich was placed on the double sided tape to give a smooth, solid dry powder finish. To protect the powder from disengaging into the colorimeter while the measurements were being performed, a second slide (top slide) was then placed over the top of the first and the two slides were taped together. The double slide was then read for L*a*b* coordinates on the colorimeter with the top slide facing the reflectance port.

The colors measured here are not absolute values for a given material, as the color also depends on the level of purity and the type of impurity present in these materials. An L* value of 100 (maximum) indicates a completely white color and a value of 0 indicates a completely black color. For a low degree of color, the color of the bulk powder should preferably have a L* value greater than 65, and more preferably greater than 70, and most preferably greater than 80 when measured on a color scale of L*a*b*. The desirable values of a* and b* are dependent on L* value, and should be as close to zero as possible. As a rough guideline, when L* value is at 65, the a* and the b* values are preferably within ±5, when L* value is at 70, the a* and the b* values are preferably within ±15, when L* value is at 75, the a* and the b* values are preferably within ±20, and when L* value is at 80 or greater, the a* and the b* values are preferably within ±25 as long as these values are within the L*a*b* color sphere.

TABLE 1b
Color coordinates of as received powders

| | Source, Catalogue | | | |
|---|---|---|---|---|
| Material | number | L* | a* | b* |
| BISMUTH (III) | Sigma Aldrich, 341010 | 0.01 | 0.09 | 0.02 |
| IODIDE | | | | |
| GOLD (I) IODIDE | Sigma Aldrich, 398411 | 76.6 | −1.98 | 34.55 |
| SILVER BROMIDE | Sigma Aldrich, 226815 | 45.02 | −20.55 | 42.49 |
| SILVER IODIDE | Sigma Aldrich, 204404 | 78.05 | −7.13 | 20.28 |
| SILVER CHLORIDE | Sigma Aldrich, 227927 | 72.46 | 4.01 | 5.05 |
| COPPER | Sigma Aldrich, 254185 | 42.02 | −29.36 | −3.45 |
| (I)BROMIDE | | | | |
| COPPER (I) | Sigma Aldrich, 205540 | 72 | 2.54 | 10.85 |
| IODIDE | | | | |
| COPPER (I) | Sigma Aldrich, 229628 | 76.35 | −4.46 | 14.93 |
| CHLORIDE | | | | |
| COPPER (I) | Sigma Aldrich, 298212 | 76.17 | 0.46 | 8.79 |
| THIOCYANATE | | | | |

These indicated color characteristics are required so that the appearance of the product incorporating the functionalized antimicrobial particles (e.g., coatings molded products, fibers) is not compromised. Color is less important for those applications where appearance is not an issue or where the articles already have a strong color.

Temperature stability is dependent on the processing temperature used to produce the product and the temperature seen during the use. Since antimicrobial materials have to go through a long regulatory process, it is difficult to change composition for each application; thus it is desirable that a given composition can be used over a broad range of conditions. Since most molding operations for polymers, including powder coating operations, are carried out at temperatures ranging from about 150 to about 250° C., it is preferable for the compositions to be stable to 150° C. or higher. Since the melting points of nanoparticles below about 50-100 nm may be lower than those of bulk materials, the melting point must be notably higher than the expected use temperatures when particles smaller than 50-100 nm are used. The preferred non-copper salts of oligodynamic metals are those of silver. Of these the more preferred salts are silver halides, and in particular AgCl, AgBr and AgI. Of these AgCl and AgI are more preferred due to lower degree of coloration (higher L* value).

Further, the preferred silver halides also have a drawback in that the materials tend to exhibit coloration to light such as the sun. Hence for those products where exposure to light such as sunlight is anticipated, these halides may desirably be doped with other materials so as to reduce the darkening. One way of accomplishing this is to make compounds such as mixed metal halides (or doping one metal halide with another metal halide) to reduce discoloration but still preserve low color, low water solubility and other desirable attributes. Another approach involves mixing the anions of the silver halide particles. Additional aspects of mixed metal halides are also discussed in the section below.

It should be noted that while some of the copper halides may also exhibit mild discoloration on exposure to light such as sunlight, the extent of such discoloration is markedly less than that of the silver halides, and any such discoloration which can also be reduced by doping.

In addition, attractive economics of the material are also very important for a variety of applications. Since the cost of copper compounds, such as the preferred copper halides of the present invention, is notably smaller than that of silver compounds, when the functionalized antimicrobial materials of the present invention comprise silver constituents, it is preferred to minimize the extent of such additions of silver constituents consistent with achieving the desired antimicrobial efficacy and other desirable attributes.

Other metal iodides may also be used, in conjunction with the materials of this invention, but many of the metal halides have drawbacks which limit that usefulness in our invention. A few select iodides with their principal shortcomings are; germanium (II) iodide (decomposes at 240° C.); germanium(IV) iodide (melting point is 144° C.); tin(II) iodide (is bright red in color); tin(IV) iodide (red in color and hydrolyses in water); platinum(II)iodide (black in color); bismuth(III) iodide (black in color); gold(I) iodide (unstable, decomposes on treating with hot water); iron(II) iodide (black colored and water soluble); cobalt(II) iodide (black colored and water soluble); nickel(II) iodide (black colored and water soluble); zinc(II) iodide (white colored but water soluble); and indium(III) iodide (orange colored). As seen, these iodides are deeply colored, or have low melting point or poor thermal stability, poor stability when exposed to oxygen or moisture, or high water solubility. These or other metal iodides may, however, be used to dope the desirable copper or silver halides as long as the desirable properties of these materials are not compromised.

It should be pointed out that while some of the copper halides may also exhibit mild discoloration on exposure to light such as sunlight, the extent of such discoloration is markedly less than that of the silver halides which can also be reduced by doping.

d. Mixed-Metal Halides

Further embodiments of the invention are directed to mixed-metal halides. These are novel halide salts containing more than a single cation, or containing more than a single anion or containing more than a single cation and more than a single anion. In the mixed-metal halides of the present invention, at least one of the cations is an oligodynamic metal cation, preferably a copper cation. More preferably, all of the mixed-metal cations are oligodynamic metal cations. Embodiments include silver-copper halide, gold-copper halide, silver-gold halide, etc. For example a metal halide of two metals with a common anion may be expressed as M₁-M₂(X), where M₁ is the first metal, M₂ is the second metal and X is the halide anion. Another combination is M₁-M₂(X₁-X₂), where X₁ and X₂ are different halogen anions. Most preferred embodiments include silver-copper halides. Embodiments may include halogens such as iodide, bromide and chloride. A preferred embodiment is Iodide. Some exemplary embodiments are (Cu—Ag)I, (Cu—Ag)Cl, (Cu—Ag)(Br—I), (Cu—Ag)(I—Cl), Ag(Cl—I) and Cu(Cl—I). Please note that the stoichiometric proportion in the mixed metal halides between the various anion and the cations may be any which can be formed and is suitable for the application.

f. Mixtures of Particles

In other embodiments of the present invention, the functionalized particles comprise mixtures or combinations of functionalized particles of salts of oligodynamic metals. The functionalized particles may comprise halides of oligodynamic metals, in some cases combined with functionalized particles of silver metal or copper alloys. In a further embodiment, the functionalized particles comprise compounds of silver and copper other than their halides. In a further embodiment, these compositions, particularly compositions comprising copper halides especially copper iodide may be combined with other known antimicrobial or antifungal agents. One may also combine particles of different sizes/composition/solubilities to control the delivery rate and the longevity of the antimicrobial efficacy of the products in which where such particles are incorporated. As an example, one may combine particles about 300 nm in size with those that are less than 30 nm, or one may combine particles larger than 300 nm in size with those that are smaller than 300 nm, etc.

In applications such as those where copper or other compounds are used for antimicrobial effects, one may combine those materials with materials of the present invention. As a specific example, in marine coatings where zinc pyrithione, cuprous oxide or copper thiocyanate are used for their antimicrobial properties, one may prepare these compounds as functionalized particles with sizes smaller than about 300 nm. As another specific example, these materials may be combined with copper iodide as taught in the present invention. As another specific example, one may also use other antimicrobial compounds which are relatively water soluble in conjunction with the materials of the present invention. In such cases, the more water soluble component will result in a fast release of antimicrobial ions when such products are brought in contact with moisture. Some examples are, silver nitrate, copper (II) chloride, zinc chloride, potassium iodide, sodium iodide and zinc iodide.

Embodiments of the mixture of particles are directed to a composition having antimicrobial activity comprising (a) a mixture of particles comprising particles of a copper salt and particles of at least a second inorganic metal compound or metal; and (b) at least one functionalizing agent in contact with the mixture of particles, the functionalizing agent stabilizing the mixture of particles in a carrier such that an antimicrobially effective amount of ions are released into the environment of the microbe. A further embodiment of the copper salt comprises a copper halide salt, and a still further embodiment of the copper salt comprises copper iodide.

Yet a further embodiment of the invention includes the second metal being selected from the group consisting of silver, gold, copper, zinc and bismuth or alloys thereof. A still further embodiment of the invention comprises a second inorganic metal compound being a metal halide salt wherein the halide is selected from the group consisting of iodide, bromide and chloride. Yet a further embodiment of the invention includes the said composition wherein the mixture of particles has an average size of less than about 100 nm, less than about 30 nm, or less than about 10 nm. Further embodiments of the invention include the said composition wherein the mixture of particles has a solubility of less than about 100 ppm in water, or less than about 15 ppm in water.

Embodiments of the invention are also directed to functionalizing agents selected from the group consisting of an amino acid, a thiol, a hydrophilic polymer and a target-specific ligand, or combinations thereof. Another embodiment of the invention is directed to the said composition wherein the second inorganic metal compound comprises silver. A further embodiment of the invention is directed to the said composition wherein the functionalized mixture of particles releases copper and silver cations into the environment of a microbe. Embodiments of the invention are also directed to compositions wherein the functionalized mixture of particles releases copper and silver cations in an amount sufficient to inhibit the growth of or kill the microbes. Further embodiments of the invention are directed to compositions wherein the copper salts and a second inorganic metal compound particles are selected from the group consisting of CuI, CuBr, CuCl, AgI, AgBr and AgCl.

For many applications cost is an important issue. Addition of precious metals or their salts to the compositions of this invention can make antimicrobial materials less attractive economically. Since the copper salts of the present invention have shown high efficacy against a variety of microbes and are less costly than their cousins the silver halides, for many applications mixing copper halides with silver, gold, platinum or other precious metals and their salts is not necessary. If needed for specific applications, the precious metals and their salts may be utilized in much lower concentrations than if they were not combined with the copper salts.

g. Functionalizing Agents

An important embodiment of the present invention is the functionalization of the metal salt particles. In functionalizing the surfaces of the particles of oligodynamic metals and their compounds or salts, a number of chemical species may effectively be used, which may be selected from one or more of the categories below. These functionalizing agents are preferably present while the particles are being formed, either during chemical synthesis, or during physical grinding when they are being ground to a finer size from larger particles. The amount of surface functionalizing agent increases with decreasing particle size in proportion to the overall change in surface area exposed for functionalizing. Any ratio of the relative amounts of the metal salt particles and the functionalizing material may be used, typically these are present in a molar ratio (metal salt:functionalizing agent) in a range of about 100:1 to about 1:100 and more preferably a range of about 20:1 to 1:20. For polymeric functionalization agents, the molarity is calculated based on their repeat units. The molecular weight of the functionalizing agents should be greater than 60, other than a few exceptions which are noted below. One purpose of the functionalizing agents is to reduce the interparticle interaction so that they disperse more easily. Putting higher molecular weight functionalization agents helps to weaken this interaction between the particles and helps dispersion.

Surface functionalization typically imparts one or more of many attributes, such as preventing particles from agglomeration (e.g., promoting suspension stability, particularly in liquid products), enabling particles to attach to various surfaces of an object or even to the microbes, and assisting particles to attach to matrix materials when these are incorporated as composites into other materials. This functionalization also helps to disperse the antimicrobial particles easily into these matrices (e.g., blending with thermoset or thermoplastic polymers which are later molded into objects). Use of acids along with other surface functionalization agents is desirable when Cu(I) halides (e.g., CuI, CuBr, CuCl) are used as antimicrobial materials. In an acidic environment, presence the acid stabilizes Cu⁺ ions from oxidizing to Cu⁺⁺ ions as Cu⁺ are preferred for their superior antimicrobial activity. Mineral acids (e.g., hydrochloric acid, nitric acid, sulfuric acid), or organic acids (such as acetic acid, ascorbic acid and citric acid), may be used for this purpose.

Functionalization agents may also provide other useful functions to a formulation. As an example, the functionalization agents may also be antimicrobial materials (such as many cationic surfactants), may have UV stabilization properties (e.g., benzophenones, benzotriazoles, acrylic esters and triazines), may impart thermal stabilization properties (including photooxidation), may also be antioxidants (e.g., ascorbic acid, butylated hydroxytoluene, furanones) and may be polymerization initiators (including photoinitiators) or dyes to impart certain colors or fluorescence properties. One may add more than one of the surface functionalizing agents with different attributes. This allows products to be made economically with low added cost. As discussed later, some of the processing technologies disclosed herein are particularly suitable for achieving this in a facile way.

Well dispersed finer particles in liquids or solids (including coatings) result in a more uniform distribution of the particles in the bulk material or on the coated surface and more of the surfaces of these particles is available to interact with the microbes. For particles that are a few nanometers in size, the surface functionalization can also influence their transportation into the interior of the microbes. Functionalizing agents that may facilitate transport of nanoparticles to the surface of a microbe include amino acids and combinations of amino acids, peptides, polypeptides and carbohydrates. Using these species as the functionalizing agents, it was found that when certain embodiments of amino acids are used to functionalize the surfaces of the oligodynamic metal-containing nanoparticles, enhanced antimicrobial activity was obtained.

Amino acids which are preferred as amino acid functionalizing agents for the present nanoparticles include aspartic acid, leucine and lysine, although numerous other amino acids can also have efficacy. Also useful are combinations of amino acids, dipeptides, tripeptides and polypeptides. Other embodiments of functionalizing agents include carbohydrates such as mono- and di-saccharides and their derivatives, enzymes, glycols and alcoholic esters (e.g., Schercemol™ and Hydramol™ esters from Lubrizol (Wickliffe, Ohio)).

Other embodiments of the invention are directed to various polymers that may be used for functionalization. Typically the functionalization procedure is done in a liquid medium in which these polymers are present in a solution and/or an emulsion form. Polyvinylpyrollidone and its copolymers represent one embodiment that can be an effective agent for modifying the surface chemistry of the antimicrobial particles. Examples of other polymeric surface modifiers include polyacrylic acid, copolymers comprising acrylic (including methacrylic acid) groups, polyethylene and polypropylene glycols (and their copolymers), polymers with alcoholic groups, urethanes, epoxies and carbohydrate polymers. Each of the above polymers may have a range of molecular weights, typically in the range of about 1,500 and 1,000,000 Daltons, although molecular weights less than 200,000 are preferred, and molecular weights less than 25,000 are most preferred. Useful functionalizing polymers have a minimum molecular weight of 60. Solubility and solution viscosity of the polymer generally correlates with average molecular weight, with high molecular weights being less soluble in water and resulting in more viscous solutions.

Another embodiment of functionalizing agents includes thiol functionalizing agents in addition to the above-cited functionalizing agents. Thiol modifying agents useful for functionalizing the antimicrobial nanoparticles include aminothiol, thioglycerol, thioglycine, thiolactic acid, thiomalic acid, thiooctic acid and thiosilane. Combinations of thiol modifying agents can also be used in the present invention.

The functionalization of the particles may also provide additional attributes desirable for using them in practical applications. These attributes include the promotion of adhesion of the particles to and/or reaction of the particles with specific matrices such as in bulk materials and coatings and the enhancement of their antimicrobial properties by making the interaction between particles and microbes more attractive or by coupling or combining them with other materials for specific applications. Examples of other materials with which the present antimicrobial particles can be combined include antimicrobial agents which target a specific microbe or group of microbes, or materials that under illumination or humid conditions provide modified antimicrobial activity, or materials that under anerobic conditions exhibit decreased antimicrobial activity for their safe disposal in landfills. The surface functionalization agents may also help disperse these particles in polymers, and for that purpose one may employ typical processing aids which are used in such applications. Some examples are stearic acid and their salts (also see discussion on surfactants).

Examples of coupling agents and monomers for increasing the compatibility of the antimicrobial particles with various polymeric matrices include organosilanes (e.g., epoxy silanes for use in epoxy matrices, mercapto silanes for use in urethane and nylon matrices, acrylic, methacrylic and vinyl silanes for use in reactive polyester and acrylic polymers). Other monomers include those materials which have the ability to attach to the surfaces of the particles and also react or bond with matrices into which such modified particles are introduced. Some examples include polyols, silanes (including silanated quats), metal alkoxides, acrylic polyols, methacrylic polyols, glycidyl ester acrylics and methacrylics.

Embodiments of the invention also make use of surfactants for surface modification. The term surfactants would mean nonionic, cationic, anionic and amphoteric surfactants, some specific examples being Brij, Tween (polysorbate), Triton X-100, benzethonium, benzalkonium, dimethyldialkylonium, alkylpyridinium and alkyltrimethylammonium cations with any anion, e.g., bromide, chloride, acetate or methyl sulfate, silicone-ethylene oxide/propylene oxide copolymers (e.g., OFX-0190, OFX-0193 and OFX-5329 from Dow Corning, Midland, Mich.), Sodium dodecyl sulfate (SDS), sodium capryl sulfonate, sodium lauryl sulfate, cetyltrimethylammonium chloride or cetyltrimethylammonium bromide (all available from Sigma-Aldrich Co, Milwaukee, Wis.). Anionic, amphoteric and nonionic surfactants are preferred, and anionic surfactants are most preferred.

One may also use surfactants (including emulsifiers) to form emulsions (including latex) of polymers and other materials, wherein such emulsions are used to modify the surfaces of the particles. For this purpose the polymers may be hydrophobic. Some examples include polyurethane emulsions, acrylic emulsions, fluorosilicone emulsions and epoxy emulsions. This method is particularly suitable where nanoparticles are made by grinding of larger particles of the antimicrobial materials in a liquid comprising a polymeric emulsion. The nanoparticles formed are functionalized by this emulsion. Alternatively one may grind the AM material in presence of a surfactant and then add this to the polymeric emulsion. Optionally, the functionalized particles may be dried as a powder and then added to the polymeric emulsion.

For oil based paints, one may use a variety of oil based surface modifiers, which may be easily incorporated on the surfaces of the particles by grinding. These may selected from different drying oils such as linseed oil, common industrial oil belonging to the class of polyunsaturated fatty acids. The viscosity of the grinding medium and other attributes may be controlled by adding solvents such as turpentine and white spirit. For some applications, particularly in preparing functionalized antimicrobial particles for cosmetic and personal or even for other uses, one may also use oils and extracts for surface modifications which are also known to impart antimicrobial properties such as oils and extracts from eucalyptus, neem, cinnamon, clove and tea tree. One may also use oil emulsions in preparing the functionalized particles in an aqueous medium and then remove the water, before adding these surface modified particles to the oil based paint formulations.

Other embodiments of functionalizing agents employ ligand-specific binding agents. For example, functionalization using autoinducer or quorum sensing molecules (e.g., N-undecanoyl-L-Homoserine lactone and N-heptanoyl-L-Homoserine lactone). may facilitate the delivery of the antimicrobial materials through biofilms, and may help delay or prevent the formation of biofilms. Functionalizing agents may also have other useful or antimicrobial properties, which may be effectively combined with the antimicrobial particles. As examples, salts of argenine and acidic polymers have been suggested for use in toothpastes for promoting oral hygiene (US 2009/0202456), and chitosans and curcumin have been also suggested for use as antimicrobial materials and all of these may be used as functionalizing agents.

Yet other examples include cecropin, caprylic acid and monocaprylin. As another specific example, it has been demonstrated (Corinne K. Cusumano, et al., Sci Transl Med 3, 109ra115 (2011) (DOI: 10.1126/scitranslmed.3003021 “Treatment and Prevention of Urinary Tract Infection with Orally Active FimH Inhibitors”) that mannoside compounds are effective in preventing uropathogenic E. coli infections in women by inhibiting the ability of the bacteria to bind to epithelial cells of the bladder via FimH receptors. One may use such compounds to modify the surfaces of particles of this invention to target E. coli with specificity. In one embodiment, the mannoside compounds may be used as functionalizing agents for the metal salt nanoparticles of present invention. In another embodiment, mannoside compounds may be included within the coatings used in urinary tract catheters.

The same approach may be used to target specific microbes responsible for specific pathogenic infections. There is an abundant and expanding literature on receptors on cell surfaces to which microbes bind; and utilizing tailored compounds as functionalizing agents which interfere with such binding can readily be carried out. Beyond this, one of ordinary skill will be able to identify various ligand-target combinations to design any manner of ligand-specific targeting agents to use as functionalizing agents for the particles of the present invention.

Other embodiments of the invention include affinity-based targeting mechanisms such as using certain inherent properties of microbes' external structures to target the metal halide nanoparticles to. For example, the peptidoglycan layer of Gram-positive bacteria is a polymer of sugars and peptides and has a generally negative charge. Other polymers, such as PVP or PEG may be attracted to the peptidoglycan surface on the basis of hydrophobic interactions, and once there, may stick to and deliver the stabilized metal halide particles to the surfaces of the microbes, which in turn will deliver the antimicrobial-active ionic species. Likewise, Mannose-binding lectin (MBL) and/or Lipopolysaccharide binding protein (LBP) may be included as functionalizing agents. MBL recognizes certain carbohydrate patterns on microbial surfaces, and LBP binds to Lipopolysaccharide, which comprises a majority of the outer membrane of Gram-negative bacteria.

In other embodiments of the present invention, after producing the functionalized particles in liquid media, these may be dried into solid powders. Such solid powders are easier to store and transport and may be also used in downstream processing with greater ease. The size of such dried powders particles will in general be larger than the size of the individual functionalized particles, and the particles of such dried powder particles will contain a number of the functionalized antimicrobial particles. The size of the dried powder particles should be greater than about 1 microns, preferably greater than about 10 microns and most preferably greater than about 100 microns. This allows downstream operations using the dry powders to be conducted safely without having the powder particles become airborne. The larger particles do not get airborne easily and further 100 micron particle size are larger than the thoracic airways of human lungs, Further, with increasing size the particles are difficult to inhale and flowability in processing also improves.

The dried powders may then be used to make antimicrobial products by adding them to a liquid carrier or a solid carrier. Use of solid carriers includes compounding these powders with a polymeric material in the molten state. When these powder particles are added to the carriers (liquid or solid), these particles will generally break down and result in a uniform dispersion of the smaller functionalized particles. Surface functionalization may also assist in the size reduction of the powders when blended with the carriers.

In still other embodiments of the present invention, one may add other agents (preferably other polymers) before the drying step used to form the solid powders. This is useful for producing larger powder particles upon drying. Such added agents can increase the cohesiveness of the assembly of functionalized particles and effectively serve as a binder, which is useful in providing stability during subsequent handling. Polymeric functionalizing agents may provide or contribute to this function. Typically when the molecular weight of the functionalizing agent is less than about 500, it is advantageous to add a polymeric binder which preferably has a molecular weight greater than about 3,000. As an example, one may use PVP, PEO or other polymers along with surfactants, where the surfactants have a molecular weight of less than 500 and the polymers have a molecular weight of greater than 3,000. Preferably, the volume percent of the surface modifiers and the polymeric additives should be in excess of 20%, and more preferably in excess of 40%.

h. Porous Particles and Particles with Core-Shell Geometry

Other embodiments of the invention are directed to compositions having antimicrobial activity comprising a metal halide, and a porous carrier particle in which the metal halide is infused, the carrier particle stabilizing the metal halide such that an antimicrobially effective amount of ions are released into the environment of the microbe. The terms “porous particle” and “porous carrier particle” are used interchangeably herein. In one embodiment, one may form the antimicrobial compositions within the porosity of larger porous carrier particles. Metals and metal compounds or salts, particularly metal halides are preferred materials for this infusion. For example one may infuse silver bromide or particularly copper iodide into the pores. The porous particles should preferably have interconnected pores. A preferred upper range of the carrier particle is below 100 μm, and more preferably below 20 μm and most preferably below 5 μm. The average pore size (average pore diameter) of the carrier particles should be less than about 100 nm, preferably less than about 50 nm and most preferably less than about 20 nm.

In other embodiments it is preferred that the surfaces of the porous particles (including the pore surfaces) are hygroscopic (an abundance of silanol or other hydroxyl groups on the surface leads to hygroscopic materials). One preferred class of carrier particles that can be used are “wide pore” silicas. The carrier particles may be of any shape, e.g., spherical, irregular, angular, cylindrical, etc. For example, SILIASPHERE™ silicas from Silicycle (Quebec, Canada) may be used. The preferred silicas have a pore size (average pore diameter) in the range of 2 to 100 nm, more preferably 4 to 20 nm). Another class of porous particles includes precipitated silicas, such as Zeothix™ and Zeofree™ from Huber Corporation (Atlanta, Ga.) and Sipernat™ from Evonik Industries (Evonik Degussa Corporation, Parsippany, N.J.).

The porous carrier particles containing antimicrobial compositions in the pores can then be incorporated into bulk products, coatings, solutions, low viscosity suspensions such as many shampoos, high viscosity suspensions such as creams and gels to impart antimicrobial properties. These may be added as fillers to polymers which may then be shaped into bulk products via molding, extrusion, etc. Porous particles may also be prepared in a form of a large three dimensional shapes such as plates, tubings or any other desired shapes. The AM material may be incorporated in these using solutions so that the bulk materials acquire antimicrobial properties. For example, a natural tubular material that is mined may be used for this purpose. These are called Halloysite clays and are available from Applied Minerals (New York, N.Y.). These clay tubes are typically between 0.5-3.0 microns in length, with an exterior diameter in the range of 50-70 nanometers and an internal diameter (lumen) in the range of 15-30 nanometers. In addition to imparting antimicrobial properties, the use of these clays in plastics in low concentrations can also lead to enhancements in modulus, strength and abrasion resistance.

These porous materials are not zeolites or other materials of the ion exchange type such as bentonite clays, hydroxyapatites and zirconium phosphates. Such ion exchange materials contain molecular channels with a size generally less than 1 nm. The channel size in zeolites and other such materials typically allows only single ions and very small molecules to pass through, and cannot accommodate the formation of discrete nanoparticles of antimicrobial materials. In contrast to the molecular-sized channels of ion exchange-type materials, larger molecules (including polymers) and solutions can readily be passed into and through the pores of the porous materials of this invention. Also in contrast to the regular molecular channels of ion exchange-type materials, the pore geometry and size of the pores of the porous particles of the present invention are irregular.

In a process embodiment of the present invention, infusion of silver metal in a porous carrier particle is generally performed by starting with an aqueous solution of a metal salt (e.g. silver nitrate with the surface modifiers (if used) dissolved therein) in water. The porous particles are added to this solution so as to infuse the solution into the pores. The porous carrier particles are then removed and optionally dried. The particles are then added to an aqueous solution of reducing agent (e.g., 0.25% w/w NaBH₄) which causes small particles of the metal (in this case, silver) to precipitate within the pores and also on the surfaces of the porous carrier particles.

In another process embodiment, metal halides may be formed in the pores where the porous carrier particles are treated with aqueous copper or silver salt solutions (or precursor solutions) followed by subjecting these to salt solutions of the required halide ions. If surface functionalization of the deposited materials is desired, these salt solutions may have include surface functionalization agents, or these may be sequentially treated with surface functionalization agent solutions, before being treated with catalysts or reactive solutions to convert them to the desired halides or metals. These may then be subjected to another series of similar treatment to precipitate more of the target metal or metal compound (as copper iodide) in the pores, or to precipitate a second compound or metal in the pores (e.g., depositing AgBr in pores which previously have been treated to deposit CuI). One may also mix different types of porous particles comprising different compositions of metals and metal compounds. Of particular utility are porous particles containing CuI and porous particles where a significant fraction of the particles contain CuI and the remaining fraction contain other antimicrobial species, as Ag metal or AgBr.

In another process embodiment, metal compounds, particularly metal halides such as copper iodide may be dissolved in non-aqueous solvents such as acetonitrile and dimethylformamide (DMF). These solutions are then used for treating the porous particles and then their removal leaves the metal halide coatings/deposits on the particles and within the pores.

Solvent selection plays a fundamental role in the use of porous carrier particles for delivery of inorganic metal compounds. Since an important part of the process is to ensure that solutions easily soak into the pores of the porous particles, it is required that the surfaces of the pores are compatible with the solvents used to form these solutions. In one embodiment, when the surfaces of the pores have hydrophilic properties, solvents with high dielectric constant such as water, ethanol, methanol, acetonitrile, dimethylformamide, etc., are easily wicked into the pores by capillary forces. The rate of release of ions can be tailored by varying the size of the porous particles, particle shape and pore geometry (including pore size). In general, smaller particle sizes, elongated or irregular particle shapes vs spherical particle shapes given the same particle volume, and larger pore sizes will result in increased rates of ion release. One may mix different sized particles and also particles with different pore sizes to tailor release properties to suit both short term and long term release of ions in final products. Generally the size of the porous particles is varied between about 0.5 to 20 microns and pore size between 2 nm to 20 nm, with 4 to 15 nm being more preferred. These particles also have high surface areas. Typically particles with surface areas greater than about 20 m²/g are desirable, and those with surface areas greater than about 100 m²/g are preferred.

The particles of this invention may also be fabricated in a core-shell geometry, wherein the core may be a solid support and these are treated with solutions as described above so that these get coated with an antimicrobial material. That is rather then using porous particles, solid particles are used. Examples of core materials are silica, titania, sand and carbon. Such core particles may also be nanosized. Preferred antimicrobial materials are silver halides, copper halides and CuSCN, of which CuI is more preferred.

Another variation in core shell geometry is where the antimicrobial particles are first formed in a desired size and then these are encapsulated in porous or permeable shells so as to allow the antimicrobial material or the ions to pass through. One method is to form the antimicrobial material particles by grinding in a liquid medium comprising organosilanes or/and other organic templates such as polyethylene glycol, drying this into a powder, and then heating this to decompose all or part of the organic group (but below the sintering temperature) so that antimicrobial particles will be captured in porous silica cages. Depending on the amount of the antimicrobial material and the silane along with the amount and the molecular weight (or size) of the organic group or the template, one can control the thickness and the porosity of the surrounding cage. The process of grinding and drying is discussed more extensively in the next section. Preferred antimicrobial materials are metal halides, particularly copper iodide.

i. Formation of Functionalized Particles by Grinding

In an earlier section on functionalization materials, several examples were cited which used grinding as a method to produce functionalized particles. Generally the starting particles of the antimicrobial materials have an average size larger than 1 micron, typically in the range of 1 to 1,000 microns. These are reduced in the grinding step to an average size below 1 micron (1,000 nm) or even below 100 nm or even below 10 nm depending on the desired size. This process is described in more detail in this section.

In this operation the functionalization materials are incorporated into the grinding medium or incorporated soon after the grinding operation. There are many advantages of the grinding process which include: (a) increased yield both in terms of amount and the concentration of the particles produced. (b) scalability on an industrial scale; (c) reduced waste both in terms of hazardous chemicals and also in terms of additional equivalents of starting materials that are typically required in chemical synthesis methods; (d) reduced energy requirements in terms of simplified processes and handling, removal and drying of larger quantity of solvents relative to the material produced; (e) reduced cost of production while adopting “clean and green” manufacturing methods; (f) increased versatilityin terms of the chemistry of the functionalizing agent; (g enhanced capability in being able to use more than one functionalization agent with different chemistries; (h) avoidance of the long development process which is typically required for each new set of particle composition and functionalization agent when chemical synthesis methods are used; (i) new capability of imparting additional attributes to the antimicrobial materials via the functionalization agents; (j) increased ability to tune/control the size of the resulting particles from a few nanometers to 1,000 nm or above; and improved ability to produce fine antimicrobial particles without introducing undesirable amounts of functionalization agents.

As an example, in many of the chemical synthesis methods where functionalized particles are made in solvent systems, such as making CuI particles functionalized with PVP, the latitude for processing and the materials used is quite limited in terms of the type of the chemistry of the antimicrobial particle being formed and also the chemistry of the surface functionalization material. First, both the antimicrobial material (e.g., Cue and functionalization agent (e.g., PVP) have to be soluble in a common solvent (such as acetonitrile), Second, the amount of functionalization agent required is very high when small particles are produced—typically the weight ratio of antimicrobial particle material to the surface functionalization agent is about 5:100 or less, and generally 1:100 or less. This results in significant amount of the functionalization agent which ends up in final products and often compromises the properties of those products. Third, one must handle and dispose of the solvent used in the synthesis, which introduces additional cost and complexity to the process. Fourth, it can be a major undertaking to change the chemistry of the particles or the functionalization agent.

As another example, consider the limitation of the chemical method which is typically used for making silver iodide nanoparticles. These particles are made by taking an aqueous solution of a soluble silver salt such as silver nitrate along with a water-soluble polymer such as PVP. To this under stirring conditions is added another aqueous solution of sodium iodide (sodium iodide is soluble in water as well). This causes silver iodide particles to precipitate. In this case, the ratio of Ag to the functionalization agent is also about 1:100, with an added complication of removing sodium and nitrate ions. Further, if one needs to add 0.1% of the antimicrobial agent to a product, then the functionalization agent would be present in a 10% concentration, and such additions and can considerably modify the properties of the product in an undesirable way. Still further, difficulties are encountered if one wants to functionalize with materials which are not soluble in water; and new synthesis routes must be explored if one wants to change the chemistry of the antimicrobial particles.

As an additional example, many useful paints and varnishes are deposited from aqueous formulations containing polymeric emulsions. Typically these polymers are not water soluble so that the coatings after drying are water-resistant; but for processing, these polymers are made compatible with water formulations by polymerizing them in water with surfactants so that water-stable emulsions can be formed. Since a wide range of polymers are used with many different kinds of surfactants, it is very challenging to develop chemical methods to accommodate the different emulsions and particles. In contrast, in the preferred process embodiment of the present invention, CuI (or another antimicrobial material) can be ground with these emulsions (or surfactants used to form these emulsions) to make antimicrobial formulations in a simple way. The process does not require addition of any extra ingredients which have the potential to change the properties of products containing the antimicrobial particles. Further, formulations made using the present process invention can be used as such and do not require handling of solvents and their removal, or production of byproducts which need to be removed, all of which lead to greener production technologies with lower energy consumption.

There are many examples and teachings in the present application which demonstrate one or more merits of the grinding method.

One such method of forming the desired microparticles and nanoparticles is by grinding of larger particles in a wet media mill. Such grinding is done in the presence of one or more functionalizing agents in an appropriate liquid medium, e.g. water. Wet media mills are available from several sources such as NETZSCH Fine Particle Technology, LLC., Exton Pa. (e.g., Nanomill Zeta®); Custom Milling and Consulting, Fleetwood, Pa. (e.g., Super Mill Plus); Glen Mills Inc, Clifton N.J. (e.g., Dyno® Mill). These mills typically comprise chambers in which hard ceramic or metal beads (grinding media) are vigorously stirred along with the slurries of the powders which result in grinding of the powders down to finer sizes. Typically, the size of the beads is about 1,000 times or more larger than the smallest average size to which the particles are ground to. It is preferred to use beads about 1 mm or smaller and more preferably in the range of about 0.04 to 0.5 mm and most preferably 0.3 mm or smaller. The grinding procedure may start with a larger bead size to grind initially the large chunks/particles of antimicrobial material to a smaller particle size and then using smaller beads to reduce the particle size further. As an example, when one starts grinding particles which have a starting size in the range of about 30-50 microns, a bead size of 0.3 mm is used, which will result in particles of about 100-400 nm in average size. In the next stage, one may use beads of 0.1 mm in diameter which results in particles ground to about 30-100 nm, and next one would use 0.05 mm diameter beads which provide particles in the range of about 15-50 nm. The particle size of the ground particles is not only dependent on the size of the beads, and other grinding parameters such as time and speed of grinding, but also on the formulation. As an example, for a given set of grinding parameters, the concentration of material being ground and the type and amount of surface functionalization, the amount of viscosity controller (if any) and other additives will influence the particle size. For a material being ground in water (carrier), the following formulation variables will reduce the particle size when the same grinding parameters are used. These are (a) smaller amounts of material relative to the carrier, (b) use of a functionalizing agent that bind strongly to the surfaces of the particles of the material being ground, and (c) use of functionalizing agents that result in low viscosity. Under certain conditions one can produce particles as small as 5 nm using grinding beads which are 0.1 mm in size. Functionalizing agents may be present at the start of the grinding process (preferred), or more amounts or different agents may be added as the grinding proceeds.

A wide range of particle sizes may be used to provide antimicrobial properties to products incorporating such particles, but particle sizes below about 300 nm are preferred. The liquid media from the grinding containing the ground particles may be directly incorporated in products (e.g., in coating formulations, low viscosity suspensions such as many shampoos, high viscosity suspensions such as creams and gels, etc.), or these may be dried (e.g, using a rotary evaporator unit or by spray drying) so that the particles along with the functionalizing agents are obtained as powders or flakes, where these powders or flakes particles are preferably sufficiently large to minimize potential health issues for workers handling the materials. The particles or flakes may then be incorporated in useful formulations including melt blending with other polymers to form products by molding, extrusion, powder coating, etc.

In order to obtain dry powders, where the size of the powder or flake material is large (preferably greater than 1 microns, more preferably greater than 10 microns and most preferably greater than 100 microns), where powder or flake particle contains several functionalized anti microbial particles, it is preferred that before drying the liquid, sufficient functionalizing agents and/or polymers (e.g., which can provide a binding function) are added, so that the volume percent of the functionalizing agent and the polymeric material is preferably greater than 20% or more preferably greater than 40% in the dry state. The binding additives (if different from the functionalizing agents) may also be added after the grinding process is complete, As a specific example, one may use 80-90% of metal halide (e.g., CuI) particles by weight, with 1-5% of an anionic surfactant by weight, and the remainder being a polymeric binder by weight. This would meet the volume percentage criteria taught immediately above.

It is preferred to add the functionalizing agents while the particles are being ground and smaller particles with fresh surfaces are produced. There is, however, an exception to this process protocol which can be use to advantage. The particles may be produced by grinding so as to reduce the size of the larger particles of the antimicrobial material in water (or acidified water) or even in an inert liquid medium. After the grinding process is substantially over, i.e., after the desired particle size is about reached, the surface functionalization agents are added and a short period of additional grinding is carried out to produce the desired functionalized particles.

When grinding is carried out in an aqueous medium, the functionalizing materials should be so selected so that they can interact with the surface hydroxyl groups on the particles (formed as a result of grinding in water) and bond to or react with them. If the grinding is carried out in an inert medium, the functionalizing materials should be selected so as to be able to interact with the newly formed surfaces.

The functionalizing agent is preferably added before the particles start agglomerating into larger sizes. From our practical experience we have noted that this addition of the functionalization agent should preferably be done within 48 hours of grinding, and more preferably immediately after grinding. One may even optionally introduce a second step of grinding after adding the surface functionalization agent for more intimate and a quick dispersion of the added material and also to break agglomerates that may have formed during the waiting period.

One advantage of using the grinding process to produce functionalized particles of antimicrobial materials is the ability to use minerals which have antimicrobial compounds naturally incorporated in them. Such minerals can be ground to provide antimicrobial materials. Such grinding is preferably done in presence of functionalizing agents. Some examples of minerals with silver or copper halides along with their principal compositions are Iodagyrite (AgI), Bromargyrite (AgBr), Chlorargyrite (AgCl), Iodian Bromian Chlorargyrite (Ag(I, Br, Cl)), Nantokite (CuCl) and Marshite (CuI).

The grinding method is generally more suitable for materials which are brittle and have a hardness and toughness lower than that of the grinding beads. The lining of the grinding vessel may be ceramic or of metallic or may have a polymeric finish. Typical grinding beads are hard, tough ceramic compositions such as compositions based on zirconium oxides (zirconia). Hard beads with zirconia comprising at least one of yttrium oxide, magnesium oxide, cerium oxide and calcium oxide are commercially available. The compositions of these beads typically contain more than 80% of zirconium oxide by weight; and the other oxides are added to stabilize the high-temperature phase of zirconia and thereby increase the toughness of the materials. The yttria stabilized zirconia (YTZ) beads from Tosoh USA have 5% yttria and 95% zirconia with a hardness of HV 1250 and fracture toughness of 6 MPa-m^{0.5}. Various publications list the hardness of yttria stabilized zirconia between 8.5 to 10 on Moh's scale. A desired hardness of the beads should exceed 500 on knoop scale or greater than 5 on Moh's scale [preferably greater than 1,000 on Knoop's scale or greater than 7.5 on Moh's scale or greater than 800 on Vicker's scale using 10 kgf, also called HV10)]. The beads should also have fracture toughness in excess of 5 Mpa-m^{1/2} (more preferably greater than 7 Mpa-m^{1/2}). Some suppliers for stabilized zirconia beads (grinding media) include Tosoh USA (Grove City, Ohio), Prime Export and Import Company Ltd (China), Stanford Materials (Irvine, Calif.), Inframet Advanced Materials (Manchester, Conn.). Depending on the materials being ground and the liquid being used, one may also use beads which are non-ceramic, such as metallic beads. These beads may be made of stainless steel, tempered carbon steel with grain structures which result in high hardness and toughness relative to the material being ground. Ceramic and non-ceramic beads are also available from several of the above mentioned manufacturers who also sell the grinding equipment. In general, hard ceramic beads are preferred because of the risk of contamination when using metallic beads.

The material to be ground should be lower in hardness as compared to the grinding beads. On Mohs scale, the hardness of the material to be ground should preferably be smaller than that of the grinding media by a factor of at least 2 Moh units or more and more preferably 3 units or more. Further the material to be ground should be brittle. In general, brittle materials often have fracture toughness (K_{IC}) of less than 2 Mpa-m^{1/2}.

Many of the metal halides and the preferred metal salts of silver and copper are available as powders, and their fracture toughness is not mentioned or evaluated. However, most of these materials (silver halides, copper halides, CuSCN and Cu₂O) are soft and brittle (not malleable) by nature and are easily processed by grinding. Usually copper and silver halides have hardness in the range of 2 to 3 on the Moh's scale, and Cu₂O crystals have a hardness in the range of 3.5 to 4 on the same scale. The process of grinding to make functionalized antimicrobial nanoparticles discovered in the present work is applicable to a wide range of metal halides and other copper salts of interest. The process is also useful for preparing functionalized particles of other compounds (e.g., AgBr, AgI), such as brittle metal oxides (e.g., zinc oxide, silver oxide and cuprous oxide).

J. Product-by-Process

Another embodiment of the invention described herein is a composition having antimicrobial activity made according to the process comprising the steps of obtaining CuI powder; dissolving the CuI powder in a polar nonaqueous solvent; adding an amount of hydrophilic polymer sufficient to stabilize the CuI in the polar, nonaqueous solvent; removing the solvent sufficient to dry the stabilized CuI particles whereby a polymer-complexed CuI particle powder is formed; dispersing the polymer-complexed CuI particle powder in an aqueous solution having a pH of from about 1 to about 6 to form CuI particles stabilized in water whereby a polymer-complexed CuI particle; and optionally drying said stabilized CuI particles sufficient to remove the water. The process is efficient and highly quantitative.

Selection of the CuI powder source is the first step. CuI powder is typically purchased from any of numerous vendors. Several grades or different purity are acceptable, although a preferred starting material has a purity of at least 98% CuI. Dissolution of the CuI is the next step. The CuI powder is dissolved in a polar nonaqueous solvent such as acetonitrile, although one of ordinary skill will realize that other nonaqueous solvents will function for this purpose, and come within the scope of the invention (CuI is soluble in polar nonaqueous liquids such as acetonitrile, dimethylformamide, etc.) It is preferred not to use protic polar solvents.

The next step is adding a functionalizing agent to the CuI solution. The functionalizing agent complexes with the CuI, so that when acetonitrile is removed the particles of CuI are prevented from coming together to form relatively large crystals. One preferred polymer is polyvinylpyrrolidone (PVP) which has dipole-bearing moieties and effectively stabilizes emulsions and suspensions of particles. Depending on the amount use, the polymer can be adsorbed in a thin layer on the surfaces of the individual particles. Other preferred polymers having dipole-bearing moieties include polyethylene glycol (PEG), surfactants, and polymeric colloids. The polymers may be hydrophilic such as PVP, polyacrylamide and PEG, copolymers of vinyl acetate and vinyl pyrrolidone or they may be hydrophobic such as several acrylic and methacrylic polymers as well as polyesters and polyurethanes. Preferred hydrophobic polymers include acrylics, urethanes, polyesters and epoxies. The ratio of metal halide to polymer is preferably from about 2:1 to about 1:100, more preferably 1:1 to 1:80, and a most preferred ratio in the case of PVP is about 1:1 to 1:65.

The next step is the creation of nanoparticles of CuI in the presence of the functionalizing agent. In one embodiment, acetonitrile is removed using a rotary evaporator, which causes the CuI particles to precipitate out of solution as nanoparticles complexed to the functionalizing agent. This can be done at room temperature or the temperature can be elevated to hasten the drying process. The resulting powder can be stored indefinitely (“Step 1 Powder”).

The dry powder from above (called as “Step 1 powder”) comprising CuI nanoparticles and the surface modifying polymer can be dissolved in water to give a suspension of the nanoparticles. The concentration of CuI in the suspension is adjusted by varying the powder to water ratio. Adjusting the pH of the solution at this stage helps further improve the binding of the polymer to the nanoparticles and helps to break any agglomerates which may have formed. The preferred pH range is from about pH 0.5 to about pH 6. A specific pH value is dependent on the functionalizing agent, the size of the particles desired, the loading of the antimicrobial particles relative to the functionalizing agent and the medium in which the particles will be dispersed later. Useful acids to adjust pH include organic acids such as acetic acid, or mineral acids such as HCl, H₂SO₄ and HNO₃. The solution is stirred until maximum optical clarity is achieved. The typical size of the resulting CuI particles ranges from about 3 nm to about 300 nm. Clear aqueous solutions typically have CuI particle sizes below about 10 nm, and with increasing particle size they become translucent to turbid. These solutions may also be dried and stored as powders (“Step 2 Powder”), which may be later dispersed into solutions. The average particle sizes of CuI in Step 2 Powders are typically smaller than the CuI particle sizes in Step 1 Powders.

The Powder (either from Step 1 or from Step 2) may be mixed in a molten state with typical thermoplastic materials, such as nylons, polyesters, acetals, cellulose esters, polycarbonates, fluorinated polymers, acrylonitrile-butadiene-styrene (ABS) polymers, and polyolefins using a twin screw extruder. PEG or non-ionic surfactants are a preferred functionalizing material for incorporating such nanoparticles into nylons, polycarbonates and polyester matrices, as transesterification will cause PEG to react with these materials and form covalent bonds to the polymer matrix. The high shear forces in a twin screw extruder will also help the particles disperse. Such extrusion is preferably done in two steps. In the first step, a concentrated antimicrobial polymer material is made with a relatively high concentration of functionalized antimicrobial metal halide particles of the invention, typically 1 to 10% by weight of the metal as metal halide. This is usually blended in a twin screw type setup to provide very intimate mixing. This is called a “masterbatch.” This masterbatch can then be blended with resins so that the concentration of the antimicrobial material drops by a factor of about 5 to 25, and these blends are then used to make polymeric products by molding, extrusion, etc, where the concentration of the antimicrobial material in the final product is generally less than 2%, preferably about or less than 1% by weight of the metal as metal halide. The masterbatch can be blended with the neat resin using processing equipment such as injection molding or extrusion machines, which makes to the final product. Typically for metal halides, these weight fractions are expressed in terms of the weight of the cations only.

k. Theory

While not wanting to be bound by a particular theory regarding the origin of the surprising antimicrobial effectiveness of the novel compositions of the present invention, it is currently believed that the compositions of the invention (or ions released therefrom) are attracted to the surfaces of target pathogens. Once attached to the surfaces of the pathogens, the active oligodynamic species (generally metal cations but also including anions such as iodide) are transferred from the particles onto and/or into the pathogens. In some embodiments, the interaction between the functionalized particles and the pathogens may be sufficiently strong that the particles become embedded in the outer membrane of the pathogen, which can have a deleterious effect on membrane function. In other embodiments, particularly when the particles are very small (as less than 10 nm in size), the functionalized particles can be transported across the outer membrane of the pathogen and become internalized. Under these conditions, the oligodynamic species can directly transfer from the particles into the pathogen, bind to proteins, organelles, RNA, DNA etc. thereby hindering normal cellular processes. In the case of bacteria, this would correspond to the direct deposition of the active oligodynamic species in the periplasm or cytoplasm of the bacteria. This theory of the operative mechanism of the invention is just that, and is one of many that could explain the underlying efficacy.

### 4. Uses of the Compositions

The embodiments of the present invention have utility in a wide range of antimicrobial applications. Some of these applications are set forth in Table 1c below. Besides their direct use as antimicrobial compounds, other embodiments include several ways in which the functionalized particles can be incorporated into other materials to obtain novel and useful objects.

TABLE 1c
Representative Applications of Functionalized Antimicrobial Nanoparticles

| No. | Application |
|---|---|
| 1. | Antimicrobial agents, administered either orally or via IV infusion |
| 2. | Coatings on implants |
| 3. | Constituents of implants |
| 4. | Sutures and medical devices |
| 5. | Pacemaker housings and leads |
| 6. | Filters for water supplies and air |
| 7. | Clothing for medical personnel, including nurses and surgeons |
| 8. | Coatings on or direct incorporation in components of ventilators, air ducts, |
| | cooling coils and radiators (for use in buildings and transportation) |
| 9. | Masks |
| 10. | Medical and surgical gloves |
| 11. | Textiles including bedding towels, undergarments and socks |
| 12. | Upholstery, carpets and other textiles, wherein the particles are incorporated |
| | into the fibers |
| 13. | Coatings on furniture for public use, as in hospitals, doctors' offices and |
| | restaurants |
| 14. | Wall coatings in buildings, including public buildings such as hospitals, |
| | doctors' offices, schools, restaurants and hotels |
| 15. | Coatings or compositions for use in transportation, such as ships, planes, |
| | buses, trains and taxis, where the antimicrobial compositions and coatings |
| | may be used for/applied to walls, floors, appliances, bathroom surfaces, |
| | handles, knobs, tables and seating |
| 16. | Coatings on and constituents of shopping bags |
| 17. | Coatings on school desks |
| 18. | Coatings on plastic containers and trays |
| 19. | Coatings on leather, purses, wallets and shoes |
| 20. | Incorporation in gloves, and liners for gloves, shoes and jackets |
| 21. | Coatings on shower heads |
| 22. | Self-disinfecting cloths |
| 23. | Coatings on bathroom door knobs, handles, sinks and toilet seats |
| 24. | Coatings on bottles containing medical or ophthalmic solutions |
| 25. | Coatings on or direct incorporation in keyboards, switches, knobs, handles, |
| | steering wheels, remote controls, of automobiles, cell phones and other |
| | portable electronics |
| 26. | Anodized coatings |
| 27. | Powder coatings |
| 28. | Coatings on toys, books and other articles for children |
| 29. | Coatings on or incorporation in gambling chips, gaming machines, dice, etc. |
| 30. | Topical creams for medical use including use on wounds, cuts, burns, skin |
| | and nail infections |
| 31. | Shampoos for treating chronic scalp infections |
| 32. | Coatings on handles of shopping carts |
| 33. | Coatings on cribs and bassinettes |
| 34. | Bottle coatings for infant's bottles |
| 35. | Coatings or direct incorporation in personal items/use such as toothbrushes, |
| | hair curlers/straighteners, combs and hair brushes, nail polish |
| 36. | Coatings on currency, including paper, tissue paper, plastic and metal |
| 37. | Coatings or direct incorporation in sporting goods such as tennis rackets, |
| | gold clubs, gold balls and fishing rods |
| 38. | Adhesives used in bandages, wound dressings |
| 39. | Anti-odor formulations, including applications for personal hygiene such as |
| | deodorants |
| 40. | Objects and coatings to prevent formation of biofilms, particularly in |
| | medical and marine applications |
| 41. | Dental applications- coatings on implants, incorporation in primers, sealants |
| | and composite fillings used for tooth restoration, incorporation in denture |
| | materials. |
| 42. | Molded and extruded products, including waste containers, devices, tubing, |
| | films, bags, liners gaskets and foam products. |
| 43. | Foams (flexible and rigid) |
| 44. | Coating of flowers and flower heads |
| 45. | Adhesives (includes caulking materials), gaskets thermosetting materials |
| | and composites |
| 46. | Use as a biocide in aqueous systems |
| 47. | Portable toilets |

a. Incorporation Methods

Embodiments of the invention are directed to compositions having antimicrobial activity made according to a process comprising the steps of (a) forming functionalized copper iodide nanoparticles having an average size between 1000 nm and 4 nm; (b) dispersing the functionalized copper iodide nanoparticles in a suspending medium; (c) adding a quantity of the dispersed copper iodide nanoparticles to a manufacturing precursor; and (d) forming an article of manufacture at least partially from the manufacturing precursor whereby copper iodide nanoparticles are dispersed throughout the article. The manufacturing precursor may comprise a polymeric material.

In further embodiments incorporation of the functionalized nanoparticles of the invention in molded and extruded thermoplastic products is typically achieved by first making masterbatches, wherein the functionalized antimicrobial compound (or particles infused in porous matrices) are present in relatively high concentrations in polymeric matrices (preferably 1 to 15% of metal (as metal compound) by weight). The masterbatches are then compounded with the polymer (resin) to make the molded or extruded product. This is typically done by first functionalizing the antimicrobial particles with agents which are compatible with the matrix resins. The functionalized particles are formed in a dry state by removing water or any other solvents which are used in their preparation and mixing them with the desired resins, usually on a mill or a twin screw extruder so that these mix intimately to have a high concentration of the antimicrobial compound. As noted above, this is called a “masterbatch.” This masterbatch is typically produced by companies which specialize in homogenously blending the two together and deliver their products as pulverized powders or pellets.

The masterbatches are then used as additives to the matrix resins by processors who to use molding and/or extrusion operations to make products. Such plastic processing operations include injection molding, injection blow molding, reaction injection molding, blown film processing, blow molding, rotational molding, calendaring, melt casting, thermoforming, rotational molding and multishot molding. Starting with the antimicrobial concentration in a masterbatch as cited above, the processors use a typical ratio of resin to masterbatch material of 10:1 to about 25:1 or so, which will then result in end products with concentrations of antimicrobial particles of about 0.1 to 1% (based on metallic concentration).

Another important aspect should be considered when preparing the nanosized antimicrobial materials to be incorporated in downstream processing (e.g. at the facility of the masterbatch producer). To protect the health and safety of the workers employed in such a facility or other downstream processor, it is important to minimize the possibility of getting the nanoparticles airborne. An effective method of accomplishing this involves making the particle size of the dried powders containing the antimicrobial particles relatively large compared with the size of the individual nanoparticles. The size of the dried powders should be greater than 1 microns, preferably greater than 10 microns, and most preferably greater than 100 microns Such dry powders are easily handled and transported for downstream operators to use in paints, resins and other liquid carriers to create coatings or objects incorporating the functionalized nanoparticles.

Antimicrobial compositions of this invention may be added to extruded or molded polymer products homogeneously or may be applied to these objects as coating layers using operations such as extrusion or molding. In the latter case, operations such as co-extrusion, in-mold decoration, in-mold coating, multi-shot molding, etc are used where the antimicrobial additive is only present in that resin/material which forms the skin of the product as a result of these operations.

The functionalized microparticles and nanoparticles of the present invention may also be used by combining them with monomeric compositions or with solutions of pre-formed polymers, where the resulting materials containing the functionalized particles may be used to create two- and three-dimensional objects, adhesives and coatings, where the compositions are polymerized or crosslinked or densified after processing/setting the compositions into their final form. Coatings may also be deposited from solutions and aqueous polymeric emulsions containing the functionalized antimicrobial particles, where the formulations preferably comprise one or more film-forming polymers, or the particles may be employed in powder-coat formulations which are then processed into coatings.

Water based acrylic, epoxy and urethane paints are used in many applications. These are typically emulsions of hydrophobic polymers in water. After application to a surface, the water evaporates and the emulsions coalesce leaving a hydrophobic coating. In order to impart antimicrobial properties to these coatings, one can take the emulsions (preferably before fillers are added) and grind the antimicrobial particles in the presence of a functionalizing agent to produce small functionalized antimicrobial particles. The antimicrobial material can be in high concentration and such concentrates may be added to the paint formulations to provide antimicrobial properties to the coated objects. Alternatively, one may also grind the antimicrobial material with a compatible functionalizing agent (such as a surfactant) which may even be the same as the surfactant used as an emulsifier in the paint, and then such powder can be added to the paints. In yet another method, porous carrier particles with antimicrobial particles therein can be produced, which are then added to the paint formulations.

As another specific example, these methods may be used to incorporate particles of this innovation in formulations of nail polish (a coating application), which are available as water or solvent based. Typical solvents used in nail polish are acetates (e.g., butyl acetate). The particles may be ground with using solutions of the polymers and/or surfactants which are used in these applications and are then added to the final nail polish composition. Since the final compositions are quite viscous, it is often desirable to grind the particles separately as suggested above, or the complete nail polish formulation with excess solvent may be used as the liquid medium, and the excess solvent is removed later. While these nail polishes can provide protection by preventing microbial growth, such nail treatments may also be used to actively treat nail fungal infections.

When used in coatings and molded and other three dimensional products, the particles may scatter light, depending on their concentration, size and refractive index relative to the matrix. This can give rise to opacity or haze with increasing product thickness, larger particles, higher particulate concentrations and larger differences between the refractive index (RI) of the particles and the matrix. In many applications, this is not an issue, since the products contain other opacifiers such as titanium dioxide. In other cases, e.g., for optical and ophthalmic products, clarity is important, and one may use the materials of the present invention provided the above-cited parameters are controlled. the RI of most common polymers have an RI in the range of 1.4 to 1.6. Silicones will be closer to 1.4, acrylics closer to 1.5 and polycarbonate closer to 1.6. By comparison, the RI of copper iodide (as an example) is 2.35. For high clarity (or low haze, typically less than 2% in the visible wavelengths as measured by ASTM test method D1003), it is preferred that the size of CuI particles be less than about 120 nm, volume loading less than about 2% and product thickness less than about 0.1 mm. CuBr and CuCl have lower refractive indices compared with that of CuI and will allow relaxation of these numbers (meaning larger particle sizes, higher volume loading and thicker products in products of high clarity).

Functionalized antimicrobial particles may be produced in aqueous media (e.g., by grinding or the other described processes) and added to the leather tanning solutions. When leather is soaked in these solutions and later dried, it will retain the antimicrobial particles which will result in antimicrobial leather. In carrying out this process, the leather may be soaked in the antimicrobial solutions after fats and oils have been removed and washed or may be incorporated within the tanning solution.

As yet another example, one may also produce antimicrobial foams which are used for a number of applications. For example, polyurethane foams are made using a formulation produced by mixing an isocyanate with a polyol (a molecule with three or more hydroxyl groups) a chain extender (a bifunctional hydroxyl molecule), catalysts to promote reaction, surfactant, heat and/or UV stabilizers along with a foaming agent. The foaming agent could be water as it produces carbon dioxide gas when it reacts with the isocyanate. One method of making antimicrobial foams involves producing antimicrobial particles with a surfactant (using a surfactant compatible with the system or the same which is used in the system) and adding these to the foam formulation. Another alternative involves producing nanoparticles in an aqueous media, such as by grinding them in water along with the desired surfactant and then adding this to the foam formulation both as a foaming agent and as an antimicrobial source.

Another method by which they may be added to solid carriers is by grinding the antimicrobial materials in liquid plasticizers. As an example, phthalate ester plasticizers may be used as a liquid medium for grinding the antimicrobial material in the presence of a functionalizing agent, and when such ground compositions are added to plasticize polyvinylchloride (PVC), than the resulting plasticized PVC acquires antimicrobial properties. Alternatively, one may also grind the antimicrobial material with a compatible surface functionalizing agent (such as a surfactant) which is then added to the plasticizer before incorporating this mixture into the polymer.

Imparting a thin coating to a surface allows one to obtain antimicrobial properties on a surface without infusing the potentially expensive materials into the bulk of the object. Powder coatings with the antimicrobial additives of this invention can be formed on metals, ceramics and other polymers (thermoplastics and thermosets). The technology for powder coating of materials is well established (e.g., see “A Guide to High Performance Powder Coating” by Bob Utec, Society of Manufacturing Engineers, Dearborn, Mich. (2002).) The matrices for powder coats are typically epoxies for indoor use where high chemical resistance is required and acrylics and polyesters including epoxy-polyester hybrids for outdoor use where superior UV resistance is needed. In typical powder coating operations, the object to be coated is suspended in a fluidized bed or subject to an electrostatic spray so that particles flowing past this object may stick on its surface (where the particles contact and melt due to higher surface temperature or the particles are attracted due to the static attraction and melted later). Typically, the powders melt and cure forming a coating. The coating processing temperatures are typically in the range of about 80 to 200° C. In the past, mainly metals were coated with polymeric powders. Recently, however, increasing use is being made of polyurethane powders for coating objects made of thermoset polymers and acrylic powders for coating thermoplastics objects (including acrylics which are cured using UV after the coating is deposited).

To produce powder coatings, one may prepare powders of functionalized antimicrobial particles or incorporate antimicrobial particles in porous materials (such as porous silica) and then dry blend with powder coating resins. Other ingredients such as crosslinking agents, degassers (defoamers) and flow additives may also be added to this blend, which is then mixed in an extruder where the resin melts and is the composition is extruded, and the material pulverized. This powder is then used to coat the objects (e.g., by a corona gun) and then heat treated to fuse the powder on the substrates which results in a antimicrobial coating.

The materials of the present invention may also be incorporated in anodized coatings to provide antimicrobial characteristics in addition to the wear and corrosion resistance which these coatings impart to the surfaces. Anodization is used to coat/treat many metals and is most often used for magnesium, aluminum and their alloys. Anodization is an electrochemical process, wherein the metal object or substrate is cleaned and placed in the electrochemical bath, which is typically acidic. There are several variations where organic or inorganic acids are used for this purpose and are well known in the art. The typical thickness of anodized layers is in the range of 0.5 to 150 μm. One method to incorporate the antimicrobial materials of this invention involves treating the anodized objects with solutions of functionalized nanoparticles of the antimicrobial agent so that they can penetrate the porous structure of the anodized layers and get trapped in the interiors (anodized coatings are usually porous with a pore size of 5 to 150 nm). Another method involves incorporating the functionalized antimicrobial particles during the process of anodization. In this process, the antimicrobial nanoparticles are typically functionalized with acids or even acidic polymers such as polystyrene sulfonic acid and then such functionalized particles are added to the anodization bath. Such functionalization imparts negative zeta potential to the particles so that they have sufficient mobility in the applied field towards the anode and get incorporated within the anodized coatings as they grow on the surfaces of the objects being anodized.

Other embodiments of products formed from the antimicrobial compositions of the present invention include topical creams for both pharmaceutical and consumer product use. As an example, functionalized nanoparticles may be added to/formulated with Carbopol® polymers from Lubrizol to produce gels and creams which may be used as antimicrobial creams for treatment of bacterial and fungal infections, wounds, acne, burns, etc. Although any concentration of the functionalized nanoparticles may be used which provides effective treatment, a useful range of metal concentration (from the nanoparticles) in the finished product is 10 to 50,000 ppm. The precise concentration of any particular topical treatment can be assessed by testing the cream in any of the assays for antimicrobial effect presented herein, or known to one of ordinary skill.

The functionalized antimicrobial particles may also be formulated in petroleum jelly to provide superior water resistance. One may use additional surfactants and compatibilizers so that while the hydrophobic petroleum jelly protects the application area, it is also able to release the antimicrobial material to the underlying areas which may be hydrophilic. One of ordinary skill in the pharmaceutical art of compounding will know how to create antimicrobially active creams and ointments in combination with the functionalized metal halide powders of the present invention.

One may also fabricate antimicrobial wound dressings (including burn dressings) using the materials of the present invention. One method involves making aqueous solutions of functionalized particles and dissolving a hydrophillic polymer in the solution (e.g., carboxy methyl cellulose, which may also be used as functionalizing agent). Sheets of foams or gauze may be soaked in these solutions and dried to form the dressings. The feel or the drape of the dressings and their adhesion properties to the wounds may be modified by adding non-toxic surfactants, glycols, fatty acids and oils, etc. to the solution compositions. These dressing may have other medications also incorporated in them (e.g., analgesics) in a post treatment or by adding them to the same solution which contains the antimicrobial particles. These dressing may be a part of (a layer of) a flexible multilayer wound dressing laminate, wherein preferably the layer in contact with or close to the wound contains the antimicrobial material.

The antimicrobial materials of this invention may also be used as additives to other drug formulations including other antibiotic creams or formulations for infection control or related purposes. The antimicrobial materials of this invention may be added in a burn cream, which while assisting the repair of burned tissue will also keep infection away, or it may be mixed with other antibiotics, infection reducing/prevention analgesic materials such as bacitracin, neomycin, polymyxin, silver sulfadiazine, selenium sulfide, zinc pyrithione and paramoxine, Many of these compositions listed above are available in commercial products, and the antimicrobial materials of this invention can be added to them to result in a concentration that is most effective. A preferred range of addition of the inventive antimicrobial materials herein is about 0.001 to 5% (based on the weight of the metal concentration of active ingredients) in the final product. For those formulations where solutions (or suspensions) are used as end products, a preferred range of the inventive antimicrobial material is below 1% by weight.

As another example, the compositions of this invention may be included in hair care products or other body care products such as shampoos, body washes deodorants, nail polish and moisturizers. In such cases, one may grind the particles using the matrix compositions of the respective formulations as the grinding fluids. One may also carry out the grinding in a different medium (e.g., an aqueous medium containing a surfactant or a polymer used in the product formulation), and adding these suspensions to the end products.

Another embodiment of the functionalized metal halide particles is directed to an antimicrobial composition comprising a povidone-iodine solution and at least one type of functionalized antimicrobial particle having an average size of from about 1000 nm to about 4 nm. A further embodiment of the povidone-iodine solution is wherein the antimicrobial particle is selected from the group consisting of copper halide and silver halide, and a further embodiment comprises halides selected from the group consisting of iodide, chloride and bromide, and a still further embodiment comprises CuI. The povidone-iodine compositions of the present invention may also be used to treat animals or humans to treat infected topical areas. As one example, aqueous topical solutions of PVP and iodine (where iodine is about 8 to 12% by weight of the PVP) are commonly used as disinfectants for wounds and for disinfecting skin prior to surgery. BETADINE® is a commercially available PVP-iodine solution. Povidone-iodine (PVP-I) is a stable chemical complex of PVP and elemental iodine. 10% solutions in water are commonly used as a topical antiseptic. One may add the functionalized antimicrobial particles of the present invention (as CuI particles functionalized with PVP) to such PVP-iodine solutions to obtain new disinfectant solutions with notably enhanced disinfecting ability. Compositions of metal halide particles added to such PVP-I solutions also come within the scope of the current invention. Such a metal halide-enhanced PVP-I solution would be formulated having about 88-99% PVP, 2 to 10% Iodine, and 0.005-10% metal halide particles on a wt/wt basis. These weight proportions are relative to these three components excluding water and other solvents.

The compositions of the present invention can also contain any combination of additional medicinal compounds. Such medicinal compounds include, but are not limited to, antimicrobials, antibiotics, antifungal agents, antiviral agents, anti thrombogenic agents, anesthetics, anti-inflammatory agents, analgesics, anticancer agents, vasodilation substances, wound healing agents, angiogenic agents, angiostatic agents, immune boosting agents, growth factors, and other biological agents. Suitable antimicrobial agents include, but are not limited to, biguanide compounds, such as chlorhexidine and its salts; triclosan; penicillins; tetracyclines; aminoglycosides, such as gentamicin and Tobramycin™; polymyxins; rifampicins; bacitracins; erythromycins; vancomycins; neomycins; chloramphenicols; miconazole; quinolones, such as oxolinic acid, norfloxacin, nalidixic acid, pefloxacin, enoxacin, and ciprofloxacin; sulfonamides; nonoxynol 9; fusidic acid; cephalosporins; and combinations of such compounds and similar compounds. The additional antimicrobial compounds provide for enhanced antimicrobial activity. Some of these may be treat humans or animals as a whole (e.g., by oral administration, injection, etc).

Several antimicrobial treatments may require use of sprays (e.g., aerosol spray-on bandages or topical treatments of infections), or even spray-on paints. In many of these cases, it is not desirable to have nanoparticles present in these compositions, since during the spray operation, many of the particles could become airborne and enter the human airways. There are several ways of overcoming this while using the antimicrobial materials of the current invention. One method is to form clusters of functionalized nanoparticles typically larger than 1 micron which keep their togetherness by using a binder which does not allow the nanoparticles to come apart in the spray solvent, For example, the binder may be water soluble while the solvent for the spray (e.g., dimethyl ether, CF₃CHF₂, CF₃CH₂F) would be a non-solvent for the binder and would keep the clusters intact. Another method is to infuse the particles in non-ion exchange porous particles which are greater than about 1 micron in size (as discussed in an earlier section) and incorporate these particles in the aerosol medium.

In cases where it is desired to use functionalized antimicrobial particles in the treatment of lung infections, it is preferred to employ particles with substantial water solubility combined with water-soluble functionalizing agents. In this way, aerosols can be prepared using a nebulizer and delivered to the patient's lungs to provide the desired high dose of antimicrobial activity, and over reasonable periods of time the particles will be eliminated by dissolution. In cases where deep penetration of the antimicrobial agent into the airways is desired, use of small nano-sized particles may be desirable.

Other embodiments of the present invention comprise medical devices that are rendered antimicrobial using methods comprising contacting the surfaces of the devices with the nanoparticle compositions of the invention. Medical devices, without limitation, include catheters (venous, urinary, Foley or pain management or variations thereof), stents, abdominal plugs, cotton gauzes, fibrous wound dressings (sheet and rope made of alginates, CMC or mixtures thereof, crosslinked or uncrosslinked cellulose), collagen or protein matrices, hemostatic materials, adhesive films, contact lenses, lens cases, bandages, sutures, hernia meshes, mesh based wound coverings, ostomy and other wound products, breast implants, hydrogels, creams, lotions, gels (water based or oil based), emulsions, liposomes, ointments, adhesives, porous inorganic supports such as silica or titania and those described in U.S. Pat. No. 4,906,466, the patent incorporated herein in its entirety by reference, chitosan or chitin powders, metal based orthopedic implants, metal screws and plates etc.

Also contemplated by the present invention are antimicrobial fabrics (including carpets), such as those based on synthetic fibers, e.g., nylon, acrylics, urethane, polyesters, polyolefins, rayon, acetate; natural fiber materials (silk, rayon, wool, cotton, jute, hemp or bamboo) or blends of any of these fibers. The fibers or yarns may be impregnated with suspensions of the functionalized antimicrobial nanoparticles, or for synthetic fibers the functionalized nanoparticles may be incorporated into resin melts/solutions (e.g., using the masterbatch approach discussed earlier) that are used to form the fibers. In an alternative embodiment, the fabrics may be provided with coatings containing the antimicrobial compositions of the present invention. Devices, medical including dental and veterinary products and non-medical, made of silicone, polyurethanes, polyamides, acrylates, ceramics etc., and other thermoplastic materials used in the medical device industry and impregnated with functionalized nanoparticles using liquid compositions of the present invention are encompassed by the present invention.

Various coating compositions for different polymeric, ceramic or metal surfaces that can be prepared from liquid compositions are also contemplated by the present invention, as are coating compositions which are impregnated with functionalized antimicrobial nanoparticles after their deposition. The coating compositions deposited from liquid solutions can be hardened by solvent loss or cured by thermal or radiation exposure or by incorporation of polymerization (e.g., cross-linking) agents in the coating formulations. The resulting coatings may be hydrophobic, oleophobic (or lipophobic) or hydrophilic. The oleophobic coatings are typically used on display screens, particularly touch screens and imparting of an antimicrobial character to such surfaces can be valuable.

Antimicrobial medical and non-medical devices of the present invention can be made by treating the devices with the functionalized metal salt compositions of the present invention by different methods. One disclosed method of the present invention comprises the steps of making the compositions in a dry particulate form that may be redispersed in an aqueous or nonaqueous carrier liquid, then contacting the compositions and the device surfaces for a sufficient period of time to allow accumulation of nanoparticles and then rinsing the excess of said composition away and drying the device. A modification of the disclosed method may involve drying or curing the surface of material first and then rinsing off the surface to remove excess. The method of contact may be dipping the device in the compositions or spraying the compositions on the device or coating blends of polymer solution and the compositions.

In other cases, the functionalized antimicrobial nanoparticles or porous particles containing antimicrobial compounds may be incorporated in polymer-based coating solutions from which antimicrobial coatings are deposited by end users. For example, the compositions of the invention may be applied to marine surfaces as a bactericidal agent. As another example, the compositions of the invention may be incorporated in polyurethane coating solutions and applied to furniture or flooring by the end users.

In another aspect, the present invention provides methods and compositions for applying antifouling coatings to an article such as a boat hull, aquaculture net, or other surface in constant contact with a marine environment. Materials that are immersed for long periods of time in fresh or marine water are commonly fouled by the growth of microscopic and macroscopic organisms. The accumulation of these organisms is unsightly and in many instances interferes with function. The natural process of accumulated growth is often referred to as fouling of the surface. There are a number of agents that may be applied to the surfaces to inhibit this growth, and may usefully be combined with the materials of this invention. These agents are known in the art as anti-fouling agents. While many of these agents are highly effective, some of them may be toxic that often leech from the surface of the article and accumulate in the local environment. In one embodiment, the present invention provides a composition for treating a marine surface comprising a particle having at least one inorganic copper salt, and at least one functionalizing agent in contact with the particle, the functionalizing agent stabilizing the particle in suspension such that an amount of ions are released into the environment of a microbe sufficient to prevent its proliferation.

Another application of the present inventions involves stopping the proliferation of microorganisms and the resultant formation of slime (biofilm) in aqueous systems. The materials of this invention are particularly effective when the pH is acidic. The microbes of concern include bacteria, fungi, and algae. The relevant aqueous systems include both industrial and residential applications. Examples of these application include water cooling systems (cooling towers), pulp and paper mill systems, petroleum (oil and gas) operations, water and slurry transportation and storage, recreational water systems, air washer systems, decorative fountains, food, beverage, and industrial process pasteurizers, desalination systems, gas scrubber systems, latex systems, industrial lubricants, cutting fluids, etc.

In petroleum applications, antimicrobial materials (or biocides) are used in hydraulic fracturing fluids (also called fracking fluids) and/or breaking fluids typically used for oil and gas wells. These biocides are added so that bacteria do not proliferate in wells and pipes, since the bacteria may clog the pipes due to the formation of slime and also release hydrogen sulfide gas. In this application, the antimicrobial agents of the present invention may be used in several ways. In one method, the functionalized antimicrobial particles or the porous particles with the antimicrobial material may be added directly to the fluids. A preferred functionalization agent is a component which is already used in the water treatment fluid, such as a surfactant, corrosion inhibitor, friction reducer, gel, acid or a scale inhibitor, etc. The materials of the present invention when added to the fluids are effective at low metal concentrations (below 300 ppm and preferably lower than 100 ppm). Another method involves using particles with a core-shell geometry, where the preferred core is one of the proppants used in the fluid, which is then coated with the antimicrobial material. Yet another method involves coating the interior of the pipes used for this application with compositions containing the antimicrobial materials, which will prevent biofilm formation on these surfaces. One may also combine several of these methods.

Yet another application of the present invention is to situations where human waste is collected for a period of time before it is disposed—for example, in waste control in portable toilets. Such toilets are extensively used to provide facilities for temporary use such as in construction and other military and civilian activities, and the application also includes toilets used in the transportation industry such as planes, buses, trains, boats, ships and space travel. In these applications, it is important to control microbial proliferation in the tanks holding such wastes for days to months. The antimicrobial materials may be added to the contents of these tanks as additives and/or also used for coatings on the interior of the tanks. One may also incorporate the antimicrobial materials in disposable liners in these tanks.

In many of these examples, the materials of this invention may be combined with other known antimicrobial materials used for that particular application.

The following examples are illustrations of the embodiments of the inventions discussed herein, and should not be applied so as to limit the appended claims in any mariner.

### EXAMPLES

List of Chemicals Used:
1. Silver nitrate>99%, Sigma-Aldrich (Milwaukee, Wis.) #S6506, 169.87 g/mol
2. Copper(I) Bromide>98% (Sigma Aldrich #61163)
3. Copper(II) acetate monohydrate≧98%, Sigma-Aldrich #217557, 199.65 g/mol
4. Sodium borohydride≧98.0%, Sigma-Aldrich #452882, 37.83 g/mol
5. Sodium hydroxide≧97.0%, Sigma-Aldrich #221465, 40 g/mol
6. Mercaptosuccinic acid (Thiomalic acid)≧99.0%, Sigma-Aldrich #88460, 150.15 g/mol, HOOCCH(SH)CH₂COOH
7. N-(2-Mercaptopropionyl)glycine (Thioglycine), Sigma-Aldrich #M6635, 163.19 g/mol, CH₃CH(SH)CONHCH₂COOH
8. Thioglycerol 95%, TCI America (Portland, Oreg.) #T0905, 108.16 g/mol, HSCH₂CH(OH)CH₂OH
9. Lipoic acid≧98.0% (Thioctic acid), Sigma-Aldrich #62320, 206.33 g/mol
10. Thiolactic acid 95%, Sigma-Aldrich T31003, 106.14 g/mol, CH₃CH(SH)COOH
11. (3-Mercaptopropyl)trimethoxysilane 95% (Thiosilane), Sigma-Aldrich #175617, 196.34 g/mol
12. 2-Aminoethanethiol>95% (Aminothiol), TCI America #77.15 g/mol
13. Aspartic acid≧99%, Sigma-Aldrich #A9006, 133.10 g/mol
14. Leucine≧99%, Sigma-Aldrich #L7875, 131.17 g/mol, CH₃)₂CHCH₂CH(NH₂)CO₂H
15. Lysine>97%, TCI America #L0129, 146.19
16. Polyvinylpyrrolidone Mw=1,300,000 (PVP-1300K), Sigma-Aldrich #437190
17. Polyvinylpyrrolidone Mw=10,000 (PVP-10K), Sigma-Aldrich #PVP10
18. Polyvinylpyrrolidone, Luvitec 1 (17 (BASF, Germany)
19. Copolymer Vinyl acetate-Vinyl pyrrolidone, Luvitec VA64 (BASF, Germany)
20. Polyethylene glycol (PEG, MW 10,000) (Sigma-Aldrich 309028)
21. Hydrobromic acid 48%, Sigma-Aldrich #268003, 80.91 g/mol
22. Hydrochloric acid 36.5%, EMD Chemicals (Bridgetown, N.J.) #HX0603-75, 36.46 g/mol
23. Sodium iodide≧99.0%, Sigma-Aldrich #S8379, 149.89 g/mol
24. Potassium bromide≧99%, Sigma-Aldrich #22,186-4, 119 g/mol
25. Sodium chloride≧99.5%, Fluka (Milwaukee, Wis.) #71379, 58.44 g/mol
26. Acetonitrile anhydrous 99.8% (Sigma-Aldrich 271004)
27. Copper Iodide 98% (particle size 2 to 3 μm), 99.5% (particle size 1 to 2 μm) and 99.999% (particle size 1-2 μm) (Sigma Aldrich 205540; 3140 and 215554 respectively)
28. AgI nanoparticles, 25 nm (0.7% by weight) in PVP matrix (Chempilots a/s, Denmark
29. Copper metal, Sigma Aldrich Cat. #326453

### 5. Processes of Making the Functionalized Metal Salt Nanoparticles

The following methods were used in synthesizing the functionalized nanoparticles. The procedures below are divided into two sets, Procedure Set 1 and Procedure Set 2. The first set comprises procedures for making nanoparticles of various metal halides and silver metal; and the antimicrobial results from these are discussed in Tables 2 through 9.

The following precursor solutions were made which were used for synthesizing particles for both sets:

Solution A: 4% AgNO₃ solution:

0.945 g Silver nitrate (Sigma-Aldrich #S6506) was dissolved in 14.055 g water (deionized). (This solution theoretically contains 4% by weight metallic silver.)

Solution B: 0.7% NaBH₄-solution:

0.07 g Sodium borohydride (Aldrich #452882) was dissolved in 9.93 g water. This solution was always prepared freshly just before its use.

Solution C: 10% Aspartic acid solution:

0.296 g NaOH pellets (7.4 mmol) was dissolved in 8.6 g water, 0.988 g Aspartic acid (7.4 mmol) (Sigma #A9006) added into it and then stirred until a clear solution was obtained.

### Solution D: 10% Thioglycine-solution (TGN)

0.0245 g NaOH pellets (0.613 mmol) was dissolved in 0.875 g water, 0.1 g N-(2-Mercaptopropionyl)glycine (0.613 mmol) (Thioglycine Sigma #M6635) added into it and then stirred until a clear solution was obtained.

Solution E: 10% Thiomalic acid (TMAN) solution:

0.134 g NaOH pellets (3.35 mmol) was dissolved in 2.12 g water, 0.25 g Mercaptosuccinic acid (3.35 mmol) (Thiomalic acid, Aldrich #88460) added into it and then stirred until a clear solution was obtained.

Solution F: 10% Thioctic acid solution (TOA):

0.0193 g NaOH pellets (0.483 mmol) was dissolved in 0.88 g water, 0.1 g Lipoic acid (0.483 mmol) (Thioctic acid, Sigma #M6635) added into it and then stirred.

Solution G: Copper solution—

Dissolve 0.0213 g CuBr in 0.048 g HBr 48%, diluting with 16 g water and, finally stirring until clear solution

### Solution H: 10% PVP-1300K or 10K-solution:

1 g Polyvinylpyrrolidone, mol. wt.=1,300,000 or 10,000 was dissolved in 9 g water.

### Procedure Set 1 (Examples 1-20) Synthesis of Functionalized Metallic Silver Nanoparticles

### Example 1

### Synthesis and Functionalization of Ag° Particles with Thiomalic Acid at Ag/SH=1/0.25 and Ag/Aspartic=1/5

1 g Solution A (0.371 mmol) was diluted with 2.39 g water. 2.47 g of Solution C (1.855 mmol) and 3-5 mins later 0.139 g Solution E (0.0926 mmol) were dropped under stirring into the diluted solution. After stirring further for 5 mins, 2 g Solution B (0.37 mmol) were dropped slowly into it under stirring. The final concentration of silver based on the calculation of metallic silver is 0.5% w/w.

### Example 2a

### Synthesis and Functionalization of Ag° Particles with Thioglycine at Ag/SH=1/0.25 and Ag/Aspartic=1/5

1 μg Solution A (0.371 mmol) was diluted with 2.368 g water. 2.47 g Solution C (1.855 mmol) and 3-5 mins later 0.151 g Solution D (0.0925 mmol) were dropped under stirring into the diluted solution. After stirring further for 5 mins, 2 g Solution B (0.37 mmol) were dropped slowly into it under stirring. The final concentration of silver based on the calculation of metallic silver is 0.5% w/w.

### Example 2b

### Synthesis and Functionalization of Ag° Particles with Thioglycine at Ag/SH=1/0.25 and Ag/Aspartic=1/2

1 μg Solution A (0.371 mmol) was diluted with 2.368 g water. 0.99 g Solution C and 3-5 mins later 0.151 g Solution D (0.0925 mmol) were dropped under stirring into the diluted solution. After stirring further for 5 mins, 2 g Solution B (0.37 mmol) were dropped slowly into it under stirring. The final concentration of silver based on the calculation of metallic silver is 0.5% w/w.

### Example 3

### Synthesis and Functionalization of Ag° Particles with PVP

0.1366 g silver nitrate was dissolved in 9.825 g water and then 2.168 g Solution H (PVP MW 10,000) in water added into it. Finally, 5.202 g of freshly prepared 0.25% w/w NaBH₄ in water was dropped slowly into the silver nitrate solution and kept stilling overnight to obtain silver particles. The final concentration of silver based on the calculation of metallic silver is 0.5% w/w.

### Example 4

### Synthesis and Functionalization of Ag° Particles with PVP and Thioglycine

0.1366 g silver nitrate was dissolved in 8.25 g water and then 2.168 g of Solution H (PVP MW 10,000) in water added into it. Finally, 5.202 g of freshly prepared 0.25% w/w NaBH₄ in water was dropped slowly into the silver nitrate solution and kept stirring overnight to obtain silver particles. The final concentration of silver based on the calculation of metallic silver is 0.55% w/w. 3.5 g of the silver sol produced in this way was diluted with 2.4 g of water and 0.146 g of Solution D, and the mixture was stirred for 2 hours to obtain silver particles modified both with PVP and thioglycine.

### Example 5

### Synthesis and Functionalization of AgBr Nanoparticles with PVP

0.2079 g silver nitrate was dissolved in 12.785 g water and then 3.30 g Solution H added into it. Finally a solution of 0.146 g potassium bromide in 5.20 g water was slowly dropped under stirring and kept stirring overnight to allow the formation of particles. The final concentration of silver based on the calculation of metallic silver is 0.61% w/w.

### Example 6

### Synthesis and Functionalization of AgBr Nanoparticles with Thiomalic Acid and Aspartic Acid at Ag/SH=1/0.25 and Ag/Aspartic=1/2

1 g Solution A (0.371 mmol) was diluted with 4.176 g water. 0.99 g Solution C (0.744 mmol) and 3-5 mins later 0.139 g Solution E (0.0925 mmol) were dropped under stirring into the diluted solution. After stirring further for 5 mins, the solution of 0.047 g HBr 48% (0.279 mmol) (Aldrich #268003) diluted in 2 g water was dropped slowly into it under stirring. The final concentration of silver based on the calculation of metallic silver is 0.5% w/w.

### Example 7

### Synthesis and Functionalization of AgCl Nanoparticles with Thiomalic and Aspartic Acid at Ag/SH=1/0.25 and Ag/Aspartic=1/2

1 g Solution A (0.371 mmol) was diluted with 3.843 g water. 0.99 g Solution C (0.744 mmol) and 3-5 mins later 0.139 g Solution E (0.0925 mmol) were dropped under stirring into the diluted solution. After stirring further for 5 mins, the solution of 0.028 g HCl 36.5% (0.280 mmol) (EMD Chem. #HX0603-75) diluted in 2 g water was dropped slowly into it under stirring. The final concentration of silver based on the calculation of metallic silver is 0.5% w/w.

### Example 8

### Synthesis and Functionalization of AgI Nanoparticles with Thioglycine at Ag/SH=1/0.25

1 g Solution A (0.371 mmol) was diluted with 4.804 g water. 0.151 g Solution D (0.0925 mmol) was dropped under stirring into the diluted solution. After stirring further for 5 mins, the solution of 0.042 g sodium iodide (Sigma-Aldrich #S8379) diluted in 2 g water was dropped slowly into it under stirring. The final concentration of silver based on the calculation of metallic silver is 0.5% w/w.

### Example 9

### Synthesis and Functionalization of AgBr Nanoparticles with Thioglycine and Aspartic Acid at Ag/SH=1/0.25 and Ag/Aspartic=1/2

1 g Solution A (0.371 mmol) was diluted with 3.826 g water. 0.99 g Solution C (0.744 mmol) and 3-5 mins later 0.151 g Solution D (0.0925 mmol) were dropped under stirring into the diluted solution. After stirring further for 5 mins, the solution of 0.033 g potassium bromide (0.277 mmol) (Aldrich #22, 186-4) dissolved in 2 g water was dropped slowly into it under stirring. The final concentration of silver based on the calculation of metallic silver is 0.5% w/w. The particle size was about 25 nm.

### Example 10

### Synthesis and Functionalization of AgBr Nanoparticles with Thioglycine and Aspartic Acid at Ag/SH=1/0.25 and Ag/Aspartic=1/5

Same procedure as Example 9, except that the amount of Solution C was 2.47 g (1.855 mol). In this case the particle size was in the range of 10 to 15 nm.

### Example 11

### Synthesis and Functionalization of AgI Nanoparticles with 5 Mol-% CuBr and Thioglycine at Ag/SH=1/0.5 and Ag/Aspartic=1/2

1 μg Solution A (0.371 mmol) was diluted with 1.675 g water. 0.99 g Solution C (0.744 mmol) and 3-5 mins later 0.303 g Solution D (0.186 mmol) were dropped under stirring into the diluted solution. After stirring further for 5 mins, 2.010 g Solution G (0.0356 mmol bromide from HBr), was dropped slowly into the solution under stirring. At the final step, 0.0225 g sodium iodide (0.15 mmol) dissolved in 2 g water was added. The final concentration of silver based on the calculation of metallic silver is 0.5% w/w.

### Example 12

### Synthesis of AgBr or AgCl) Nanoparticles with Thioglycerol at Ag/SH=1/0.10 and Ag/PVP=1/2.5 w/w

For preparation of AgBr nanoparticles, 1 g Solution A (0.371 mmol) was diluted with 3.88 g water. 1 g of Solution H (PVP-1300K) and 2-3 mins later 0.080 g 5% w/w aqueous solution of thioglycerol (0.037 mmol) (TCI America #T0905) were dropped under stirring into the diluted solution. In 2-3 mins, the solution of 0.0397 g potassium bromide (0.334 mmol) (Aldrich #22, 186-4) for AgCl) diluted in 2 g water was dropped slowly into it under stirring. The final concentration of silver based on the calculation of metallic silver is 0.5% w/w.

For preparation of AgCl nanoparticles the same procedure was used, but instead of 3.88 g of water 3.90 g of water was used and instead of 0.0397 g of potassium bromide, 0.0195 g of sodium chloride (Fluka #71379) was used.

### Example 13

### Synthesis of AgBr or AgCl Nanoparticles with Thioglycine at Ag/SH=1/0.5 and Ag/PVP=1/2.5 w/w

a. production of silver bromide nanoparticles: 3.30 g Solution A were diluted with 12.056 g water. 3.30 g 10% PVP-10K-solution and the solution of 0.1426 g potassium bromide and 5.2 g water were respectively dropped slowly, and the nanoparticle suspension was stirred overnight.

b. surface modification: 0.204 g water and 0.146 g 10% Thioglycine-solution were dropped into 3.5 g portion of the synthesized silver halide nanoparticles above, and then stirred for, at least, six hours. The final concentration of silver based on the calculation of metallic silver is 0.5% w/w.

For preparation of AgCl nanoparticles the same procedure was used as above but instead of 12.056 g of water 12.128 g of water was used and instead of 0.1426 g of potassium bromide, 0.0715 g of sodium chloride was used.

### Example 14

### Synthesis of AgBr Nanoparticles with 5 Mol-% CuBr and Thioglycine at Ag/SH=1/0.5 and Ag/PVP=1/2.5 w/w

a. production of silver bromide nanoparticles: 3.30 g Solution A (1.224 mmol) were diluted with 10.585 g water. 3.30 g 10% PVP-10K-solution and 6.815 g copper solution (1.224 mmol bromide from HBr), which was made by dissolving 0.0213 g CuBr in 0.50 g HBr 48%, diluting with 16 g water and, finally stirring until a clear nanoparticle suspension was obtained, and the particle suspension was stirred overnight.

b. surface modification: 0.204 g water and 0.146 g Solution D were dropped into 3.5 g portion of the synthesized silver bromide nanoparticle suspension above, and then stirred for at least six hours. The final concentration of silver based on the calculation of metallic silver is 0.5% w/w.

### Example 15

### Synthesis of AgI Nanoparticles with 5 Mol-% CuBr and Thioglycine at Ag/SH=1/0.5 and Ag/PVP=1/2.5 w/w

a. production of silver iodide nanoparticles: 1.65 g Solution A (0.612 mmol) were diluted with 4.452 g water. 1.65 g Solution H (PVP-10K) and 1.674 g copper solution (0.118 mmol bromide from HBr), which was made by dissolving 0.0213 g CuBr in 0.096 g HBr 48%, diluting with 8 g water and, finally stirring until a clear nanoparticle suspension. At the final step, 0.074 g sodium iodide (0.494 mmol) dissolved in 2 g water was added and stirred overnight.

b. surface modification: 0.204 g water and 0.146 g Solution D were dropped into 3.5 g portion of the synthesized silver iodide nanoparticle suspension above, and then stirred for, at least, six hours. The final concentration of silver based on the calculation of metallic silver is 0.5% w/w.

### Example 16

### Synthesis of AgI with 5 Mol-% CuBr and Thioglycine at Ag/SH=1/0.5 and Ag/PVP=1/2.5 w/w; and Excess of Free Silver Ions

a. production of silver iodide nanoparticles: 1.65 g Solution A (0.612 mmol) were diluted with 4.452 g water. 1.65 g Solution H (PVP-10K) and 1.674 g copper solution (0.118 mmol bromide from HBr), which was made by dissolving 0.0213 g CuBr in 0.096 g HBr 48%, diluting with 8 g water and, finally stirring until a clear sol were respectively dropped slowly. At the final step, 0.023 g sodium iodide (0.151 mmol) dissolved in 2.05 g water was added and stirred overnight. The molar ratio of silver nitrate to the sodium iodide ions was such that 56% of the silver was available as free ions.

b. surface modification: 0.204 g water and 0.146 g Solution D were dropped into 3.5 g portion of the synthesized silver iodide sol above, and then stirred for, at least, six hours. The final concentration of silver based on the calculation of metallic silver is 0.5% w/w.

### Example 17

### Synthesis of CuI Nanoparticles with PVP at Cu/PVP=1/3.3 w/w

2.232 g Solution H (PVP-10K) solution was added into the solution of 0.211 g Copper(II) acetate monohydrate (1.057 mmol) dissolved in 6.227 g water under stirring. Afterwards, 0.3168 g sodium iodide (2.114 mmol) dissolved in 5 g water was dropped slowly into the copper solution and stirred overnight. Next day, the CuI suspension was washed to remove the formed iodine by extracting 7-10 times 2.5-3 ml with diethyl ether. The remaining ether was separated from the solution by evaporation under vacuum and then water was added to compensate for the loss of weight during processing. The final concentration of copper based on the calculation of metallic copper is 0.48% w/w. Reaction: Cu²⁺+2I⁻→CuI₂→CuI₍ₛ₎+I₂.

### Example 18

### CuI Particles with Excess Cu⁺⁺

1.86 g Solution H (PVP-10K) was added into the solution of 0.176 g Copper(II) acetate monohydrate dissolved in 6.448 g water under stirring. Afterwards, 0.132 g sodium iodide dissolved in 3 g water was dropped slowly into the copper solution and stirred overnight. The remainder of the process was the same as in Example 18, and the final concentration of copper in the suspension was 0.48% w/w.

### Example 19

### Synthesis of Silver Halide Nanoparticles with 5 Mol-% CuI

0.236 g water and 0.114 g CuI as prepared in Method 17 were respectively dropped into 3.5 g solution of silver halide nanoparticles made by the procedure in Example 13 under stilling. The final concentration of silver based on the calculation of metallic silver is 0.5% w/w

### Example 20

### Synthesis of Silver Halide Nanoparticles with 5 Mol-% CuI and Thioglycine at Ag/SH=0.5

0.09 g water, 0.114 g CuI in Method 17 and, 0.146 g Solution D were respectively dropped into 3.5 g solution of silver halide nanoparticles made by the procedure in Example 13 under stirring. The final concentration of silver based on the calculation of metallic silver is 0.5% w/w.

### Procedure Set 2 (Examples 21-42b)

### Example 21

### Synthesis of Silver Nanoparticles Functionalized with Polyvinylpyrrolidone

To a reaction flask fitted with a stir bar and shielded from ambient light was added 0.1366 g of silver nitrate and 6.7 g of deionized water (DI water). This was stirred to give a clear solution. To this solution was added 2.168 g of a 40% w/w PVP, Aldrich, Mol wt 10 k). Under rapid stirring 5.202 g of a 0.25% w/w solution of sodium borohydride was added drop-wise. This resulted in a very dark gray solution. The weight % silver in the final dispersion was 0.61% with a particle size of 10 to 40 nm as measured by dynamic light scattering after converting the data to volume fraction.

### Example 22

### Synthesis of Silver Bromide Nanoparticles Functionalized with Polyvinylpyrrolidone

To a reaction flask covered to shield for ambient light, fitted with a stir bar and placed on an ice bath at 0° C. was added 0.2 g of silver nitrate and 51 g of DI-water. This was stirred for five minutes to form a complete solution. To this was added 3.34 ml of a 10 wt % solution in water of PVP (Aldrich, Mol. Wt. 10K) and stirred for ten minutes. To a second reaction vessel fitted with a stir bar and placed on an ice bath was added 0.157 g of potassium bromide and 21.4 g of DI-water. This was stirred for ten minutes to form a complete solution. This solution was transferred to a dropping funnel and added drop-wise (drop rate 0.436 ml/min) to the stirred silver nitrate/PVP solution at 0° C. During this process the silver nitrate solution was shielded from ambient light. The mixture was stirred overnight at 0° C. to give a light tan translucent mixture. Weight percent silver in the final mixture was 0.17%. The average particle size was 4 nm (based on volume fraction distribution by dynamic light scattering).

### Example 23

### Synthesis of Copper Iodide Nanoparticles Modified with PVP

To a 100 ml round bottom flask was added 0.380 g of copper iodide powder (Aldrich, 98%) and 60 mls of anhydrous acetonitrile. The flask was stoppered and placed under sonication for 10 minutes to form a clear yellow solution. To this solution was added 1.956 g of PVP (Aldrich, Mol. wt. 10K) and sonicated for 10 minutes to form a light green solution. The solution was placed on a rotary evaporator and the acetonitrile removed under vacuum at 30° C. for approximately 30 minutes, then the temperature was increased to 60° C. for 15 minutes. This resulted in a bright green solid (a polymeric powder with coarse grain size that can be ground to any sized powder, preferably in a size much larger than nanosize). This solid was stable and could be redispersed in water to yield nanoparticles. To the flask containing the CuI/PVP solid was added a stir bar and 100 ml of DI-water to form a white milky opaque mixture. The mixture was shield form ambient light and stirred at 25° C. for three days this resulted in a translucent light pink stable dispersion. The weight % of Cu in the dispersion was 0.13%. The average particle size was 4 nm (based on volume fraction distribution by dynamic light scattering).

### Example 24

### Synthesis of CuI-PEG Dispersion w/pH Modifier

A dispersion of CuI surface modified with polyethylene glycol (PEG), prepared in water using nitric acid as a pH modifier. To a reaction flask fitted with a stir bar was added 4.5 g of PEG (MW=10,000), and 0.0476 g CuI (99.999%) and 50 ml of acetonitrile. The mixture was stirred at room temperature for about 30 minutes to give a light green solution. The reaction flask was placed on a rotary evaporator and the solvent removed at 25° C. to a paste-like consistency. The temperature was then increased to 45° C. to complete removal of acetonitrile. This resulted in a yellow powder. This powder was dispersed in 50 ml of DI water and 0.05 ml (0.07 g) of concentrated nitric acid was added to form an off-white mixture. Upon stirring in the dark over night the dispersion became clear to give a light yellow dispersion.

### Example 25

### Synthesis of AgBr:CuI/PVP Dispersion with a Molar Ratio Ag⁺:Cu⁺1:10

a. A copper iodide dispersion was prepared by direct reaction of the elements copper and iodine as follows: To a reaction flask was added 8.75 g of polyvinylpyrrolidone PVP (10,000 MW, Sigma Aldrich Cat. #PVP10), 50 ml DI water (18 Mohm-cm) and 0.125 g Cu metal (Sigma Aldrich Cat. #326453). The mixture was stirred and cooled to 0° C. on an ice bath.

A second solution was prepared where 0.25 g of iodine (≧99.8% Sigma Aldrich Cat. #20, 777-2) and 8 ml of toluene (99.8% Sigma Aldrich Cat. #244511) were added to a reaction vessel. The mixture was stirred and cooled to 0° C. on an ice bath.

The iodine/toluene mixture was added slowly, 1 ml/minute, to the copper dispersion at 0° C. This was stirred for 30 minutes at 0° C. and then allowed to warm to room temperature under stirring. The solution was transferred to a separator funnel to give a clear toluene phase and dark orange aqueous phase of CuI dispersion. The aqueous phase (CuI) was separated from the toluene phase and stored shielded from light.

b. A 1:10 molar ratio of Ag⁺:Cu⁺ was prepared by mixing 1.5 g of AgBr dispersion prepared in Example #27 and 14.8905 g of CuI aqueous dispersion as described above. This resulted in a transparent dispersion yellow/brown dispersion.

### Example 26

### Preparation of Ag/PVP Dispersion

To a round bottom flask fitted with a condenser was added 50 ml of DI water (18 Mohm-cm) and 20 g of PVP (10,000 MW, Sigma Aldrich Cat. #PVP10). The mixture was stirred at room temperature to form a clear yellow solution. To this solution was added 0.04926 g of silver nitrate 99.0% ACS reagent Sigma Aldrich Cat. #209139) and the solution heated to 70° C. for 7 hours while stirring. During this time the reaction was followed by PVP absorption with the formation of the Plasmon peak at 425 nm due to the reduction of silver nitrate to silver metal by PVP. The final dispersion of Ag nano-particles was orange/brown in color and was transparent. Dynamic light scattering on a dilute sample of the dispersion gave a mean particle size of 7 nm.

### Example 27

### Synthesis of AgBr/PVP Dispersion

A silver bromide dispersion was prepared by dissolving 20 g of PVP (10,000 MW, Sigma Aldrich Cat. #PVP10) in 40 ml of DI water (18 Mohm-cm). To this solution while stirring was added 0.0492 g of silver nitrate, (≧99.0% ACS reagent Sigma Aldrich Cat. #209139), resulting in a clear yellow solution. In a separate reaction vessel a reducing solution was prepared by dissolving 0.0357 g of potassium bromide (anhydrous powder 99.95% Sigma Aldrich Cat. #451010), in 10 ml DI water (18 Mohm-cm). This KBr solution was added drop wise to the AgNO₃/PVP solution to form a yellow/orange transparent dispersion of AgBr. Dynamic light scattering on a dilute sample of the dispersion gave a mean particle size of 4 nm.

### Example 28

### Synthesis of CuI/PVP Dispersion

To a reaction flask containing 50 ml of anhydrous acetonitrile, (99.8% Sigma Aldrich Cat. #271004), was added 10 g of PVP (10,000 MW, Sigma Aldrich Cat. #PVP10) and stirred to form a light yellow solution. To this solution was added 0.0476 g of CuI (98.0% Sigma Aldrich Cat. #205540) and after stirring for 30 minutes this resulted in a clear pale green solution. Then the bulk of the acetonitrile was removed under reduced pressure at 30° C. to form a viscous paste. The temperature was then increased to 60° C. to completely remove the solvent to give a pale green solid. To this solid was added 50 ml of DI water (18 Mohm-cm) and stirred to give a transparent bright yellow dispersion. Dynamic light scattering on a dilute sample of the dispersion gave a mean particle size of 4 nm.

### Example 29

### Synthesis of Ag+AgBr Dispersion Molar Ratio Ag⁰:Ag⁺=1:5

A 1:5 molar ratio of Ag⁰:Ag⁺ was prepared by mixing 2.0 g of Ag/PVP dispersion prepared in Example 26 and 10.022 g of AgBr/PVP dispersion as prepared in Example 27. This resulted in a transparent dispersion yellow/brown dispersion. Dynamic light scattering on dilute samples of the dispersions before mixing gave a mean particle size for Ag of 7 nm and AgBr of 4 nm.

### Example 30

### Synthesis of Ag:CuI dispersion Molar ratio Ag⁰:Cu⁺ 1:10

A 1:10 molar ratio of Ag^{o}:Cu⁺ was prepared by mixing 1.5 g of Ag/PVP dispersion prepared in Example #26 and 14.8905 g of CuI/PVP dispersion as prepared in Example #28. This resulted in a transparent yellow/brown dispersion. Dynamic light scattering on dilute samples of the dispersions before mixing gave a mean particle size for Ag of 7 nm and CuI of 4 nm.

### Example 31

### Synthesis of AgBr:CuI Dispersion Molar Ratio Ag⁺:Cu⁺ 1:10

A 1:10 molar ratio of Ag⁺:Cu⁺ was prepared by mixing 1.5 g of AgBr/PVP dispersion prepared in Example #27 and 14.8905 g of CuI/PVP dispersion as prepared in Example #28. This resulted in a transparent yellow/brown dispersion.

### Example 32

### Synthesis of PVP-BASF-CuCl Dispersion

To a reaction flask containing 50 ml of anhydrous acetonitrile (99.8% Sigma Aldrich Cat. #271004) was added 14 g of PVP (BASF K17) and stirred to form a clear solution. To this solution was added 0.0239 g of CuCl (ACS reagent>99.0% Sigma Aldrich Cat. #307483) and after stirring for 30 minutes this resulted in a green/yellow solution. Then the bulk of the acetonitrile was removed under reduced pressure at 30° C. to form a viscous paste. The temperature was then increased to 60° C. to completely remove the solvent to give a pale green solid. To this solid was added 50 ml of DI water (18 Mohm-cm) and stirred to give a transparent bright yellow dispersion.

### Example 33

### Synthesis of CuI/PVP-BASF+Acetic Acid+HNO₃

To a reaction vessel were added 4.05 g of PVP (BASF K17) and 50 ml of anhydrous acetonitrile (99.8% Sigma Aldrich Cat. #271004). This was capped and left to stir at room temperature to form a clear colorless solution. To this solution was added 0.0476 g of CuI (99.999% Sigma Aldrich Cat. #215554) and stirred at 25° C. for 30 minutes to form a transparent light yellow solution. The bulk of the acetonitrile was removed under reduced pressure at 30° C. to form a viscous paste. The temperature was then increased to 60° C. to completely remove the solvent to give a yellow uniform solid. To this solid was added 50 ml of DI water (18 Mohm-cm) and stirred to give a cloudy white dispersion. This was left to stir for 3 days in the dark the dispersion remained cloudy with a light white precipitate. While stirring 0.3 ml of glacial acetic acid (ACS reagent 99.7% Sigma Aldrich Cat. #320099) was added immediately and the dispersion turned a orange/yellow color but was cloudy with a slight precipitate. To this mixture was added 0.05 ml of concentrated nitric acid (ACS reagent 90% Sigma Aldrich Cat. #258121) and the solution cleared up to give a transparent light yellow solution.

### Example 34

### Synthesis of CuI/VP-VA Copolymer-BASF+HNO₃ Dispersion

To a reaction flask containing 50 ml of anhydrous acetonitrile (99.8% Sigma Aldrich Cat. #271004) was added 6.75 g of the copolymer PV-VA (BASF Luvitec VA 64) and stirred to form a clear solution. To this solution was added 0.0476 g of CuI (99.999% Sigma Aldrich Cat. #215554) and after stirring for 30 minutes this resulted in a green/yellow solution. The bulk of the acetonitrile was removed under reduced pressure at 30° C. to form a viscous paste. The temperature was then increased to 60° C. to completely remove the solvent to give a yellow uniform solid. To this solid was added 50 ml of DI water (18 Mohm-em) and stirred to give a cloudy light yellow slurry. Under stirring 0.05 g of concentrated nitric acid (ACS reagent 90% Sigma Aldrich Cat. #258121) was added to the mixture and it turned a light yellow color and was transparent.

### Example 35

### Synthesis of CuI/VP-VA Copolymer-BASF+HNO₃+Sodium Sulfite Dispersion

To a reaction flask containing 50 ml of anhydrous acetonitrile (99.8% Sigma Aldrich Cat. #271004) was added 13.5 g of the copolymer PV-VA (BASF Luvitec VA 64) and stirred to form a clear solution. To this solution was added 0.0952 g of CuI (99.999% Sigma Aldrich Cat. #215554) after stirring for 30 minutes this resulted in a green/yellow solution. Then the bulk of the acetonitrile was removed under reduced pressure at 30° C. to form a viscous paste. The temperature was then increased to 60° C. to completely remove the solvent to give a yellow uniform solid. To this solid was added 100 ml of DI water (18 Mohm-cm) and stirred to give a cloudy light yellow slurry. While stirring 0.05 g of concentrated nitric acid (ACS reagent≧90% Sigma Aldrich Cat. #258121) was added to the mixture and it turned a light yellow color and was transparent. To this CuI nano-dispersion was added 0.0135 g sodium sulfite (>98% Sigma Aldrich Cat. #S50505) which was equivalent to a concentration of 0.1 wt % based on total weight of copolymer. This addition had no effect on the appearance of the dispersion.

### Example 36a

### Synthesis of CuI/PVP-BASF+HNO₃

To a round bottom flask fitted with a stir bar were added 4.275 g of PVP (BASF K17) and 50 ml of anhydrous acetonitrile (99.8% Sigma Aldrich Cat. #271004). This was capped and left to stir at room temperature to form a clear colorless solution. To this solution was added 0.225 g of CuI (99.999% Sigma Aldrich Cat. #215554) and stirred at 25° C. for 30 minutes to form a transparent light yellow solution. The bulk of the acetonitrile was removed under reduced pressure at 30° C. to form a viscous paste. The temperature was then increased to 60° C. to completely remove the solvent to give a yellow uniform solid. To this solid was added 50 ml of DI water (18 Mohm-cm) and stirred to give a cloudy light yellow dispersion. While stirring 0.07 g of concentrated nitric acid (ACS reagent 90% Sigma. Aldrich Cat. #258121) was added to the mixture and it turned colorless and lightly cloudy with no precipitate. Dynamic light scattering on a diluted sample of the dispersion showed a bimodal distribution for volume fraction analysis with particles with peaks at diameter of 263 and 471 nm.

In another preparation following the above route, the proportion of components was changed. The amount of PVP (BASF K17) was 2.25 g in 50 ml acetonitrile. To this was added 0.0476 g of CuI (99.999%). This was processed as before and the dry powder was redispersed in 60 ml DI water. The solution was milky/pale yellow. After stirring 0.05 ml of nitric acid was added and stirred for two days. The solution became clear yellow with no precipitate. The solution remains stable after this process. The particle size was 4 nm.

### Example 36b

### Syntheses of CuI/PVP Particles—Control of Particle Size Using Acid

Copper iodide functionalized with PVP was prepared at different particle sizes by controlling the amount of nitric acid in the aqueous dispersion. The dispersions were prepared as described in Example 36a with the exception that the acid was added in the form of an aqueous solution in which the CuI/PVP powder was dispersed. The acid concentration was varied between 0 to 8.46 mM and gave a corresponding particle size variation of between 1070 to 5 nm as measured by dynamic light scattering. pH was read using a Fisher Scientific pH meter calibrated between 4 and 7 pH. The data is summarized in Table 1d which shows the effect of nitric acid in controlling the particle size. Samples were also made with acid but without copper iodide (samples S45, S47 and S49 with 0.846, 4.227 and 8.46 mM nitric acid respectively but without any copper iodide), these samples were tested to ensure that acidity of the sample was not responsible for the antimicrobial effect. Another aspect of note is that different sources of PVP may have different acidity depending on the method used to produce them, and may require a different extent of pH adjustment to control the particle size. As an example in this case when no nitric acid was used, the particle size was 1070 nm, whereas in Example 28 where a different PVP (PVP from Aldrich) was used (without added acid), the particle size was 4 to 6 nm.

TABLE 1d

| | | pH of | | Particle Size |
|---|---|---|---|---|
| Sample # | % Cu | dispersion | [HNO₃] | (nm) |
| S44 | 0.0749 | 6.17 | 0.00 mM | 1070 |
| S46 | 0.0749 | 2.59 | 0.846 mM | 323 |
| S48 | 0.0749 | 2.36 | 4.227 mM | 315 |
| S50 | 0.0749 | 1.37 | 8.460 mM | 5 |

To a 50 ml round bottom flask was added 0.81 g of PVP (Luvitec K17 from BASF) and 15 ml acetonitrile. This was stirred to form a solution free of color. To the PVP solution was added 0.0095 g CuI (Aldrich, 99.5% purity). This was stirred to form a transparent yellow solution. The PVP/CuI solution was dried on a rotary evaporator at 45° C. This formed a yellow solid. This solid was redispersed in 7.5 ml of deionized water. This was stirred to form a cloudy white solution. The redispersed PVP/CuI solution was added to different acids in a volume of 7.5 ml in different concentrations (strengths) as shown in the table below. This solution was stirred while keeping it away from light. After 1 day of stirring the solution in most cases it became transparent as shown in Table 1e (“Solution Clarity” column). The pH of these solutions was also measured. The pH is dependent on several factors, type and amount of PVP, amount of CuI, type and concentration of acid in the solution. The average particle size in clear solutions is expected to be below 10 nm, and significantly higher for others. The solution was diluted to 59.07 ppm of total copper content in phosphate buffered saline (PBS; pH 7.4; Sigma-Aldrich, St. Louis, Mo.) and pH measurements were again taken. This was the typical concentration of copper that was used in generating several of the antimicrobial testing results in liquid suspensions. This test was done to assure that antimicrobial properties of these nanoparticles are measured in suspensions which are in a consistent pH range of about 6 and 7.4 (or up to the pH of the buffer). As a reference, the pH of human skin is about 5.5, urine is about 6.0 and of blood 7.34 to 7.45. The results after adding different strengths of hydrochloric acid, nitric acid, and sulfuric acid are summarized in Table 1e. This table shows that different acids can be used in different concentrations to control both the pH and the particle size, but all of these in the buffer solution can result in pH greater than 6.

TABLE 1E

| | | | | Neat pH | | pH in |
|---|---|---|---|---|---|---|
| | | | | of | | buffer, |
| | wt % | Wt % | | aqueous | Solution | 59.07 ppm |
| Experiment | Cu+ | PVP | [Acid] | dispersion | clarity | Cu⁺ |
| 1 | 0.00317 | 8.1 | 0 | 6.110 | Cloudy | 7.303 |
| 2 | 0.00317 | 8.1 | HCl | 3.153 | Cloudy | 7.020 |
| | | | 2 mM | | | |
| 3 | 0.00317 | 8.1 | HCl | 2.636 | Clear | 7.020 |
| | | | 4 mM | | | |
| 4 | 0.00317 | 8.1 | HCl | 2.285 | Clear | 6.810 |
| | | | 6 mM | | | |
| 5 | 0.00317 | 8.1 | HNO₃ | 2.621 | Clear | 7.019 |
| | | | 2 mM | | | |
| 6 | 0.00317 | 8.1 | HNO₃ | 2.130 | Clear | 6.690 |
| | | | 4 mM | | | |
| 7 | 0.00317 | 8.1 | HNO₃ | 1.885 | Clear | 6.297 |
| | | | 6 mM | | | |
| 8 | 0.00317 | 8.1 | H₂SO₄ | 2.458 | Clear | 6.877 |
| | | | 2 mM | | | |
| 9 | 0.00317 | 8.1 | H₂SO₄ | 2.074 | Clear | 6.448 |
| | | | 4 mM | | | |

### Example 37

### Synthesis of Ag_{0.5}Cu_{0.5}I and AgₓCu₁₋ₓBr Nanoparticles

This method results in “solid solutions,” meaning not separate distinct liquid phases of CuI and AgI but where one metal is substituted for the other randomly throughout the crystal or a non-crystalline lattice structure of the solid. 10 g of PVP (10,000 MW, Sigma Aldrich Cat. #PVP10) was dissolved in 40 ml of DI water (18 Mohm-cm) and to this was added 0.0246 g (0.145 mmol) of silver nitrate (≧99.0% ACS reagent Sigma Aldrich Cat. #209139). To this pale yellow solution was added 0.0350 g (0.145 mmol) of copper nitrate trihydrate, *≧98% Sigma Aldrich Cat. #61197), to give a dark yellow solution. In a separate vessel 0.0481 g (0.29 mmol) of potassium iodide, (≧99.0% ACS reagent Sigma Aldrich Cat. #60400), was dissolved in 10 ml DI water (18 Mohm-cm) and added drop wise (0.34 ml/minute) to the silver, copper nitrate PVP solution. This resulted in a pale yellow dispersion of a solid solution of silver-copper iodide (Ag_{0.5}Cu_{0.5}I). Dynamic light scattering on a dilute sample of the dispersion gave a mean particle size of 29 nm.

Silver-copper-bromide nanoparticles were synthesized following the same procedure as for silver-copper-iodide using KBr instead of KI. Silver-copper-iodide-bromide nanoparticles were prepared in the same fashion using a combination of KI and KBr in a (1-y):(y) mole ratio.

### Example 38

### Synthesis of Ag_{0.25}Cu_{0.75}I Nanoparticles

Nano-particle dispersion of silver copper iodide solid was prepared according to example #37 except that the molar concentrations of the metal ions were adjusted according to the formula Ag_{0.25}Cu_{0.75}1. Dynamic light scattering of a dilute sample of the dispersion gave a mean particle size of 10 nm.

### Example 39

### Synthesis of Ag_{0.75}Cu_{0.25}1 Nanoparticles and Antimicrobial Activity of AgₓCu₁₋ₓI

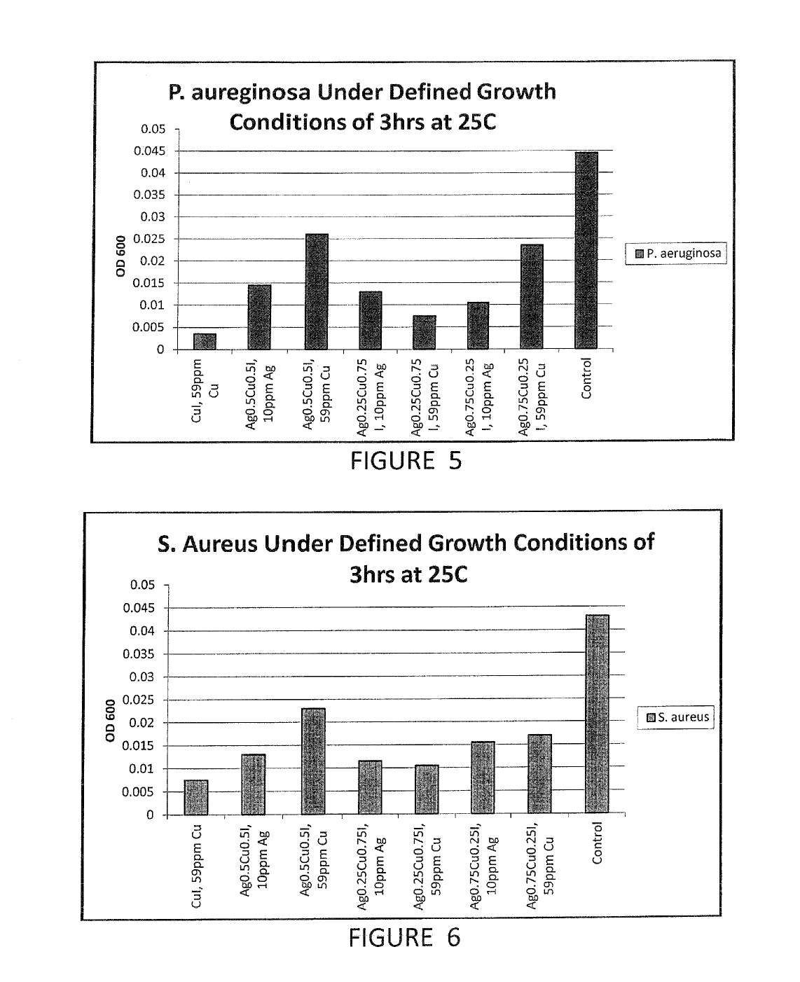

Nano-particle dispersion of silver copper iodide solid was prepared according to example #37 except that the molar concentrations of the metal ions were adjusted according to the formula Ag_{0.75}Cu_{0.25}I. Dynamic light scattering of a dilute sample of the dispersion gave a mean particle size of 8 nm. Antimicrobial activity was determined for Ag₁₋ₓCuₓI (x=0.25, 0.50, 0.75) by measuring optical density at 600 nm after 3 hours at 25° C. for P. aureginosa and S. aureus. Results are shown in FIGS. 5 and 6.

### Example 40

### Infusion of Metal and Inorganic Metal Compounds into Porous Particles

This example teaches the synthesis and antimicrobial testing of a composition having antimicrobial activity comprising a copper halide particle selected from the group consisting of copper iodide, copper bromide and copper chloride, and a porous carrier particle in which the copper halide particle is infused, the carrier particle stabilizing the copper halide particle such that an antimicrobially effective amount of ions are released into the environment of the microbe.

The copper halide-porous particle composition is demonstrated by two process embodiments which were used to infuse copper halide into porous silica carrier particles. These methods may also be used to incorporate other metal compounds (including other metal halides) and metals by reactive precipitation and/or by the evaporation of the solvent. To increase the amount of the infused material in the carrier particle, concentrated solutions (including saturated or close to saturated solutions) of metal halides can be used. Once the solutions are infused in the pores, the porous particles are removed and dried so that the metal compound deposits on the surface of the particles (including surfaces of the pores). To increase the concentration of the metal halides further, one can repeat the process several times using saturated or close to saturated solutions so that the already deposited material is not solubilized. Various types of porous silica particles were used from Silicycle Inc. (Quebec City, Canada). These were IMPAQ® angular silica gel B10007B hydrophilic silica. They had average particle size of 10 μm and a pore size of 6 nm, with pore volume of about 0.8 ml/g and a surface area of >450 m²/g); or silica with particle size of 0 to 20 μm range (pore size 6 nm, surface area 500 m²/g); or silica 0.5 to 3 μm in range (product number R10003B, pore size 6 nm).

Method 1

0.6 g of CuI (from Sigma Aldrich, 98.5% purity) was dissolved in 20 ml acetonitrile at room temperature (use of about 0.68 g of CuI would have saturated the solution). 1 g of silica powder (0-20 μm) was added to this solution. The solution was stirred for three hours at room temperature (this time period could have varied from a few seconds to more than three hours), then filtered through 0.45 μm nylon filter (from Micron Separations Inc., Westboro, Mass.) and finally dried at 70° C. Using a spatula, the material is easily broken down into a fine powder. The analysis of this silica using inductively coupled plasma (ICP) atomic absorption spectroscopy at a commercial laboratory showed that the copper by weight was 1.88% of silica.

### Example 41

### Infusion of Metal and Inorganic Metal Compounds into Porous Particles

Method 2

In this method the solvent for CuI was 3.5 M KI solution in water. KI solution was prepared by dissolving 29 g of KI in 40 ml of deionized water, stirring and adding water to complete a final volume of 50 ml. The volume of the KI solution after mixing was measured to be 50 ml. 1.52 g of CuI was added and stirred at room temperature. The solution turned yellow immediately and by the next day it darkened somewhat. To 6 ml of this solution, 0.5 g of porous silica carrier particles (0.5 to 3 μm) were added and stirred for six hours. The silica particles were filtered and were then added to water so as to precipitate CuI trapped on the surface of the silica. The analysis of this silica using ICP AA instrument showed that the copper by weight was 1.46% of silica.

### Example 42a

### Preparation of Polyurethane/CuI Dispersions by Wet Grinding

The samples were ground in a wet grinding mill produced by Netzsch Premier Technologies LLC (Exton Pa.), equipment model was Minicer®. The grinding beads were made of YTZ ceramic (300 μm in diameter). The interior of the mill was also ceramic lined. 99.9% purity CuI was used to be ground to finer particle size using aqueous media. Two different types of aqueous media were used. In the first case the material was an aliphatic urethane 71/N aqueous dispersions (35% solids) sold under the Tradename of ESACOTE® obtained from Lambeth SpA, (Gallarate, Italy). This material is used for aqueous furniture varnishes and also for metal coatings. The second material was a PVP (Aldrich molecular weight 10,000) solution in water.

For the polyurethane dispersion, 10 g of copper iodide was added for every 100 ml of dispersion. As the grinding proceeded, the viscosity increased and the dispersion was diluted with a mixture of 7% n-ethyl pyrrolidone and 93% water by weight. 60 ml of diluents was added throughout the process. The samples started out with 50 grams CuI and 500 grams of the PU dispersion. It should be noted that the surface of the ground particles was being functionalized by the PU dispersion (which comprised of hydrophobic polyurethane and a surfactant amongst other additives). A total of 60 grams of 7% 1-ethyl-2-pyrrolidone was added periodically throughout the milling process as follows: 25 grams at 75 minutes, 10 grams at 105 minutes, 15 grams at 120 minutes, and 10 grams at 150 minutes. Approximately 100 mL of product was taken out of the mill at 75 and 105 minutes (before the addition of the solvent), and the remainder was pumped out at the 210 minute mark. At the end the process, the total solids content including CuI was 35%, the polymeric content was 27.2% and the % of CuI to that of the polymer was 28.6%. During grinding the maximum temperature was 38° C. After 210 minutes of grinding, the particle size was measured. The circulation speed and agitation speed settings on the equipment were both at six. Particle size measurement was conducted by HORIBA Laser Scattering Particle Size Distribution Analyzer (model LA-950A). The average particle size was 68 nm with a standard deviation of 7.4 nm. To test the stability of the suspension with ground particles, the particle size was measured again the next day which gave the mean size as 70 nm with a standard deviation of 8.2 nm.

### Example 42b

### Preparation of PVP/CuI Dispersions by Wet Grinding

For the PVP dispersion, the formulation was 480 grams: 20 grams CuI, 60 grams PVP (Aldrich 10,000 MW), 400 grams de-ionized water. Grinding parameters were the same as in 42a. Samples were pulled out after 45, 120 and 210 minutes of grinding under the same conditions as above (Example 42a), the particle size (mean size) was respectively 920 nm (bimodal distribution with peaks at 170 and 1,500 nm), 220 nm and 120 nm respectively, when measured using the HORIBA apparatus as described above.

### 6. Testing of Particle Suspensions for Efficacy Against Bacteria, Viruses and Fungi

a. Microbial Assays

The antimicrobial efficacy of the functionalized particles was evaluated using the following standard methods.

### Maintenance and Preparation of Bacterial Isolates:

Test bacteria were obtained from the American Type Culture Collection (ATCC, Manassas, Va.) or The University of Arizona, Tucson, Ariz.: Escherichia coli (ATCC #15597), Enterococcus faecalis (ATCC #19433), Pseudomonas aeruginosa (ATCC #27313), Staphylococcus aureus (ATCC #25923), Mycobacterium fortuitum (ATCC #6841), Salmonella enterica serovar Typhimurium (ATCC 23564), and Streptococcus mutans (ATCC #25175). Escherichia coli 77-30013-2 a copper resistant strain was obtained from Dr. Chris Rensing and Bacillus Cereus was obtained from Dr. Helen Jost at the University of Arizona, Tucson, Ariz.

Bacterial isolates used in these studies were routinely cultured on Tryptic Soy Agar (TSA; Difco, Sparks, Md.) at 37° C. or in Tryptic Soy Broth (TSB) medium at 37° C. on an orbital shaker at 200 r.p.m. In the case of M. fortuitum, Tween 80 (polyethylene glycol sorbitan monooleate; Sigma Aldrich, St. Louis, Mo.) was added to the broth to a final concentration of 0.1% (v/v) to inhibit the formation of bacterial aggregates.

### Maintenance and Preparation of Viruses:

Test viruses were obtained from the ATCC or Baylor College of Medicine Houston, Tex.: MS2 coliphage (ATCC #15597-B1) and Poliovirus 1 (strain LSc-2ab) Baylor College of Medicine Houston, Tex.

MS2 was maintained as described: Test tubes containing approximately 5 mls of soft TSA containing 0.8% Bacto agar (Difco, Sparks, Md.) at 45° C. were inoculated with overnight cultures of E. coli and approximately 1×10⁵ plaque forming units (PFU) of MS2. The soft agar overlay suspensions were gently vortexed and poured evenly across the top of TSA plates and allowed to solidify. Following incubation of 24 hours at 37° C., 6 ml of sterile phosphate buffered saline (PBS; pH 7.4; Sigma-Aldrich, St. Louis, Mo.) was added to the agar overlays and allowed to sit undisturbed for 2 hours at 25° C. Following the incubation the PBS suspension was collected and centrifuged (9,820×g for 10 min) to pellet the bacterial debris. The remaining supernatant containing MS2 was filtered through a 0.22 μm (Millex; Millipore, Bedford Mass.) membrane pre-wetted with 1.5% beef extract and stored in sterile tubes at 4° C. until use. To determine the MS2 titer, the double-agar overlay method as described above was used, however after the 24 hour incubation at 37° C., MS2 was enumerated by plaque formation to determine the number of PFU/ml.

Poliovirus 1 (strain LSc-2ab) was maintained as described: Poliovirus 1 were maintained in cell culture flasks containing BGM (Buffalo green monkey kidney; obtained from Dan Dahling at the United States Environmental Protection Agency, Cincinnati, Ohio) cell monolayers with minimal essential medium (MEM, modified with Earle's salts; Irvine Scientific, Santa Ana, Calif.) containing (per 100 ml total volume) 5 ml of calf serum (CS; HyClone Laboratories, Logan, Utah), 3 ml of 1 M HEPES buffer (Mediatech Inc., Manassas, Va.), 1.375 ml of 7.5% sodium bicarbonate (Fisher Scientific, Fair Lawn, N.J.), 1 ml of 10 mg/ml kanamycin (HyClone Laboratories, Logan, Utah), 1 ml of 100× antibiotic-antimycotic (HyClone Laboratories, Logan, Utah), and 1 ml of 200 mM glutamine (Glutamax; HyClone Laboratories, Logan, Utah) at 37° C. with 5% CO₂.

Viruses were propagated by inoculating BGM cell monolayers. Following the observation of ≧90% destruction of the cell monolayer, the cell culture flasks were frozen at −20° C. and thawed three successive times to release the viruses from the host cells. The culture suspension was then centrifuged (1000×g for 10 min) to remove cell debris, and then precipitated with polyethylene glycol (PEG; 9% w/v) and sodium chloride (5.8% w/v) overnight at 4° C. (Black et al. “Determination of Ct values for chlorine resistant enteroviruses,” J. Environ. Sci. Health A Tox. Hazard Subst. Environ. Eng. 44: 336-339, 2009). Following the overnight incubation the viral suspension was centrifuged (9,820×g for 30 min at 4° C.) and the viral pellet re-suspended in 10 ml PBS. A Vertrel XF extraction was performed at a 1:1 ratio to promote monodispersion of the virus and the removal of lipids (centrifugation at 7,500×g for 15 min at 4° C.) (Black et al., 2009). The top aqueous layer containing the virus was carefully removed using a pipette and aliquoted in 1 ml volumes in sterile cryogenic vials (VWR, Radnor, Pa.). A viral titration for poliovirus 1 was performed using a 10-fold serial dilution plaque-forming assay described by Bidawid et al., “A feline kidney cell line-based plaque assay for feline calicivirus, a surrogate for Norwalk virus.” J. Virol. Methods 107: 163-167. (2003). BGM cell monolayers in 6-well tissue culture plates (Corning Inc., Corning, N.Y.) were rinsed twice with 0.025 M TRIS buffered saline [0.32 L TBS-1 (31.6 g/L Trizma base, 81.8 g/L NaCl, 3.73 g/L KCl, 0.57 g/L Na₂HPO₄-anhydrous) in 3.68 L ultrapure H₂O] and then inoculated with 0.1 ml volumes of 10-fold serial dilutions of the virus stock and incubated at 37° C. for 30 minutes. Following this incubation period, 3 ml of a soft solution of MEM containing (per 100 ml) 0.75% Bacto-agar (Becton, Dickenson and Co., Sparks, Md.), 2% FBS (HyClone Laboratories, Logan, Utah), 3 ml of 1 M HEPES buffer (Mediatech Inc., Manassas, Va.), 1 ml of 7.5% sodium bicarbonate (Fisher Scientific, Fair Lawn, N.J.), 1 ml of 10 mg/ml kanamycin (HyClone Laboratories, Logan, Utah), 1 ml of 100× antibiotic-antimycotic (HyClone Laboratories, Logan, Utah), and 1 ml of 200 mM glutamine (Glutamax; HyClone Laboratories, Logan, Utah) was added as an overlay to each well and allowed to solidify. The plates were then incubated at 37° C. with 5% CO₂ for two days. Following incubation, the agar overlays were removed and the cell monolayers were stained with 0.5% (w/v) crystal violet (Sigma-Aldrich, St. Louis, Mo.) dissolved in ultrapure water and mixed 1:1 with 95% ethanol. Plaques were counted to enumerate infectious viruses.

### Maintenance and Preparation of Molds:

Test molds were obtained from the American Type Culture Collection (ATCC, Manassas, Va.) or The University of Arizona, Tucson, Ariz.: Trichophyton mentagrophytes (ATCC #9533). Penicillium and Aspergillus niger isolates were obtained from Dr. Charles Gerba.

Trichophyton mentagrophytes, Penicillium and Aspergillus niger isolates were maintained on Sabouraud's agar (Neogen Corporation, Lansing, Mich.) slants at 25° C. For preparation of Penicillium and Aspergillus niger spore suspensions, mature slant cultures containing fruiting bodies were washed repeatedly with 10 mL of sterile PBS to release spores. The spore suspension was then transferred to a 15 mL conical tube and vortexed to disperse the spores. For preparation of Trichophyton mentagrophytes spore suspensions, methods were adapted from the ASTM 2111-05 standard (ASTM Standard 2111, 2005, “Standard Quantitative Carrier Test Method to Evaluate the Bactericidal, Fungicidal, Mycobactericidal, and Sporicidal Potencies of Liquid Chemical Microbicides.” ASTM International, West Conshohocken, Pa., 2005.). A small section of mycelial mat from mature slant cultures was transferred to 3-4 plates of Sabouraud's agar. These were incubated for 10-15 days at 25° C. Mature mycelial mats were removed from the agar surface and placed into a 250 ml Erlenmeyer flask containing 50 ml sterile saline (0.85% NaCl) and glass beads. The flask was shaken vigorously to release conidia spores from the fungal hyphae and the suspension was filtered through sterile cotton to remove hyphae fragments.

1) Bacterial Kill Assay.

Overnight suspensions were harvested by centrifugation (9,820×g, 15 min, 20° C., JA-14 rotor, Beckman J2-21 centrifuge; Beckman Coulter, Inc., Fullerton, Calif.) and resuspended in 100 ml of sterile PBS. The above centrifugation process was carried out two additional times and the final harvest was resuspended in 10 mls of PBS. Bacterial suspensions were then adjusted in PBS to an optical turbidity (measured using a BIOLOG turbidimeter, Hayward, Calif.) equivalent to a McFarland number 0.5 standard. Sterile 50 ml polypropylene conical tubes (Becton Dickinson and Company, Franklin Lakes, N.J.) containing PBS were inoculated with test suspensions to a final concentration of approximately 1.0×10⁶ CFU/ml. Functionalized particles of the present invention were evaluated at either 10 ppm silver or 59 ppm copper. Test samples were then placed on an orbital shaker (300 rpm) at 25° C. for the duration of the experiment. At predetermined time intervals (e.g., 1, 3, 5, 24 hours), 100 μl samples were collected and neutralized with Dey Engley neutralizing broth (D/E; Difco, Sparks, Md.) at a ratio of 1:10. Bacterial samples were serially diluted in sterile PBS and enumerated using the spread plate method (Eaton et al., “Spread Plate Method,” in Standard Methods for the Examination of Water & Wastewater, 21^{st} ed., American Public Health Association, Washington, D.C., pp. 9-38-9-40. 9215C. 2005) at 37° C. for either 24 hours (E. coli, P. aeruginosa, S. aureus, and E. faecalis) or 48 and 72 hours (M. fortuitum and S. mutans).

### Evaluation of Antimicrobial Properties of Porous Silica Particles:

Experiments for porous silica particles without Cud and those comprising CuI were conducted in 100 ml of sterile PBS in 250 ml Erlenmeyer flasks. Bacterial suspensions were added to a final concentration of 1.0×10⁶ CFU/ml. Powdered silica samples were tested at 0.1 g dry weight per 100 ml of PBS. A control with bacteria but no added particles was also included. Powdered silica samples were added to each flask and kept in suspension by agitation using stir plates (VWR VMS-C7, VWR, Radnor, Pa.) for the duration of the experiment at 25° C. At predetermined time intervals (e.g. 15 minutes, 1, 6, 24 hours), 1 ml samples were collected and neutralized with Dey Engley neutralizing broth (D/E; Difco, Sparks, Md.) at a ratio of 1:2.

Samples were then diluted and enumerated as described before.

2) Evaluation of Antimicrobial Properties of Polymer Coated Surfaces Containing Functionalized Particles.

Experiments for polymer coated stainless steel surfaces with and without CuI were conducted based on the JIS Z 2801:2000 method (JIS Z 2801:2000, “Antimicrobial products—Tests for antimicrobial activity and efficacy.”, Japanese Standards Association, Tokyo, Japan, 2000.) with minor modifications. Bacterial suspensions with a final concentration of 1.0×10⁷ CFU/ml were prepared and 400 μl was inoculated onto 50×50 mm square coupons of the desired surface (surfaces were disinfected with 70% ethanol twice and air dried prior to experiment). The inoculum was held in contact with the surface using sterile 40×40 mm polyethylene film cover slips. A control surface coated with polymer but containing no CuI was also inoculated. All inoculated surfaces were incubated in sealed environment at 25° C. and >95% relative humidity. At predetermined time intervals (e.g. 3, 6, 24 hours), the cover slip was aseptically removed and set aside. Bacteria were recovered by swabbing the surface and the cover slip with a cotton swab pre-moistened in sterile PBS. The swab was then neutralized in 1 ml of Dey Engley neutralizing broth (DIE; Difco, Sparks, Md.) and the cotton tip of the swab was broken off into the tube containing DIE. Samples were then vortexed for 30 seconds and diluted/enumerated as described before.

Three replicate samples for each surface treatment were tested for each time interval in this manner. Bacterial reductions were determined by comparing the recovery of bacteria from untreated control samples (polymer coated coupons without functionalized particles) to treated samples containing functionalized particles at each exposure interval.

3) Viral Kill Assay.

Poliovirus 1 experiments were conducted in 10 ml of sterile PBS in 50 ml sterile polypropylene conical tubes (Becton Dickinson and Company, Franklin Lakes, N.J.). MS2 experiments were conducted in 50 ml of sterile PBS in 250 ml sterile covered Pyrex beakers. The purified stocks of the viruses were added separately to the tubes/beakers to achieve the desired final test concentration of approximately 1.0×10⁶ PFU/ml. Functionalized particles of the present invention were evaluated at either 10 ppm silver or 59 ppm copper. The tubes/beakers were then placed on an orbital shaker (300 rpm) for the duration of the experiment. Experiments were performed at 25° C. At predetermined time intervals (e.g., 3, 5, 7, 24 hours), 100 μl samples were collected and neutralized with Dey Engley neutralizing broth (D/E; Difco, Sparks, Md.) at a ratio of 1:10. Functionalized particle efficacy was determined by the agar overlay method as described above in maintenance and preparation of viruses section.

4) Mold Kill Assay.

Sterile 50 ml polypropylene conical tubes (Becton Dickinson and Company, Franklin Lakes, N.J.) containing PBS were inoculated with mold spore suspensions of approximately 1.0×10⁶ CFU/ml. Functionalized particles of the present invention were evaluated at either 10 ppm silver or 59 ppm copper. Test samples were then placed on an orbital shaker (300 rpm) at 25° C. for the duration of the experiment. At predetermined time intervals (e.g., 1, 3, 5, 24 hours), 100 μl samples were collected and neutralized with Dey Engley neutralizing broth (D/E; Difco, Sparks, Md.) at a ratio of 1:10. Mold samples were serially diluted in sterile PBS and enumerated with the spread plate method (Eaton et al., “Spread Plate Method,” in Standard Methods for the Examination of Water & Wastewater, 21^{st} ed., American Public Health Association, Washington, D.C., pp. 9-38-9-40. 9215C, 2005) at 25° C. for 48 and 72 hours.

5) Determination of Antimicrobial Activity by Optical Density Measurements.

Bacterial suspensions with or without antimicrobial particles where monitored for growth using a turbidimetric measurement. Turbid or cloudy suspensions indicated growth or increase in biomass whereas clear suspensions indicate no growth or no increase in biomass. A deficiency or lack of growth correlates to the effectiveness of the antimicrobial particles. Optical densities where monitored using a spectrophotometer such as an Eppendorf Bio Photometer cuvette reader (Eppendorf North America, Inc, Enfield, Conn.) or Biotek Synergy 2 multiwell plate reader (Biotek Inc., Winooski, Vt.).

6) Determination of Activity Against Bacterial Spore Germination.

Preparation of spores. One-liter cultures were grown in Erlenmeyer flasks containing trypticase soy broth (TSB; Difco, Sparks, Md.) inoculated with exponential-phase cells from trypticase soy precultures. The cultures were incubated at 37° C. on a rotary shaker at 200 rpm. Spore development was visualized by phase contrast microscopy. The cultures were harvested after 72 hours. All harvesting and washing procedures were performed at 25° C. Spores were harvested by centrifugation and resuspended with one quarter culture volume of a solution containing 1M KCL and 0.5M NaCl. Centrifugation was repeated and cultures were resuspended in one tenth culture volume of 50 mM Tris-HCL (pH 7.2) containing 1 mg lysozyme per milliliter. Cell suspensions were then incubated at 37° C. for 1 hour followed by alternate centrifugation and washing with 1M NaCl, deionized water, 0.05% sodium dodecyl sulfate (SDS), 50 mM Tris-HCl, pH 7.2; 10 mM EDTA and three additional wash steps in deionized water. Spore suspensions were heat-shocked at 80° C. for 10 min and stored at 4° C. until use (Nicholson, W. L. and P. Setlow. 1990. Sporulation, germination, and outgrowth. pp. 391-450. In Harwood, C R and Cutting, S M (eds.) Molecular biological methods for Bacillus. John Wiley & Sons, New York).

Germination assay. Two milliliter polypropylene tubes were inoculated with B. cereus spore suspensions treated with approximately 2 pM or 59 ppm of nanoparticles for 24 hours at room temperature. After 24 hours of incubation, suspensions were pelleted by centrifugation at 13,000×g, and the supernatant removed and discarded. Pellets were resuspended in 200 μl of TSB. The tubes were then incubated for 24 hours at 25° C. and 37° C. Germination characteristics of B. cereus spores after 24 hours of incubation with nanoparticle chemistries were determined by optical density (Eppendorf Bio Photometer) at a wavelength of 600 nm (OD600).

### Example 43

### Antimicrobial Effectiveness of Particle Suspensions Against Target Microbes

The results listed above do not cover each and every variation of the materials used in Tables 2 through 9. The formula numbers are only a guide to correlate the samples among these tables. All the samples in these tables were made by PROCEDURE SET 1 (Examples 1 through 20).

For purposes of illustration, Formula #E33_{B} in Table 2 comprises a mixture of different functionalized metal halide particles including silver iodide and copper bromide, where the particles are surface modified with PVP and then TGN. This particular formula was made using the process of Example 16. Since in this formulation silver is 5.6 ppm in excess of the iodide, the silver stoichiometry was 56% more as compared to the sodium iodide salt.

In all cases for testing against microbes, the solutions were diluted so as to result in 10 ppm silver metal concentration unless mentioned otherwise.

This example reflects the testing of a variety of binary mixed metal halide particle compositions and their efficacy against seven different pathogenic species. The results obtained from evaluating the antimicrobial effectiveness of a range of particles prepared with different chemistries and surface modifications against target microbes are presented in Tables 2-9 for the following microbes: E. coli (ATCC 15579), Table 2; P. aeruginosa (ATCC 27313), Table 3; M. fortuitum (ATCC 6841), Table 4; S. aureus (ATCC 25923), Table 5; E. faecalis (ATCC 19433), Table 6; Copper-resistant E. coli (77-30013-2), Table 7; MS2 colliphage (ATCC 15597-B1), Table 8; Poliovirus (PV-1, LSc-2ab), Table 9.

The abbreviations used in the following tables are as follows:

Amino Acid Modifiers column: Leu=Leucine; Lys=Lysine; Asp=Aspartic acid; PVP=Polyvinylpyrrolidone. Thiol Modifier Column: AT=Aminothiol; TGO=Thioglycerol; TGN=Thioglycine; TLA=Thiolactic acid; TMA=Thiomalic acid; TOA=Thiooctic acid; TS=Thiosilane.

Subscripts for Formula Numbers: R#=repeat test with same sample for the “#” time, i.e. R1 is the 1^{st} repeat of this sample. Letters other than “R” indicate a sample that has been remade, i.e. A is the first remake, B is the second remake, etc.

The headers in Tables 2-9 are explained as follows: “Formula #” refers to an internal tracking number; “1° Constituent (% weight)” refers to the metal constituent and to its weight percent in the first metal halide particle; “1° Halogen” refers to the halogen in the primary metal halide salt particle; “2° Constituent” refers to the metal constituent in the second metal halide particle; “2° Halogen” refers to the halogen in the second metal halide salt particle; “AA Modifier (Ag:AA, in mol)” refers to the amino acid or polymer, if any, used to stabilize the particle(s) in solution, and its silver to amino acid/polymer ratio in moles; “Thiol modifier (Ag:SH)” refers to the thiol modifier used to stabilize the particle(s) in water, and the ratio of silver to thiol in moles; “Exposure time” is the time (usually stated in hours) that a bacterial sample was exposed to a test article coated with a composition of the present invention; “Log₁₀” is the resulting reduction in the number of bacterial counts versus a control, on a logarithmic scale.

TABLE 2
Nanoparticle Results against Escherichia coli (ATCC 15597)

| | 1° | | | | AA | Thiol | Exposure | |
|---|---|---|---|---|---|---|---|---|
| | Constituent | 1° | 2° | 2° | Modifier | Modifier | Time | |
| Formula # | (% weight) | Halogen | Constituent* | Halogen | (Ag:AA) | (Ag:SH) | (hours) | Log₁₀ |
| E-30_{B} | Ag (0.50%) | I | Cu (5.0%) | Br | PVP(1:2.5) | — | 5 | 3.57 |
| | ex: 5.6 ppm | | | | | | | |
| E-33_{B} | Ag (0.50%) | I | Cu (5.0%) | Br | PVP(1:2.5) | TGN | 5 | 4.32 |
| | ex: 5.6 ppm | | | | | (1:0.50) | | |
| H-02_{B} | Ag (0.50%) | Br | Cu (5.0%) | I | PVP(1:2.5) | — | 5 | >4.80 |
| | | | ex: 0.15 ppm | | | | | |
| H-04_{A} | Ag (0.50%) | Br | Cu (5.0%) | I | PVP(1:2.5) | TGN | 5 | 3.80 |
| | | | ex: 0.15 ppm | | | (1:0.50) | | |

*2° Constituent metal concentration is given in relative molar percentage based on silver moles from 1° constituent (e.g., Ag 0.5%, Cu 5% means formulation has 0.5 Wt % silver and the copper/silver ratio is 5%. Before use the formulation is diluted to 10 ppm silver, unless mentioned otherwise.)

Table 2 contains the numbers of E. coli bacteria after exposure for 5 hours to selected combinations of the functionalized particles, which are seen to decrease by more than 4 logs (i.e., fewer than 1 microbe in 10,000 survive). Specifically, Formulae E-33_{B}, a combination of AgI and CuBr particles functionalized with PVP and TGN show a 4.32 log₁₀ reduction in E. coli. Also, Formula H-02_{B}, a combination of AgBr/CuI particles functionalized with PVP only, showed the single highest E. coli reduction, a greater than 4.8 log₁₀ reduction.

TABLE 3
Nanoparticle Results against Pseudomonas aeruginosa (ATCC 27313)

| | 1° | | | | AA | Thiol | Exposure | |
|---|---|---|---|---|---|---|---|---|
| | Constituent | 1° | 2° | 2° | Modifier | Modifier | Time | |
| Formula # | (% weight) | Halogen | Constituent* | Halogen | (Ag:AA) | (Ag:SH) | (hours) | Log₁₀ |
| D-02 | Ag (0.50%) | Br | Cu (2.5%) | Br | Asp (1:2) | TGN | 5 | 3.42 |
| | | | | | | (1:0.50) | | |
| D-03 | Ag (0.50%) | Br | Cu (2.5%) | Br | Asp (1:2) | TLA | 5 | 2.18 |
| | | | | | | (1:0.50) | | |
| D-04 | Ag (0.50%) | Br | Cu (2.5%) | Br | Asp (1:2) | TMA | 5 | 2.60 |
| | | | | | | (1:0.50) | | |
| D-07 | Ag (0.50%) | I | Cu (2.5%) | Br | Asp (1:2) | TGN | 5 | 2.42 |
| | | | | | | (1:0.50) | | |
| D-08 | Ag (0.50%) | I | Cu (2.5%) | Br | Asp (1:2) | TLA | 5 | 3.21 |
| | | | | | | (1:0.50) | | |
| D-09 | Ag (0.50%) | I | Cu (2.5%) | Br | Asp (1:2) | TMA | 5 | 4.12 |
| | | | | | | (1:0.50) | | |
| D-09_{R1} | Ag (0.50%) | I | Cu (2.5%) | Br | Asp (1:2) | TMA | 5 | 2.16 |
| | | | | | | (1:0.50) | | |
| D-12 | Ag (0.50%) | Br | Cu (5.0%) | Br | Asp (1:2) | TGN | 5 | 3.62 |
| | | | | | | (1:0.50) | | |
| D-17 | Ag (0.50%) | I | Cu (5.0%) | Br | Asp (1:2) | TGN | 5 | 3.86 |
| | | | | | | (1:0.50) | | |
| D-17_{R1} | Ag (0.50%) | I | Cu (5.0%) | Br | Asp (1:2) | TGN | 5 | 4.35 |
| | | | | | | (1:0.50) | | |
| D-18 | Ag (0.50%) | I | Cu (5.0%) | Br | Asp (1:2) | TLA | 5 | 3.20 |
| | | | | | | (1:0.50) | | |
| D-19 | Ag (0.50%) | I | Cu (5.0%) | Br | Asp (1:2) | TMA | 5 | 4.20 |
| | | | | | | (1:0.50) | | |
| D-19_{R1} | Ag (0.50%) | I | Cu (5.0%) | Br | Asp (1:2) | TMA | 5 | 3.81 |
| | | | | | | (1:0.50) | | |
| E-05 | Ag (0.50%) | Br | Cu (10.0%) | Br | PVP (1:2.5) | — | 5 | >5.65 |
| E-06 | Ag (0.50%) | Br | Cu (15.0%) | Br | PVP (1:2.5) | — | 5 | >5.65 |
| E-07 | Ag (0.50%) | Br | Cu (2.5%) | Br | PVP (1:2.5) | — | 5 | 2.11 |
| E-08 | Ag (0.50%) | Br | Cu (2.5%) | Br | PVP (1:2.5) | TGO | 5 | 2.66 |
| | | | | | | (1:0.50) | | |
| E-09 | Ag (0.50%) | Br | Cu (2.5%) | Br | PVP (1:2.5) | TGN | 5 | 2.53 |
| | | | | | | (1:0.50) | | |
| E-10 | Ag (0.50%) | Br | Cu (2.5%) | Br | PVP (1:2.5) | TLA | 5 | 2.42 |
| | | | | | | (1:0.50) | | |
| E-11 | Ag (0.50%) | Br | Cu (2.5%) | Br | PVP (1:2.5) | TMA | 5 | 2.08 |
| | | | | | | (1:0.50) | | |
| E-12 | Ag (0.50%) | Br | Cu (5.0%) | Br | PVP (1:2.5) | — | 5 | 2.49 |
| E-13 | Ag (0.50%) | Br | Cu (5.0%) | Br | PVP (1:2.5) | TGO | 5 | 3.06 |
| | | | | | | (1:0.50) | | |
| E-14 | Ag (0.50%) | Br | Cu (5.0%) | Br | PVP (1:2.5) | TGN | 5 | 3.45 |
| | | | | | | (1:0.50) | | |
| E-15 | Ag (0.50%) | Br | Cu (5.0%) | Br | PVP (1:2.5) | TLA | 5 | 3.33 |
| | | | | | | (1:0.50) | | |
| E-16 | Ag (0.50%) | Br | Cu (5.0%) | Br | PVP (1:2.5) | TMA | 5 | 3.19 |
| | | | | | | (1:0.50) | | |
| E-17 | Ag (0.50%) | I | Cu (10.0%) | Br | PVP (1:2.5) | — | 5 | 5.05 |
| E-18 | Ag (0.50%) | I | Cu (15.0%) | Br | PVP (1:2.5) | — | 5 | >5.65 |
| E-19 | Ag (0.50%) | I | Cu (5.0%) | Br | PVP (1:2.5) | — | 5 | 4.54 |
| E-20 | Ag (0.50%) | I | Cu (5.0%) | Br | PVP (1:2.5) | TGO | 5 | 3.54 |
| | | | | | | (1:0.50) | | |
| E-21 | Ag (0.50%) | I | Cu (5.0%) | Br | PVP (1:2.5) | TGN | 5 | 3.85 |
| | | | | | | (1:0.10) | | |
| E-22 | Ag (0.50%) | I | Cu (5.0%) | Br | PVP (1:2.5) | TGN | 5 | 4.19 |
| | | | | | | (1:0.50) | | |
| E-23 | Ag (0.50%) | I | Cu (5.0%) | Br | PVP (1:2.5) | TLA | 5 | 3.22 |
| | | | | | | (1:0.50) | | |
| E-24 | Ag (0.50%) | I | Cu (5.0%) | Br | PVP (1:2.5) | TMA | 5 | 2.77 |
| | | | | | | (1:0.50) | | |
| E-25 | Ag (0.50%) | I | Cu (2.5%) | Br | PVP (1:2.5) | — | 5 | 4.51 |
| | ex: 6.3 ppm | | | | | | | |
| E-25_{R1} | Ag (0.50%) | I | Cu (2.5%) | Br | PVP (1:2.5) | — | 5 | 5.53 |
| | ex: 6.3 ppm | | | | | | | |
| E-26 | Ag (0.50%) | I | Cu (2.5%) | Br | PVP (1:2.5) | TGO | 5 | >5.76 |
| | ex: 6.3 ppm | | | | | (1:0.50) | | |
| E-26_{R1} | Ag (0.50%) | I | Cu (2.5%) | Br | PVP (1:2.5) | TGO | 5 | 5.53 |
| | ex: 6.3 ppm | | | | | (1:0.50) | | |
| E-26_{R1} | Ag (0.50%) | I | Cu (2.5%) | Br | PVP (1:2.5) | TGO | 3 | 2.02 |
| | ex: 6.3 ppm | | | | | (1:0.50) | | |
| E-27 | Ag (0.50%) | I | Cu (2.5%) | Br | PVP (1:2.5) | TGN | 5 | >5.76 |
| | ex: 6.3 ppm | | | | | (1:0.50) | | |
| E-27_{R1} | Ag (0.50%) | I | Cu (2.5%) | Br | PVP (1:2.5) | TGN | 5 | 5.53 |
| | ex: 6.3 ppm | | | | | (1:0.50) | | |
| E-27_{R1} | Ag (0.50%) | I | Cu (2.5%) | Br | PVP (1:2.5) | TGN | 3 | 3.97 |
| | ex: 6.3 ppm | | | | | (1:0.50) | | |
| E-28 | Ag (0.50%) | I | Cu (2.5%) | Br | PVP (1:2.5) | TLA | 5 | 2.74 |
| | ex: 6.3 ppm | | | | | (1:0.50) | | |
| E-29 | Ag (0.50%) | I | Cu (2.5%) | Br | PVP (1:2.5) | TMA | 5 | 5.28 |
| | ex: 6.3 ppm | | | | | (1:0.50) | | |
| E-29_{R1} | Ag (0.50%) | I | Cu (2.5%) | Br | PVP (1:2.5) | TMA | 5 | 2.48 |
| | ex: 6.3 ppm | | | | | (1:0.50) | | |
| E-30 | Ag (0.50%) | I | Cu (5.0%) | Br | PVP (1:2.5) | — | 5 | >5.76 |
| | ex: 5.6 ppm | | | | | | | |
| E-30_{A} | Ag (0.50%) | I | Cu (5.0%) | Br | PVP (1:2.5) | — | 5 | 4.42 |
| | ex: 5.6 ppm | | | | | | | |
| E-30_{B} | Ag (0.50%) | I | Cu (5.0%) | Br | PVP (1:2.5) | — | 5 | 5.32 |
| | ex: 5.6 ppm | | | | | | | |
| E-30_{R1} | Ag (0.50%) | I | Cu (5.0%) | Br | PVP (1:2.5) | — | 5 | >5.53 |
| | ex: 5.6 ppm | | | | | | | |
| E-30_{R1} | Ag (0.50%) | I | Cu (5.0%) | Br | PVP (1:2.5) | — | 3 | 2.17 |
| | ex: 5.6 ppm | | | | | | | |
| E-31 | Ag (0.50%) | I | Cu (5.0%) | Br | PVP (1:2.5) | TGO | 5 | 5.46 |
| | ex: 5.6 ppm | | | | | (1:0.50) | | |
| E-31_{R1} | Ag (0.50%) | I | Cu (5.0%) | Br | PVP (1:2.5) | TGO | 5 | 3.75 |
| | ex: 5.6 ppm | | | | | (1:0.50) | | |
| E-33 | Ag (0.50%) | I | Cu (5.0%) | Br | PVP (1:2.5) | TGN | 5 | 5.16 |
| | ex: 5.6 ppm | | | | | (1:0.50) | | |
| E-33_{A} | Ag (0.50%) | I | Cu (5.0%) | Br | PVP (1:2.5) | TGN | 5 | 5.20 |
| | ex: 5.6 ppm | | | | | (1:0.50) | | |
| E-33_{B} | Ag (0.50%) | I | Cu (5.0%) | Br | PVP (1:2.5) | TGN | 5 | 5.06 |
| | ex: 5.6 ppm | | | | | (1:0.50) | | |
| E-33_{C} | Ag (0.50%) | I | Cu (5.0%) | Br | PVP (1:2.5) | TGN | 5 | >5.30 |
| | ex: 5.6 ppm | | | | | (1:0.50) | | |
| E-33_{R1} | Ag (0.50%) | I | Cu (5.0%) | Br | PVP (1:2.5) | TGN | 5 | >5.53 |
| | ex: 5.6 ppm | | | | | (1:0.50) | | |
| E-33_{R1} | Ag (0.50%) | I | Cu (5.0%) | Br | PVP (1:2.5) | TGN | 3 | 4.25 |
| | ex: 5.6 ppm | | | | | (1:0.50) | | |
| E-34 | Ag (0.50%) | I | Cu (5.0%) | Br | PVP (1:2.5) | TLA | 5 | 3.53 |
| | ex: 5.6 ppm | | | | | (1:0.50) | | |
| E-35 | Ag (0.50%) | I | Cu (5.0%) | Br | PVP (1:2.5) | TMA | 5 | 5.46 |
| | ex: 5.6 ppm | | | | | (1:0.50) | | |
| E-35_{R1} | Ag (0.50%) | I | Cu (5.0%) | Br | PVP (1:2.5) | TMA | 5 | 4.75 |
| | ex: 5.6 ppm | | | | | (1:0.50) | | |
| F-01 | Ag (0.50%) | Br | Cu (2.5%) | I | PVP (1:2.5) | — | 5 | 4.09 |
| | | | ex: 0.074 ppm | | | | | |
| F-02 | Ag (0.50%) | Br | Cu (5.0%) | I | PVP (1:2.5) | — | 5 | >5.65 |
| | ex: 0.194 ppm | | ex: 0.15 ppm | | | | | |
| F-03 | Ag (0.50%) | Br | Cu (10.0%) | I | PVP (1:2.5) | — | 5 | >5.65 |
| | ex: 0.5 ppm | | ex: 0.3 ppm | | | | | |
| F-06 | Ag (0.50%) | I | Cu (10.0%) | I | PVP (1:2.5) | — | 5 | 4.81 |
| | ex: 0.5 ppm | | ex: 0.3 ppm | | | | | |
| G-01 | Cu (0.50%) | I | — | — | PVP (1:2.5) | — | 5 | 5.35 |
| | ex: 5 ppm | | | | | | | |
| H-01 | Ag (0.50%) | Br | Cu (2.5%) | I | PVP (1:2.5) | — | 5 | 4.40 |
| | | | ex: 0.074 ppm | | | | | |
| H-02 | Ag (0.50%) | Br | Cu (5.0%) | I | PVP (1:2.5) | — | 5 | >5.65 |
| | | | ex: 0.15 ppm | | | | | |
| H-02_{A} | Ag (0.50%) | Br | Cu (5.0%) | I | PVP (1:2.5) | — | 5 | 5.50 |
| | | | ex: 0.15 ppm | | | | | |
| H-02_{B} | Ag (0.50%) | Br | Cu (5.0%) | I | PVP (1:2.5) | — | 5 | 5.60 |
| | | | ex: 0.15 ppm | | | | | |
| H-04 | Ag (0.50%) | Br | Cu (5.0%) | I | PVP (1:2.5) | TGN | 5 | 5.50 |
| | | | ex: 0.15 ppm | | | (1:0.50) | | |
| H-04_{A} | Ag (0.50%) | Br | Cu (5.0%) | I | PVP (1:2.5) | TGN | 5 | 3.92 |
| | | | ex: 0.15 ppm | | | (1:0.50) | | |
| H-04_{B} | Ag (0.50%) | Br | Cu (5.0%) | I | PVP (1:2.5) | TGN | 5 | 5.00 |
| | | | ex: 0.15 ppm | | | (1:0.50) | | |
| H-05 | Ag (0.50%) | Br | Cu (10.0%) | I | PVP (1:2.5) | — | 5 | 5.65 |
| | | | ex: 0.3 ppm | | | | | |
| H-06 | Ag (0.50%) | Br | Cu (5.0%) | I | PVP (1:2.5) | — | 5 | >5.30 |
| H-07 | Ag (0.50%) | Br | Cu (5.0%) | I | PVP (1:2.5) | TGN | 5 | 4.46 |
| | | | | | | (1:0.50) | | |
| I-1 | Cu (0.50%) | I | — | — | PVP (1:2.5) | — | 5 | >5.30 |
| X-01 | Ag (0.50%) | Br | Cu (5.0%) | I | PVP (1:2.5) | — | 5 | 5.20 |
| X-02 | Ag (0.50%) | Br | Cu (15.0%) | I | PVP (1:2.5) | — | 5 | 5.50 |
| X-03 | Ag (0.50%) | Br | Cu2+ (5.0%) | I | PVP (1:2.5) | — | 5 | 4.60 |
| | | | ex: 0.15 ppm | | | | | |
| X-04 | Ag (0.50%) | Br | Cu2+ (15.0%) | I | PVP (1:2.5) | — | 5 | 4.46 |
| | | | ex: 0.45 ppm | | | | | |

Table 3 shows selected results of combinations of functionalized metal halide particles against P. aeruginosa. Surprisingly, there are twenty-nine different combinations of silver halide and copper halide particles that exhibited at least 5 log₁₀ reduction over the test period of 5 hours. Considering the results on P. aeruginosa, it is seen that functionalized silver halide-copper halide nanoparticle combinations are notably more effective in killing the microbes than functionalized silver metal nanoparticles alone. Functionalized silver metal nanoparticles alone showed no more than 0.93 log₁₀ reduction, functionalized silver bromide particles 3.68 log₁₀, and functionalized silver iodide particles 0.97 log₁₀ (data not shown). Silver chloride nanoparticles, with the exception of Formula A-07 (not shown) did not have much effect on P. aeruginosa. It is also seen that combinations of functionalized silver halide particles with functionalized copper halide particles are more effective than functionalized silver halide particles alone, given the twenty-nine results in excess of 5 log₁₀ reduction. It is further seen that combinations of functionalized silver halide particles with functionalized copper halide particles where the halides are different on the two cations provide further enhanced antimicrobial effectiveness. It is noteworthy that two examples of CuI-PVP, Formulae G-01 and I-1, recorded a 5.35 and 5.30, respectively, log₁₀ reduction without any silver halide co-particle.

TABLE 4
Nanoparticle Results against Mycobacterium fortuitum (ATCC 6841)

| | 1° | | | | AA | Thiol | Exposure | |
|---|---|---|---|---|---|---|---|---|
| | Constituent | 1° | 2° | 2° | Modifier | Modifier | Time | |
| Formula # | (% weight) | Halogen | Constituent * | Halogen | (Ag:AA) | (Ag:SH) | (hours) | Log₁₀ |
| E-19_{A} | Ag (0.50%) | I | Cu (5.0%) | Br | PVP (1:2.5) | — | 48 | 2.62 |
| E-22_{A} | Ag (0.50%) | I | Cu (5.0%) | Br | PVP (1:2.5) | TGN | 48 | 2.84 |
| | | | | | | (1:0.50) | | |
| E-30_{B} | Ag (0.50%) | I | Cu (5.0%) | Br | PVP (1:2.5) | — | 48 | 2.73 |
| | ex: 5.6 ppm | | | | | | | |
| E-30_{C} | Ag (0.50%) | I | Cu (5.0%) | Br | PVP (1:2.5) | — | 48 | 4.41 |
| | ex: 5.6 ppm | | | | | | | |
| E-30_{C} | Ag (0.50%) | I | Cu (5.0%) | Br | PVP (1:2.5) | — | 18 | 2.58 |
| | ex: 5.6 ppm | | | | | | | |
| E-33_{B} | Ag (0.50%) | I | Cu (5.0%) | Br | PVP (1:2.5) | TGN | 48 | 4.73 |
| | ex: 5.6 ppm | | | | | (1:0.50) | | |
| E-33_{C} | Ag (0.50%) | I | Cu (5.0%) | Br | PVP (1:2.5) | TGN | 48 | 3.84 |
| | ex: 5.6 ppm | | | | | (1:0.50) | | |
| E-33_{C} | Ag (0.50%) | I | Cu (5.0%) | Br | PVP (1:2.5) | TGN | 18 | 2.31 |
| | ex: 5.6 ppm | | | | | (1:0.50) | | |
| F-05_{A} | Ag (0.50%) | I | Cu (5.0%) | I | PVP (1:2.5) | — | 48 | 3.05 |
| | ex: 0.194 ppm | | ex: 0.15 ppm | | | | | |
| F-05_{B} | Ag (0.50%) | I | Cu (5.0%) | I | PVP (1:2.5) | — | 48 | 4.19 |
| | ex: 0.194 ppm | | ex: 0.15 ppm | | | | | |
| F-05_{B} | Ag (0.50%) | I | Cu (5.0%) | I | PVP (1:2.5) | — | 18 | 2.10 |
| | ex: 0.194 ppm | | ex: 0.15 ppm | | | | | |
| G-01_{B} | Cu (0.50%) | I | — | — | PVP (1:2.5) | — | 48 | 2.07 |
| | ex: 5 ppm | | | | | | | |
| H-02_{B} | Ag (0.50%) | Br | Cu (5.0%) | I | PVP (1:2.5) | — | 48 | 4.73 |
| | | | ex: 0.15 ppm | | | | | |
| H-02_{C} | Ag (0.50%) | Br | Cu (5.0%) | I | PVP (1:2.5) | — | 18 | 3.17 |
| | | | ex: 0.15 ppm | | | | | |
| H-02_{C} | Ag (0.50%) | Br | Cu (5.0%) | I | PVP (1:2.5) | — | 48 | 2.89 |
| | | | ex: 0.15 ppm | | | | | |
| H-04_{A} | Ag (0.50%) | Br | Cu (5.0%) | I | PVP (1:2.5) | TGN | 48 | 4.13 |
| | | | ex: 0.15 ppm | | | (1:0.50) | | |
| H-04_{B} | Ag (0.50%) | Br | Cu (5.0%) | I | PVP (1:2.5) | TGN | 18 | 2.81 |
| | | | ex: 0.15 ppm | | | (1:0.50) | | |
| H-04_{B} | Ag (0.50%) | Br | Cu (5.0%) | I | PVP (1:2.5) | TGN | 48 | 2.59 |
| | | | ex: 0.15 ppm | | | (1:0.50) | | |
| H-06 | Ag (0.50%) | Br | Cu (5.0%) | I | PVP (1:2.5) | — | 48 | 3.45 |
| H-06 | Ag (0.50%) | Br | Cu (5.0%) | I | PVP (1:2.5) | — | 18 | 2.84 |
| I-1 | Cu (0.50%) | I | — | — | PVP (1:2.5) | — | 48 | 2.31 |

Table 4 shows the results of testing functionalized metal halide particles against M. fortuitum. The results shown in Table 4 for M. fortuitum indicate remarkable killing efficiency, with five examples of reductions in bacterial populations greater than 4 logs in 48 hours. (Since mycobacteria are known to undergo mitosis at a much slower rate than conventional bacteria, the exposure times for M. fortuitum were longer than those for P. aeruginosa or E. coli.) These results on M. fortuitum suggest that the present functionalized particles would also be effective against M. tuberculosis, and even against M. tuberculosis which is resistant to conventional antibiotics—since the mechanism of antimicrobial activity of the present antimicrobial agents is very different from the antimicrobial mechanisms of conventional antibiotics. Notably, the CuI particles alone were inferior to the combinations, suggesting a synergistic effect between the silver halide and copper halide particles.

TABLE 5
Nanoparticle Results against Staphylococcus aureus (ATCC 25923)

| | 1° | | | | AA | Thiol | Exposure | |
|---|---|---|---|---|---|---|---|---|
| | Constituent | 1° | 2° | 2° | Modifier | Modifier | Time | |
| Formula # | (% weight) | Halogen | Constituent * | Halogen | (Ag:AA) | (Ag:SH) | (hours) | Log₁₀ |
| E-19_{A} | Ag (0.50%) | I | Cu (5.0%) | Br | PVP (1:2.5) | — | 24 | 3.76 |
| E-22_{A} | Ag (0.50%) | I | Cu (5.0%) | Br | PVP (1:2.5) | TGN | 24 | 2.74 |
| | | | | | | (1:0.50) | | |
| E-30_{C} | Ag (0.50%) | I | Cu (5.0%) | Br | PVP (1:2.5) | — | 24 | >5.19 |
| | ex: 5.6 ppm | | | | | | | |
| E-33_{C} | Ag (0.50%) | I | Cu (5.0%) | Br | PVP (1:2.5) | TGN | 24 | 3.66 |
| | ex: 5.6 ppm | | | | | (1:0.50) | | |
| H-02_{C} | Ag (0.50%) | Br | Cu (5.0%) | I | PVP (1:2.5) | — | 24 | 2.94 |
| | | | ex: 0.15 ppm | | | | | |

Table 5 shows the results of testing functionalized metal halide particles against S. aureus. Fewer investigations were carried out on the antimicrobial effectiveness of the functionalized particles against Gram-positive bacteria, the results obtained against S. arueus shown here are nevertheless encouraging, with reductions in bacterial populations greater than 5 logs in 24 hours having been obtained (Formula E-30_{C}, AgI/CuBr-PVP, >5.19 log₁₀).

TABLE 6
Nanoparticle Results against Enterococcus faecalis (ATCC 19433)

| | 1° | | | | AA | Thiol | Exposure | |
|---|---|---|---|---|---|---|---|---|
| | Constituent | 1° | 2° | 2° | Modifier | Modifier | Time | |
| Formula # | (% weight) | Halogen | Constituent * | Halogen | (Ag:AA) | (Ag:SH) | (hours) | Log₁₀ |
| E-19_{A} | Ag (0.50%) | I | Cu (5.0%) | Br | PVP (1:2.5) | — | 24 | 2.19 |
| E-30_{C} | Ag (0.50%) | I | Cu (5.0%) | Br | PVP (1:2.5) | — | 24 | 2.47 |
| | ex: 5.6 ppm | | | | | | | |
| E-33_{C} | Ag (0.50%) | I | Cu (5.0%) | Br | PVP (1:2.5) | TGN | 24 | >5.24 |
| | ex: 5.6 ppm | | | | | (1:0.50) | | |
| E-33_{C} | Ag (0.50%) | I | Cu (5.0%) | Br | PVP (1:2.5) | TGN | 5 | 2.53 |
| | ex: 5.6 ppm | | | | | (1:0.50) | | |
| F-05_{B} | Ag (0.50%) | I | Cu (5.0%) | I | PVP (1:2.5) | — | 24 | 2.14 |
| | ex: 0.194 ppm | | ex: 0.15 ppm | | | | | |
| G-01_{B} | Cu (0.50%) | I | — | — | PVP (1:2.5) | — | 24 | >5.24 |
| | ex: 5 ppm | | | | | | | |
| G-01_{B} | Cu (0.50%) | I | — | — | PVP (1:2.5) | — | 5 | 2.59 |
| | ex: 5 ppm | | | | | | | |
| H-02_{C} | Ag (0.50%) | Br | Cu (5.0%) | I | PVP (1:2.5) | — | 24 | 2.39 |
| | | | ex: 0.15 ppm | | | | | |
| H-04_{B} | Ag (0.50%) | Br | Cu (5.0%) | I | PVP (1:2.5) | TGN | 24 | >5.24 |
| | | | ex: 0.15 ppm | | | (1:0.50) | | |
| H-04_{B} | Ag (0.50%) | Br | Cu (5.0%) | I | PVP (1:2.5) | TGN | 5 | 2.90 |
| | | | ex: 0.15 ppm | | | (1:0.50) | | |

Table 6 shows the results of testing functionalized metal halide particles against E. faecallis. From the results it is apparent that the present functionalized particles are even effective against enterococci. As seen in the table, reductions in bacterial populations greater than 5 log₁₀ in 24 hours have been obtained using combinations of functionalized particles. Specifically, E-33_{c} (Agl/CuBr-PVP-TGN), and H-04_{B} (AgBr/CuI-PVP-TGN). The copper iodide example, G-01_{B} (CuI-PVP) matched or exceeded the silver halide/copper halide combinations.

TABLE 7
Nanoparticle Results against Copper Resistant Escherichia coli

| | 1° | | | | AA | Thiol | Exposure | |
|---|---|---|---|---|---|---|---|---|
| | Constituent | 1° | 2° | 2° | Modifier | Modifier | Time | |
| Formula # | (% weight) | Halogen | Constituent * | Halogen | (Ag:AA) | (Ag:SH) | (hours) | Log₁₀ |
| E-33_{C} | Ag (0.50%) | I | Cu (5.0%) | Br | PVP (1:2.5) | TGN | 5 | 2.93 |
| | ex: 5.6 ppm | | | | | (1:0.50) | | |
| H-04_{B} | Ag (0.50%) | Br | Cu (5.0%) | I | PVP (1:2.5) | TGN | 5 | 2.35 |
| | | | ex: 0.15 ppm | | | (1:0.50) | | |

Table 7 shows the results of testing functionalized metal halide particles against copper-resistant E. coli. When tested against the microbes, reductions in bacterial populations approaching 3 logs have been obtained in 5 hours using combinations of the present functionalized particles (see Table 7). Specifically, almost three logs of reduction 99.9% (log₁₀ 2.93) was obtained with Formula E-33C (AgI/CuBr-PVP-TGN).

TABLE 8
Nanoparticle Results against MS2 coliphage (ATCC 15597-B1)

| | 1° | | | | AA | Thiol | Exposure | |
|---|---|---|---|---|---|---|---|---|
| | Constituent | 1° | 2° | 2° | Modifier | Modifier | Time | |
| Formula # | (% weight) | Halogen | Constituent * | Halogen | (Ag:AA) | (Ag:SH) | (hours) | Log₁₀ |
| A-04_{C} | Ag (0.50%) | Br | — | — | Asp (1:2) | TMA | 24 | 5.28 |
| | | | | | | (1:0.25) | | |
| A-07_{A} | Ag (0.50%) | Cl | — | — | Asp (1:2) | TGN | 24 | 4.08 |
| | | | | | | (1:0.50) | | |
| D-02_{A} | Ag (0.50%) | Br | Cu (2.5%) | Br | Asp (1:2) | TGN | 24 | 2.63 |
| | | | | | | (1:0.50) | | |
| D-09_{A} | Ag (0.50%) | I | Cu (2.5%) | Br | Asp (1:2) | TMA | 24 | >5.28 |
| | | | | | | (1:0.50) | | |
| D-17_{A} | Ag (0.50%) | I | Cu (5.0%) | Br | Asp (1:2) | TGN | 24 | >5.28 |
| | | | | | | (1:0.50) | | |
| D-19_{A} | Ag (0.50%) | I | Cu (5.0%) | Br | Asp (1:2) | TMA | 24 | >5.28 |
| | | | | | | (1:0.50) | | |
| E-06_{A} | Ag (0.50%) | Br | Cu (15.0%) | Br | PVP (1:2.5) | — | 24 | 2.20 |
| E-27_{A} | Ag (0.50%) | I | Cu (2.5%) | Br | PVP (1:2.5) | TGN | 24 | >4.07 |
| | ex: 6.3 ppm | | | | | (1:0.50) | | |
| E-29_{A} | Ag (0.50%) | I | Cu (2.5%) | Br | PVP (1:2.5) | TMA | 24 | >4.07 |
| | ex: 6.3 ppm | | | | | (1:0.50) | | |
| E-33_{D} | Ag (0.50%) | I | Cu (5.0%) | Br | PVP (1:2.5) | TGN | 24 | >4.07 |
| | ex: 5.6 ppm | | | | | (1:0.50) | | |
| E-35_{A} | Ag (0.50%) | I | Cu (5.0%) | Br | PVP (1:2.5) | TMA | 24 | >4.07 |
| | ex: 5.6 ppm | | | | | (1:0.50) | | |
| G-01_{B} | Cu (0.50%) | I | — | — | PVP (1:2.5) | — | 24 | >4.07 |
| | ex: 5 ppm | | | | | | | |
| G-01_{C} | Cu (0.50%) | I | — | — | PVP (1:2.5) | — | 24 | >5.25 |
| | ex: 5 ppm | | | | | | | |
| H-01_{A} | Ag (0.50%) | Br | Cu (2.5%) | I | PVP (1:2.5) | — | 24 | 4.01 |
| | | | ex: 0.074 ppm | | | | | |
| H-02_{D} | Ag (0.50%) | Br | Cu (5.0%) | I | PVP (1:2.5) | — | 24 | 4.65 |
| | | | ex: 0.15 ppm | | | | | |
| H-04_{C} | Ag (0.50%) | Br | Cu (5.0%) | I | PVP (1:2.5) | TGN | 24 | >5.25 |
| | | | ex: 0.15 ppm | | | (1:0.50) | | |
| H-05_{A} | Ag (0.50%) | Br | Cu (10.0%) | I | PVP (1:2.5) | — | 24 | 5.25 |
| | | | ex: 0.3 ppm | | | | | |
| I-1 | Cu (0.50%) | I | — | — | PVP (1:2.5) | — | 24 | >4.07 |
| X-03_{A} | Ag (0.50%) | Br | Cu2+ (5.0%) | I | PVP (1:2.5) | — | 24 | 3.31 |
| | | | ex: 0.15 ppm | | | | | |
| X-04_{A} | Ag (0.50%) | Br | Cu2+ (15.0%) | I | PVP (1:2.5) | — | 24 | >5.25 |
| | | | ex: 0.45 ppm | | | | | |

Table 8 shows the results of testing functionalized metal halide particles against a different genus, that of bacteriophage. Bacteriophage are viruses that attack bacteria. Results of the functionalized metal halide particles against MS2 coliphage are shown in Table 8. The present functionalized particles were tested against bacteriophage to evaluate their potential effectiveness against viruses without the necessity of testing involving cell culture. As seen in Table 8, combinations of the present functionalized particles were found to be highly effective in decreasing the microbial populations of this bacteriophage, with decreases exceeding 5 logs in 24 hours being obtained.

TABLE 9
Nanoparticle Results against Poliovirus (PV-1 LSc-2ab)

| | 1° | | | | AA | Thiol | Exposure | |
|---|---|---|---|---|---|---|---|---|
| | Constituent | 1° | 2° | 2° | Modifier | Modifier | Time | |
| Formula # | (% weight) | Halogen | Constituent * | Halogen | (Ag:AA) | (Ag:SH) | (hours) | Log₁₀ |
| G-01_{B} | Cu (0.50%) | I | — | — | PVP (1:2.5) | — | 24 | 2.00 |
| | ex: 5 ppm | | | | | | | |
| G-01_{C} | Cu (0.50%) | I | — | — | PVP (1:2.5) | — | 24 | 2.56 |
| | ex: 5 ppm | | | | | | | |
| I-1 | Cu (0.50%) | I | — | — | PVP (1:2.5) | — | 24 | 3.11 |

The testing carried out on Poliovirus, some of which are shown in Table 9, were likewise encouraging although not as dramatic as the results obtained on the bacteriophage. Functionalized CO particles were found to be particularly effective against poliovirus, with decreases in microbial populations greater than 3 logs being found in 24 hours. A further encouraging result of the testing on poliovirus was the observation of the cell culture work carried out here, which showed no adverse effect of the functionalized particles on cell viability and reproduction in culture.

It is seen from the data in Tables 2-9 that remarkable decreases in bacterial populations can be obtained using functionalized nanoparticles comprising embodiments of the invention including metal halides. Since among Gram-negative bacteria, P. aeruginosa is generally more difficult to kill than E. coli, more data were presented for P. aeruginosa.

### Example 44

### Evaluation of Effectiveness of Functionalized Silver Halide, Modified Silver Halide and Mixed-Metal Halide Nanoparticles Against B. cereus Spores

All previously-mentioned chemicals are incorporated by reference herein.

a) Preparation of Stock Solutions and Sols:

### 1% Alanine-Solution

1% w/w aqueous solution of Alanine was made by dissolving 0.05 g Alanine in 4.95 g water and keeping it stirred until it was a clear solution.

Preparation of CuI particles with excess Cu²⁺ (see Example 18)

### Preparation of CuI-particles (see Example 17)

Preparation of AgBr particles (see Example 5)
Preparation of AgBr particles-doped with 2.5% CuBr

CuBr-Solution:

0.0106 g of copper (I) bromide was dissolved in 0.500 g 48% Hydrobromic acid, afterwards diluted with 16 g water and kept stirring until a clear solution was obtained.

0.2079 g silver nitrate was dissolved in 13.682 g water and then 3.30 g 10% w/w PVP (MW 10,000) aqueous solution added into it. Finally 6.810 g of CuBr-solution prepared above was slowly dropped under stirring. The concentration of silver based on the calculation of metallic silver is 0.55 w/w in which Ag/Cu ratio is 40/1 in mol/mol (2.5%). This procedure results in largely AgBr particles which also comprise copper bromide (doping of AgBr particles by CuBr, or particles of mixed halides).

Preparation of AgI Particles—Doped with 2.5% CuBr

CuBr-Solution:

0.0106 g of copper (I) bromide was dissolved in 0.048 g 48% Hydrobromic acid, afterwards diluted with 8 g water and kept stirring until a clear solution was obtained.

0.2079 g silver nitrate was dissolved in 12 g water and then 3.30 g 10% w/w PVP (MW 10,000) aqueous solution added into it. 3.324 g of CuBr-solution prepared above were slowly dropped under stirring.

Finally a solution of 0.1628 g sodium iodide in 5 g water was slowly dropped and kept stirring overnight to allow the formation of particles. The concentration of silver based on the calculation of metallic silver was 0.55% w/w in which Ag/Cu ratio is 40/1 in mol/mol (2.5%).

b) Preparation of Functionalized Particle Samples:

Samples were prepared by mixing of components as prepared above in a sure seal bottle under stirring in the order described in Tables 10 and 11 as shown below (“NP” denotes nanoparticles), Table 10 shows the formulations surface modified by alanine (ALA) and Table 11 shows formulations modified with PVP.

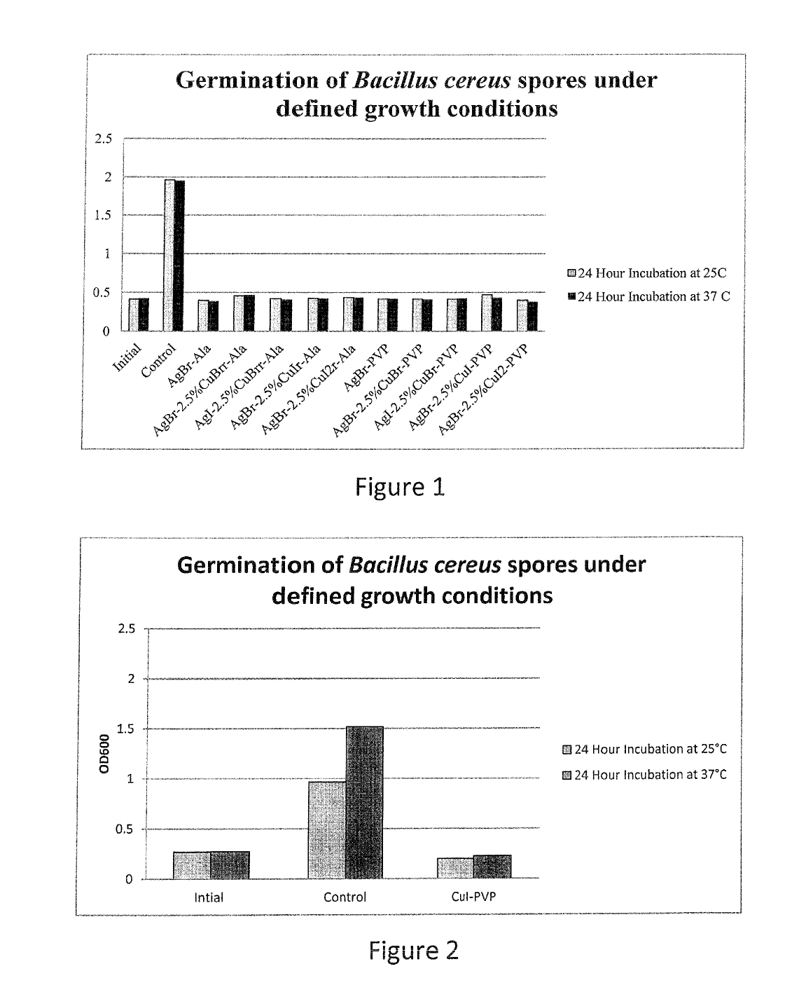

TABLE 10

| | Sample designations in FIG. 1 (w/alanine) | | | | |
|---|---|---|---|---|---|
| Components | AgBr | AgBr—2.5%CuBr | AgI—2.5%CuBr | AgBr—2.5%CuI | AgBr—2.5%CuI2 |
| AgBr-NP, g | 3.16 | — | — | 3.5 | 3.5 |
| AgBr—2.5%CuBr-NP, g | — | 3.5 | — | — | — |
| AgI—2.5%CuBr-NP, g | — | — | 3.5 | — | — |
| CuI-NP with excess Cu²⁺, g | — | — | — | 0.063 | — |
| CuI-NP, g | — | — | — | — | 0.063 |
| 1% Alanine-sol, g | 0.057 | 0.057 | 0.057 | 0.063 | 0.063 |
| Water, g | 0.633 | 0.293 | 0.293 | 0.644 | 0.644 |

TABLE 11

| | Sample designations in FIG. 1 (PVP) | | | | |
|---|---|---|---|---|---|
| | AgBr- | AgBr—2.5%CuBr- | AgI—2.5%CuBr- | AgBr—2.5%CuI- | AgBr—2.5%CuI2- |
| Components | PVP | PVP | PVP | PVP | PVP |
| AgBr-NP, g | 3.5 | — | — | 3.5 | 3.5 |
| AgBr—2.5%CuBr-NP, g | — | 3.5 | — | — | — |
| AgI—2.5%CuBr-NP, g | — | — | 3.5 | — | — |
| CuI-NP with excess Cu²⁺, g | — | — | — | 0.063 | — |
| CuI-NP, g | — | — | — | — | 0.063 |
| Water, g | 0.77 | 0.35 | 0.35 | 0.707 | 0.707 |

The germination responses of spores to various particles functionalized with L-alanine (ALA) or PVP were measured after a 24 hour static incubation period. The results are shown in FIG. 1, where the particles identified with an “-Ala” suffix were functionalized with L-alanine.

As seen in FIG. 1, the control B. cereus spore samples exhibited appreciable increases in optical density (appreciable growth) when exposed to nutrient conditions, while B. cereus spores treated with the indicated functionalized metal halide particles exhibited essentially no change in optical density (no growth) when exposed to the same nutrient conditions. Besides the specific functionalized particles used in these tests, one may also use other functionalized particles of this invention, including functionalized nanoparticles, to deactivate spores. While L-alanine was used as a functionalizing agent in some of the tests, other amino acids and combinations of amino acids may also be used.

### Example 45

### Effect of CuI Particles on Inhibiting the Growth of Spores

FIG. 2 is a bar chart that shows the effect of CuI/PVP inhibition on B. cereus spores growth. CuI/PVP suspensions were made as in Example 28, and the copper concentration was 59 ppm in the final medium comprising CuI/PVP and the bacterial broth. This figure clearly shows the effectiveness of CuI/PVP in preventing B. cereus spores growth, and in fact even achieving a slight reduction as compared to the starting spore concentration.

### Examples 46-52

### Additional Antimicrobial Results Using Particulate Suspensions

Antimicrobial testing was carried out on the following microbes:

Ex. 46—Pseudomonas aeruginosa (ATCC 27313) (Table 13)

Ex. 47—Staphylococcus aureus (ATCC 25923) (Tables 14)

Ex. 48—Streptococcus mutans (ATCC 25175) (Table 15)

Ex. 49—S. enterica Typhimurium (ATCC 23564) (Table 16)

Ex. 50—Mycobacterium fortuitum (ATCC 6841) (Table 17)

Ex. 51—Penicillium (Table 18)

Ex. 52—Aspergillus niger (Table 19)

Table 12 is a list of samples, particle sizes and functionalization used in subsequent tables 13-19 with antimicrobial results. The particle size in this table was measured using dynamic light scattering (here and above, unless mentioned otherwise). In some cases the particle size was confirmed by optical absorption or by scanning electron microscopy (SEM). For measurement by dynamic light scattering, the nanoparticle suspensions were diluted in DI water by taking one to two drops of the suspension and adding several ml of water to ensure that a clear (to the eye) solution was obtained in a 1 cm path length cuvette. If the particles were large, the solutions were stirred just before measurement. Several measurements were made to ensure repeatability and reproducibility of samples. Most measurements were carried out using a Malvern Zetasizer Nano ZS light scattering analyzer (available from Malvern Inc, Westborough, Mass.) at ambient temperature, with a backscatter mode at a 173° scattering angle or using DynaPro NanoStar by Wyatt Technologies (Santa Barbara, Calif.), with a Laser Wavelength (nm)=661). Commercial polystyrene spheres with known size (60 nm) were used for instrument calibration. Some of the measurements were also made on the Nanotrac particle analyzer (available from Microtrac Inc, Montgomeryville, Pa.), also in the backscattering mode using a fiberoptic probe. The data was converted and reported in the volume fraction mode.

TABLE 12

| | Preparation | Metal or | | | |
|---|---|---|---|---|---|
| Sample | method | halide (CuI | | Particle | |
| number | (Example#) | purity, %) | Surface Modification | size*, nm | |
| S1 | 25 | AgBr/CuI (98) | PVP-Aldrich | 182 | |
| S2 | 26 | Ag | PVP-Aldrich | 7 | |
| S3 | 27 | AgBr | PVP-Aldrich | 4 | |
| S4 | 28 | CuI (98) | PVP-Aldrich | 4 | |
| S5 | 29 | Ag/AgBr | PVP-Aldrich | Ag = 4, AgBr = 4 | |
| S6 | 30 | Ag/CuI (98) | PVP-Aldrich | Ag = 7, CuI = 4 | |
| S7 | 31 | AgBr/CuI (98) | PVP-Aldrich | CuI = 4, AgBr = 4 | |
| S8 | 26 | Ag | PVP-Aldrich | 6 | |
| S9 | 28 | CuI (98) | PVP-Aldrich | 4 | E |
| S10 | 27 | AgBr | PVP-Aldrich | 4 | E |
| S11 | 26 | Ag | PVP-Aldrich | 7 | E |
| S12 | 28 | CuI (98) | PVP-Aldrich | >15 | E |
| S13 | 37 | Ag₀.₅Cu₀.₅I | PVP-Aldrich | 29 | |
| S14 | 28 | CuI (98) | PVP-Aldrich | >30 | E |
| S15 | 6 | AgBr | Thiomalic acid/ | 25 | E |
| | | | Aspartic acid | | |
| S16 | | | | | |
| S17 | 28 | CuI (98) | PVP-Aldrich | 4 | E |
| S18 | 27 | AgBr | PVP-Aldrich | 4 | E |
| S19 | 27 | AgBr | PVP-Aldrich | 4 | E |
| S20 | 9 | AgBr | Thioglycine/Aspartic acid | 25 | E |
| S21 | 9 | AgBr | Thioglycine/Aspartic acid | 25 | E |
| S22 | 2a | Ag | Thioglycine/Aspartic acid | <20 | E |
| S23 | 2a | Ag | Thioglycine/Aspartic acid | <20 | E |
| S24 | 2b | Ag | Thioglycine/Aspartic acid | <20 | E |
| S25 | 2b | Ag | Thioglycine/Aspartic acid | <20 | E |
| S26 | 28 | CuI (98) | PVP-Aldrich | 4 | E |
| S27 | 33 | CuI (99.999) | PVP- | 4 | E |
| | | | BASF + HNO₃ + CH₃COOH | | |
| S28 | 34 | CuI(99.999) | VP-VA Copolymer- | 4 | E |
| | | | BASF + HNO₃ | | |
| S29 | 35 | | PVP- | 4 | E |
| | | | BASF + HNO₃ + Na₂SO₃ | | |
| S30 | 34 | | VP-VA Copolymer- | 4 | E |
| | | | BASF + HNO₃ + Na₂SO₃ | | |
| S31 | 36 | CuI (99.999) | PVP-BASF + HNO₃ | 4 | |
| S32 | 36 | CuI (99.999) | PVP-BASF + HNO₃ | 263 and 471 | |
| S33 | 28 | CuI (98) | PVP-BASF | 5 | |
| S34 | 24 | CuI (99.999) | PEG(10k, Aldrich) + HNO₃ | 4 | E |
| S34 | 32 | CuCl | PVP-BASF | 4 to 10 E | |
| S35 | 26 | Ag | PVP-Aldrich | 6 | |
| S36 | 27 | AgBr | PVP-Aldrich | 4 | E |
| S37 | Purchased | AgI | PVP (AgI nano from | 25 | |
| | | | ChemPilots) | | |
| S38 | 36a | CuI (99.999) | PVP-BASF + HNO₃ | 4 | |
| S39 | 32 | CuCl | PVP-BASF | <10 | E |
| S40 | | No AM | Porous silica | Silica 0.5 | |
| | | material | | to 3 μm | |
| S41 | 40(1) | CuI (98.5) | Porous silica | Silica 0 to | |
| | | | | 20 μm | |
| S42 | (40(2) | CuI (98.5) | Porous silica, | Silica 0.5 | |
| | | | | to 3 μm | |
| S43 | 28 | CuI(98) | PVP-Aldrich | 6 | |
| S44 | 36b | CuI (99.999) | PVP-BASF + HNO₃ | 1070 | |
| S45 | 36b | No AM | PVP-BASF + HNO₃ | | |
| | | material | | | |
| S46 | 36b | CuI (99.999) | PVP-BASF + HNO₃ | 323 | |
| S47 | 36b | No AM | PVP-BASF + HNO₃ | | |
| | | material | | | |
| S48 | 36b | CuI (99.999) | PVP-BASF + HNO₃ | 315 | |
| S49 | 36b | No AM | PVP-BASF + HNO₃ | | |
| | | material | | | |
| S50 | 36b | CuI (99.999) | PVP-BASF + HNO₃ | 5 | |
| S51 | 42b | CuI (99.5%) | PVP-Aldrich (Ground) | 120 | |
| S52 | 42b | CuI (99.5%) | PVP-Aldrich (Ground) | 220 | |

| | | | | |
|---|---|---|---|---|
| S53 | 42b | CuI (99.5%) | PVP-Aldrich (Ground) | 920 (bimodal |
| | | | | 170 and |
| | | | | 1,500 nm) |

*“E” stands for those particles whose size was estimated. Estimated particle size is based on comparison to previously measured particle sizes for particles made according to the same process.

### Example 46

### Efficacy Against P. Aeruginosa of Various Functionalized Nanoparticles

Table 13 shows the reduction of P. aeruginosa by exposure to various type of metal halide particles and their combinations, and also in different concentrations, sizes and surface modifications. All of these were tested with controls (meaning without metal halide particles or other known antimicrobial materials). The results from control are not shown, as they all uniformly showed either no growth or moderate growth of microbes under the same conditions. Experiments were conducted in duplicate. Further, in many cases, e.g., in Table 13, result R1 (at 24 hr), the results show >4.57 log reduction. In the same table at 24 hrs the result R2 also show >5.34 log reduction. This does not imply that the result in the second case is more effective than in the first, all it says is that given a starting concentration of microbes, at that point there were too few too count. Thus use of the symbol “>” in all of these tables means that the maximum log reduction for that experiment was reached. That is to say, after the indicated time, there were no viable microbes seen. Sample number (starting with “S” in column 2) when stated will correspond to the sample number in Table 12. If exactly the same result number (Column 1, starting with “R”) is used in various tables (Tables 13 to 19), then that corresponds to the same formulation and batch being tested for different microbes. For example R2 result in Table 13 was obtained on P. aeruginosa, and the same suspension was used to obtain the R2 result against S. aureus in Table 14.

TABLE 13
P. aeruginosa

| | | | Conc, | | | | | | |
|---|---|---|---|---|---|---|---|---|---|
| | | | PPM, | Time | | | | | |
| Result | Sample # | Particles | Ag, Cu | 15 min | 30 min | 1 hr | 2 hr | 6 hr | 24 hr |
| R1 | S1 | AgBr/CuI | 10, 100 | | | 0.4 | 0.93* | 1.53* | >4.57 |
| R2 | S8 | Ag | 10, 0 | | | | 0.94 | 1.11 | >5.34 |
| R3 | S3 | AgBr | 10, 0 | | | | 0.95 | 1.07 | >5.34 |
| R4 | S9 | CuI | 0, 59 | | | | >5.34 | >5.34 | >5.34 |
| R5 | S8 + S9 | Ag + AgBr | 10 + 10, 0 | | | | 0.92 | 1.08 | >5.34 |
| R6 | S3 + S9 | AgBr + CuI | 10, 59 | | | | >5.34 | >5.34 | >5.34 |
| R7 | S12 | CuI | 0, 59 | 4.32 | >4.47 | >4.47 | >4.47 | | |
| R8 | S11 + S12 | Ag + CuI | 10, 59 | >4.47 | >4.17 | >4.47 | >4.47 | | |
| R9 | S10 + S12 | AgBr + CuI | 10, 59 | 4.17 | >4.47 | >4.47 | >4.47 | | |
| R10 | S11 + S12 | Ag + CuI | 10, 6 | 0.09 | 0.07 | 0.08 | 0.20 | | |
| R11 | S12 | CuI | 0, 12 | 0.31 | 0.33 | 0.33 | 0.42 | 1.22 | >4.41 |
| R12 | S11 + S12 | Ag + CuI | 2, 12 | 0.3 | 0.3 | 0.42 | 0.46 | 1.32 | >4.41 |
| R13 | S10 + S12 | AgBr + CuI | 2, 12 | 0.34 | 0.25 | 0.34 | 0.41 | 1.13 | >4.41 |
| R14 | S11 + S12 | Ag + CuI | 10, 59 | 2.35 | >4.41 | >4.41 | >4.41 | >4.41 | >4.41 |
| R15 | S15 | AgBr | 10, 0 | | | | 0.05 | 0.91 | >4.40 |
| R16 | S15 + S17 | AgBr + CuI | 10, 59 | 2.22 | 3.36 | 3.75 | >4.25 | >4.40 | |
| R17 | S20 | AgBr | 10, 0 | 0.19 | 0.18 | 0.16 | 0.27 | 3.04 | |
| R18 | S21 | AgBr | 10, 0 | 0.22 | 0.15 | 0.18 | 0.18 | 2.90 | |
| R19 | S20 + S17 | AgBr + CuI | 10, 59 | 1.55 | 2.37 | 3 | 3.69 | >4.73 | |
| R20 | S21 + S17 | AgBr + CuI | 10, 59 | 1.67 | 2.54 | 3.06 | 3.82 | >4.73 | |
| R21 | S24 | Ag | 10, 0 | 0.24 | 0.3 | 0.33 | 0.32 | 0.28 | |
| R22 | S24 + S17 | Ag + CuI | 10, 59 | 3.68 | 4.31 | >4.53 | >4.77 | >4.77 | |
| R23 | S17 | CuI | 0, 59 | 2.30 | 2.97 | 3.81 | 4.76 | >4.77 | |
| R24 | S22 | Ag | 10, 0 | 0.18 | 0.14 | 0.17 | 0.19 | 0.19 | |
| R25 | S22 + S26 | Ag + CuI | 10, 59 | >4.50 | >4.65 | >4.65 | >4.65 | >4.65 | |
| R26 | S26 | CuI | 0, 59 | >4.65 | >4.65 | >4.65 | >4.65 | >4.65 | |
| R27 | S27 | CuI | 0, 59 | >6.76 | >6.76 | >6.76 | >6.76 | >6.76 | |
| R28 | S28 | CuI | 0, 59 | >6.76 | >6.76 | >6.76 | >6.76 | >6.76 | |
| R29 | S31 | CuI | 0, 59 | >4.78 | >4.78 | >4.78 | >4.78 | >4.78 | |
| R30 | S32 | CuI | 0, 59 | 4.11 | >4.78 | 4.36 | 4.54 | >4.78 | |
| R31 | S33 | CuI | 0, 59 | >4.19 | >4.48 | 4.63 | >4.78 | >4.63 | |
| R32 | S35 | Ag | 60, 0 | 0.05 | | −0.05 | −0.02 | 0.06 | 1.57 |
| R33 | S36 | AgBr | 60, 0 | 0.01 | | −0.11 | −0.01 | 0.15 | 3.67 |
| R34 | S37 | AgI | 60, 0 | 0.01 | | 0.01 | 0.06 | 0.19 | 0.29 |
| R35 | S38 | CuI | 0, 60 | >4.56 | | >4.56 | >4.56 | >4.56 | >4.56 |
| R36 | S39 | CuCl | 0, 60 | 0.05 | | 0.03 | 0.19 | 0.47 | 1.21 |
| R37 | S40 | No AM | 0, 0 | 0.24 | | 0.2 | | 0.04 | 0.02 |
| | | material | | | | | | | |
| R38 | S41 | CuI | 0, 19 | 0.97 | | 2.32 | | >4.59 | 3.58 |
| R39 | S42 | CuI | 0, 15 | 1.50 | | 3.89 | | >5.16 | 4.57 |
| R40 | S43 | CuI | 0, 59 | >5.04 | | >5.19 | | >5.19 | >5.19 |
| R41 | S44 | CuI | 0, 59 | >4.73 | | >5.19 | | >5.19 | >5.19 |
| R42 | S45 | No AM | 0, 0 | 0.26 | | 0.30 | | 0.69 | 0.01 |
| | | material | | | | | | | |
| R43 | S46 | CuI | 0, 59 | 5.04 | | >5.19 | | >5.19 | >5.19 |
| R44 | S47 | No AM | 0, 0 | 0.34 | | 0.45 | | 0.66 | 0.07 |
| | | material | | | | | | | |
| R45 | S48 | CuI | 0, 59 | >5.19 | | >5.19 | | >5.19 | >5.19 |
| R46 | S49 | No AM | 0, 0 | 0.28 | | 0.37 | | 0.77 | 0.95 |
| | | material | | | | | | | |
| R47 | S50 | CuI | 0, 59 | >5.19 | | >5.19 | | >5.19 | >5.19 |
| R48 | S51 | CuI | 0, 59 | >4.53 | | >4.53 | | >4.53 | >4.53 |
| R49 | S52 | CuI | 0, 59 | 4.38 | | >4.53 | | >4.53 | >4.53 |
| R50 | S53 | CuI | 0, 59 | 3.91 | | 3.84 | | >4.53 | >4.53 |

Results on P. aeruginosa, a gram negative bacterium, are shown in Table 13. Comparison of R1 and R6 (for CuI and AgBr mixture) in Table 13 shows that when the particle size of CuI is decreased from about 182 to 4 nm along with the changes in the preparation method, the efficacy at 24 hr remains about the same, achieving the maximum log reduction. However, use of the smaller particle size impacts the efficacy at shorter times, producing higher log reductions at shorter times. Result R9 in this table shows that efficacy at much shorter times, i.e., at 15 minutes is surprisingly high. This high efficacy is seen even in those formulations where only CuI is used, such as in R7. All of the above formulations use suspensions with a copper concentration of 59 ppm. Interestingly as seen in R5, when Ag and AgBr with PVP surface modification are combined (both at 10 ppm silver concentration, with a total silver concentration of 20 ppm), their combined efficacy is not much superior to any one of these alone in 10 ppm concentration (R2 and R3), whereas copper iodide efficacy at 59 ppm is much higher than any of these (R4).

When the copper concentration is dropped to 12 ppm, such as in R11, the efficacy at short times suffers, but one is still able to achieve the same efficacy at 24 hrs comparable to R1 which uses larger CuI particles and at higher copper concentration. Addition of silver as silver metal or silver bromide to copper iodide (compare R11 to R12 or R13; or compare R7 to R8 or R9), does not improve the efficacy, showing that CuI by itself is quite effective.

Further, for P. aeruginosa, different surface modifications were used on CuI, such as PVP from Aldrich, PVP from BASF, VP-VA copolymer from BASF, Polyethylene glycol, and even acids for surface peptization (see results R26 to R31), and all of these show that each of these suspensions were maximally effective. Comparison of results R15 on AgBr with R17 and R18 show that in this case surface functionalization type made a difference with thioglycine/aspartic acid being more effective than PVP. Further, comparing AgBr with Ag metal (R17 or R18 when compared with R21) shows that when silver is incorporated as silver bromide (for thioglycine/aspartic acid modification), the formulation is more effective in reducing the microbe concentration. One may also mix different metal halides or metal halide and a metal, and also particles with different surface modifications with high efficacy against P. aeruginosa as shown in numerous results in this table.

Results R32 to R36 compare nanoparticles of various silver salts (AgBr and Agl), silver metal and various copper salts (CuCl and CuI), all of these surface modified with PVP and by themselves only, and all of them at metal concentration of 60 ppm. This data clearly shows CuI has the highest efficacy and the other materials show lower efficacy against this microbe.

Results R37 through R39 were on porous silica particles. R37 was for silica particles with a size in the range of 0.5 to 3 μm which do not have any CuI. Result R38 was for silica particles with a size in the range of 0 to 20 μm which had CuI infused by the method of Example 40 (method 1). The copper metal content in these particles was 1.9% by weight. Result R39 was for silica particles with a size in the range of 0.5 to 3 μm which had CuI infused by the method in Example 41 (method 2). The copper metal content in these particles was 1.5% by weight. These were tested for antimicrobial effect in a suspension, where the silica particles were added with and without CuI. The copper concentration in samples R38 and R39 was 19 and 15 ppm respectively. As expected the sample without antimicrobial additive (result R37) did not show antimicrobial properties. The other two showed a high efficacy.

Results R40 to R47 were for samples S43 to S50 respectively. This series of experiments was done to evaluate the effect on the type of PVP and the effect of the addition of an acid on the particle size of functionalized CuI. Sample S43 was made by the procedure of Example 28 and uses Aldrich PVP and the other samples were made by the procedure of Example 36b and use BASF PVP. PVP from different sources differ in acidity depending on the process used, and may require different levels of pH adjustment. Results R42, R44 and R46 were on samples where acid was added but no CuI. During testing in the buffer solution with microbes, the pH of all solutions was above 6. All samples with CuI showed high antimicrobial activity, and all samples without CuI did not show any appreciable activity. It was surprising that all functionalized particles made by these methods showed high antimicrobial activity although their average sizes varied from about 1,000 mm to 6 nm.

Results R48 to R50 (on samples S51 to S53 respectively) are the results of suspension testing of particles made by wet grinding in the presence of PVP comprising an aqueous solution using the process described in Example 42b. These three samples were obtained from the same run but extracted at different periods of grinding. The average particle size of these three samples was 120, 220 and 920 nm respectively. The last sample, S53 with an average particle size of 920 nm, had a bimodal distribution with particles average sizes peaking at 170 and 1,500 nm. All of these show high antimicrobial efficacy, with the smallest particle size sample (Result R48 on Sample S51) showing a great efficacy at shorter time periods.

### Example 47

### Efficacy Against S. Aureus of Various Functionalized Nanoparticles

TABLE 14
S. aureus

| | | | Conc, | | | | | | |
|---|---|---|---|---|---|---|---|---|---|
| | | | PPM, | Time | | | | | |
| Result# | Sample # | Particles | Ag, Cu | 15 min | 30 min | 1 hr | 2 hr | 6 hr | 24 hr |
| R2 | S8 | Ag | 10, 0 | | | | 0.08 | 0.22 | 4.29 |
| R3 | S3 | AgBr | 10, 0 | | | | 0.46 | 0.39 | >4.44 |
| R4 | S9 | CuI | 0, 59 | | | | >4.44 | >4.44 | >4.44 |
| R5 | S8 + S9 | Ag + AgBr | 10 + 10, 0 | | | | 0.02 | 0.22 | >4.44 |
| R6 | S3 + S9 | AgBr + CuI | 10, 59 | | | | >4.44 | 4.29 | >4.44 |
| R7 | S12 | CuI | 0, 59 | >4.07 | >4.31 | >4.31 | >4.31 | | |
| R8 | S11 + S12 | Ag + CuI | 10, 59 | >4.31 | >4.31 | >4.31 | >4.31 | | |
| R9 | S10 + S12 | AgBr + CuI | 10, 59 | >4.31 | >4.31 | 4.07 | >4.31 | | |
| R10 | S11 + S12 | Ag + CuI | 10, 6 | 0.05 | 0.04 | 0.06 | 0.09 | | |
| R11 | 12 | CuI | 0, 12 | 0.79 | 0.95 | 1.35 | 1.81 | 2.96 | >4.34 |
| R12 | S11 + S12 | Ag + CuI | 2, 12 | 0.69 | 0.88 | 1.20 | 1.66 | 3.16 | >4.34 |
| R13 | S10 + S12 | AgBr + CuI | 2, 12 | 0.79 | 1.04 | 1.30 | 1.71 | 3.03 | >4.34 |
| R14 | S11 + S12 | Ag + CuI | 10, 59 | 0.58 | 2.71 | >4.34 | >4.34 | >4.34 | >4.34 |
| R27 | S27 | CuI | 0, 59 | >6.47 | >5.99 | >6.47 | >6.47 | >6.47 | >6.47 |
| R28 | S28 | CuI | 0, 59 | >6.47 | >6.47 | >6.05 | >6.47 | >6.47 | >6.47 |

Table 14 shows results from similar experimentation on S. aureus, a gram positive bacterium responsible for common staph infections. Comparing R4 to R3 and R2 in this table shows superior effectiveness of copper iodide. Comparing results on Ag metal, AgBr, their combination and CuI, shows similar behavior as for P. aeruginosa, namely that CuI was more effective than either silver metal or silver bromide, or mixture of silver+silver bromide with PVP surface modification. Also CuI in small particle size by itself or mixed with silver metal or silver bromide was highly effective as seen in results R7, R8 and R9. Similar conclusion for S. aureus as for P. aeruginosa can be drawn on concentration of the compounds, mixture of different metal halides or metal halide and a metal, and particles with different surface modifications.

### Example 48

### Efficacy Against S. mutans of Various Functionalized Nanoparticles

TABLE 15
S. mutans

| | | | Conc, | | | | | | |
|---|---|---|---|---|---|---|---|---|---|
| | | | PPM, | Time | | | | | |
| Result# | Sample # | Particles | Ag, Cu | 15 min | 30 min | 1 hr | 2 hr | 6 hr | 24 hr |
| R27 | S27 | CuI | 0, 59 | >4.75 | >4.75 | >4.60 | >4.75 | >4.75 | >4.75 |
| R28 | S28 | CuI | 0, 59 | >4.75 | >4.75 | >4.75 | >4.75 | >4.75 | >4.75 |

To test the broad efficacy of metal halides, and in particular for copper iodide, we also tested functionalized nanoparticles of this material against several other microbes. One of these is a strep bacterium S. mutans, commonly found in mouth infections. R27 and R28 in Table 15 shows that CuI particles modified with PVP and the copolymer (VP-VA) both resulted in effective reduction of populations of this bacteria.

### Example 49

### Efficacy Against S. enterica Typhimurium of Various Functionalized Nanoparticles

TABLE 16
S. enterica Typhimurium

| | | | Conc, | | | | | | |
|---|---|---|---|---|---|---|---|---|---|
| | | | PPM, | Time | | | | | |
| Result# | Sample # | Particles | Ag, Cu | 15 min | 30 min | 1 hr | 2 hr | 6 hr | 24 hr |
| R15 | S15 | AgBr | 10, 0 | 0.26 | 0.47 | 0.57 | 1.52 | >4.85 | |
| R23 | S17 | CuI | 0, 59 | >4.85 | >4.85 | >4.85 | >4.85 | >4.85 | |
| R16 | S15 + S17 | AgBr + CuI | 10, 59 | >4.85 | >4.70 | >4.50 | 4.70 | >4.85 | |

Table 16 shows that at 59 ppm, CuI surface modified with PVP showed a high degree of effectiveness (R23) against the microbe S. enterica when used alone or in combination with AgBr modified with thiomalic and aspartic acids (R16). This was more effective as compared to AgBr alone with a silver concentration of 10 ppm in the suspension (R15).

### Example 50

### Efficacy Against M. fortuitum of Various Functionalized Nanoparticles

TABLE 17
M. fortuitum

| | | | Conc, PPM, | Time | | | | | |
|---|---|---|---|---|---|---|---|---|---|
| Result# | Sample # | Particles | Ag, Cu | 2 hr | 6 hr | 24 hr | 48 hr | 72 hr | 96 hr |
| R2 | S2 | Ag | 10, 0 | | | 2.33 | 3.68 | 4.41 | 5.04 |
| R3 | S3 | AgBr | 10, 0 | | | 1.51 | 1.93 | 1.65 | 2.42 |
| R29 | S4 | CuI | 0, 59 | | | 2.46 | 2.63 | 2.93 | 3 |
| R30 | S2 + S3 | Ag + AgBr | 3.3 + 6.6, 0 | | | 0.59 | 1.28 | 1.41 | 1.95 |
| R31 | S2 + S4 | Ag + CuI | 10, 59 | | | 2.40 | 2.62 | 2.85 | 3.22 |
| R32 | S3 + S4 | AgBr + CuI | 10, 59 | | | 1.91 | 2.71 | 2.91 | 3.02 |
| R15 | S15 | AgBr | 10, 0 | 0.29 | 1.41 | 1.94 | 2.50 | | |
| R23 | S17 | CuI | 0, 59 | 0.79 | 1.69 | 1.35 | 1.41 | | |
| R16 | S15 + S17 | AgBr + CuI | 10, 59 | 1.48 | 1.35 | 1.58 | 1.29 | | |

Table 17 presents data on the antimicrobial effectiveness of these materials against M. fortuitum. In general CuI is effective, when used in the same concentration as with the other microbes. One can increase the concentration of CuI to achieve higher level of effectiveness against this microbe. Strongest reduction was seen by silver metal modified with PVP (R2). This was much stronger than silver bromide (R3) or copper iodide (R29). When Ag or AgBr was combined with CuI (R31 and R32 respectively), the formulation was effective. This type of reduced activity of combinations was not seen for other microbes.

### Example 51

### Efficacy Against Penicillium of Various Functionalized Nanoparticles

TABLE 18
Penicillium

| | | | Conc, | | | | | | |
|---|---|---|---|---|---|---|---|---|---|
| | | | PPM, | Time | | | | | |
| Experiment # | Sample # | Particles | Ag, Cu | 2 hr | 6 hr | 24 hr | 48 hr | 72 hr | 96 hr |
| R27 | S27 | CuI | 0, 59 | | | >3.98 | >3.98 | >3.98 | >3.98 |
| R28 | S28 | CuI | 0, 59 | | | >3.98 | >3.98 | >3.98 | >3.98 |

To examine the effectiveness of the inorganic metal salts against molds, experiments were done against Penicillium as shown in Table 18. R27 and R28 in this table shows that CuI particles modified with PVP and the copolymer (VP-VA) both resulted in effective reduction of this mold.

### Example 52

### Efficacy Against A. niger of Various Functionalized Nanoparticles

TABLE 19
A. niger

| | | | Conc, | | | | | | |
|---|---|---|---|---|---|---|---|---|---|
| | | | PPM, | Time | | | | | |
| Result# | Sample # | Particles | Ag, Cu | 2 hr | 6 hr | 24 hr | 48 hr | 72 hr | 96 hr |
| R33 | S11 | Ag | 50, 0 | | −0.09 | −0.01 | 0.01 | 0.00 | −0.16 |
| R34 | S10 | AgBr | 50, 0 | | 0.06 | −0.14 | 0.16 | 0.21 | 0.15 |
| R35 | S14 | CuI | 0, 295 | | 0.06 | 0.82 | 0.77 | 1.43 | 1.99 |
| R36 | S10 + S14 | AgBr + CuI | 50, 295 | | −0.02 | 0.39 | 0.78 | 0.62 | 0.81 |

Table 19 shows the results for another mold A. niger. The strongest response is shown by CuI (R35) by itself.

### Example 53

### Antimicrobial Testing of Mixed Metal Halide Suspensions (Suspensions Prepared by Methods of Examples 37, 38 and 39)

Antimicrobial testing of Ag—Cu mixed metal halides and their performance comparison with CuI was done using optical density method. FIG. 5 is a plot bar chart of Optical Density (OD, Y-axis) as a measure of growth against the effect of copper iodide particles and Ag—CuI mixed metal halides, and a control. Optical density was measured after treating the bacterial solutions with the nanoparticles of mixed metal halides (or solid solutions of mixed metal halides). Lower optical density implies growth inhibition and showed higher effectiveness. Ag_{0.25}Cu_{0.75}I, Ag_{0.5}Cu_{0.5}I, and Ag_{0.75}Cu_{0.25}I all showed effective antimicrobial properties against P. aureginosa (FIG. 5) and S. aureus (FIG. 6), however, none were as effective as CuI nanoparticles alone (CuI was made as in Example 23). Further, with increasing copper content in the solid solution the efficacy of the material increased.

### Example 54

### Coating of Textiles with Metal Halides and their Antimicrobial Testing

The following methods were used to prepare coating suspensions of functionalized particles and to use these suspensions in coating textile fabrics.

a) Preparation of Particles

GLYMO_{H}-Sol: 0.144 g Formic acid and 1.71 g water respectively were added into 7.5 g Glycidoxypropyltrimethoxysilane (GLYMO) under stirring and kept stirring overnight.

Preparation of AgBr particles (see Example 5)

Preparation of CuI particles (see Example 17)

Preparation of Ag^{o} particles (see Example 3, water used was 5.202 g rather than 9.825 g resulting in silver concentration of 0.61% w/w.)

b) Preparation of Coated Textile Samples

i) Preparation of Coating Suspensions:

Amine cured PEG coating suspension was made using 0.80 g Polyethylene glycol (PEG, MW=1,000) dissolved in 18.056 g water. 5.36 g of GLYMO_{H}-Sol, 6.192 g of AgBr particles, 4.624 g of CuI particles and 4.968 g of 2% \A/4 Jeffamine HK-511 in water respectively were slowly dropped into the PEG solution under stirring. This sol was immediately used to make coatings.

ii) Application of Coating Suspension to Textile Sample

A sample of cotton textile (25×25 cm, untreated cotton Muslin) was washed in hot water and was placed in a beaker with the amine cured PEG coating suspension from Part b) i) above. The textile sample was completely wet by squeezing the coating suspension out of it by hand many times and then soaking it again. Finally the wet substrate was wrung using a mechanical roller type equipment Dyna-Jet Model BL-38 and cured in oven at 120 C for 1 hour. The cured coating had theoretically 1.5% w/w antibacterial material of Ag/Cu=1/1 in mol/mol.

Separately, samples of cotton textile (25×25 cm, untreated cotton canvas) were washed in hot water and placed in a beaker with the coating suspension (polyurethane coating suspension or amine cured PEG suspension). The textile sample was completely wet by squeezing the coating sol out of it by hand many times and then soaking it again. Finally the wet substrate was wrung using Dyna-Jet Model BL-38 and cured in an oven at 120 C for 1 hour.

The antimicrobial effectiveness of fabrics coated with functionalized particles was evaluated using ASTM E 2149-01, incorporated by reference herein in its entirety. Briefly, overnight cultures were adjusted to a final concentration of 1.5×10⁶ in 250 ml Erlenmeyer flasks containing sterile PBS. Fabric samples (5.4 cm×5.4 cm) were introduced to the flask and agitated at 25° C. At appropriate time exposure intervals, 1-ml aliquots were removed and the viable bacteria were enumerated as described previously.

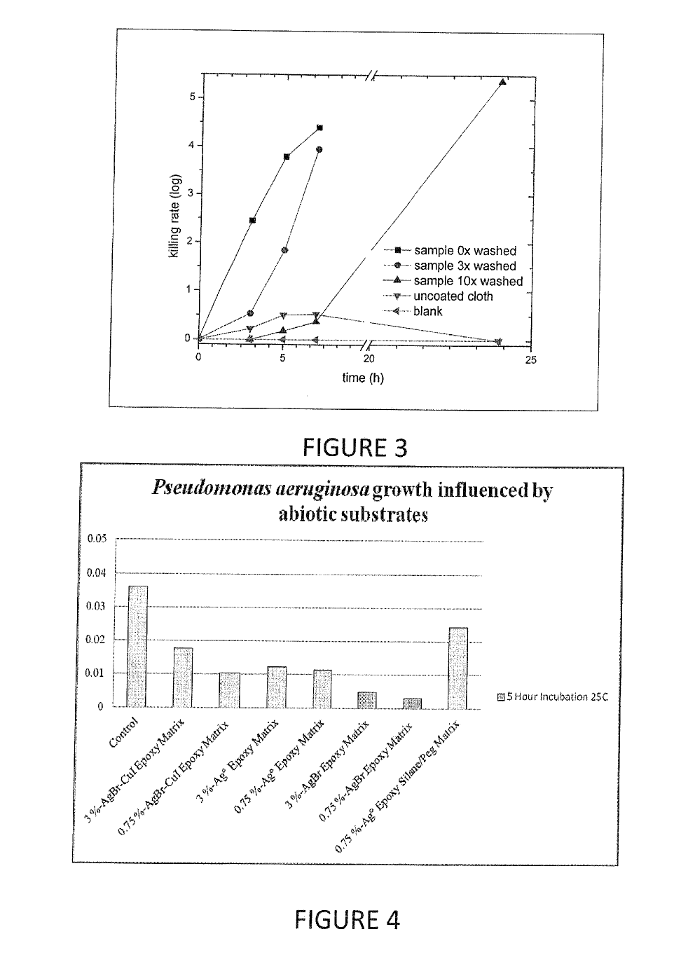

FIG. 3 shows the efficacy of treated fabrics containing functionalized particles of the present invention against P. aeruginosa. Samples were tested both initially and after washing 3 times and 10 times in ordinary household detergent. “Sample 0×” indicates it was never washed; “Sample 3×” was washed three times; and Sample “10×” ten times. An uncoated fabric sample was used as a control.

Reductions in bacterial populations exceeding 4-log₁₀ can readily be obtained using antimicrobial coatings containing the present functionalized particles (FIG. 3). In addition, washing with household detergent introduces a delay in the antimicrobial effect, but does not decrease the antimicrobial effectiveness of the coatings.

### Example 55

### Preparation of Coatings with Metal Halides and their Antimicrobial Testing

a) Preparation of Coating Sols in Organic Epoxy Matrix

The procedure for the preparation of a coating sol containing organic epoxy was as follows: 0.25 g EPON® 8281 (organic epoxy, Miller Stephenson Chemical Co.) and 0.375 g Anquamine® 721 (curing agent and emulsifier, Air Products and Chemicals Inc.) were transferred in a glass bottle and mixed with a spatula until it became milky, homogenous. 1.40 g AgBr-sol (for AgBr-sol preparation see Example 5), 1.04 g CuI-sol (for CuI-sol preparation see Example 17) and 0.155 g water were added into the mixture of EPON® and Anquamine®, and the sol was kept stirring with a spatula and treated in an ultrasonic bath for about 4 minutes to be obtained a homogenous emulsion. The final coating sol has calculated solid content of 14% w/w. The calculated percentage of bioactive material (in metallic form, Ag/Cu=1/1 in mol/mol) in cured coating is 3% w/w in this example. The amounts of components used to make coatings with different bioactive materials are as in Table 20:

TABLE 20

| | 3% | 0.75% | 3% | | | |
|---|---|---|---|---|---|---|
| | Ag/Cu = | Ag/Cu = | Ag | 0.75% | 3% | 0.75% |
| | 1/1 | 1/1 | (Br) | Ag (Br) | Ag° | Ag° |
| EPON ® | 0.25 | 0.25 | 0.25 | 0.25 | 0.25 | 0.25 |
| 8281, g | | | | | | |
| Anquamine ® | 0.375 | 0.375 | 0.375 | 0.375 | 0.375 | 0.375 |
| 721, g | | | | | | |
| AgBr-sol, g | 1.40 | 0.341 | 2.218 | 0.542 | — | — |
| CuI-sol, g | 1.04 | 0.255 | — | — | — | — |
| Ag°-sol, g | — | — | — | — | 2.218 | 0.542 |
| Water, g | 0.155 | 1.928 | 0.379 | 1.98 | 0.379 | 1.98 |

b) Preparation of Coating Suspensions in Epoxy Silane Matrix

The procedure used to prepare a coating suspension containing epoxy silane was as follows: suspensions having a solid content of 14% w/w for making coatings with an epoxy silane matrix were prepared in the same way as described in section a) above but with amounts of the components shown in Table 21:

TABLE 21

| | 0.75% Ag^{o} |
|---|---|
| PEG, g | 0.1 |
| Water, g | 1.545 |
| GLYMO_{H}, g | 0.67 |
| AgBr-NP, g | — |
| CuI-NP, g | — |
| Ag^{o}-NP, g | 0.61 |
| 2% HK-511, g | 0.621 |

c) Application of Coatings to Polystyrene 24-Well Plates

50 μL of one of the coating suspensions prepared in sections a) and b) was transferred using a pipetter into a well of a 24-well plate (Sigma Aldrich, CLS3526-1 EA) and then spread with a spatula over the bottom surface (1.9 cm²) of the well. This step was repeated three times to produce three samples in 3 wells of the 24-well plate. The plate was placed in an oven at 50° C. for 10-15 minutes. Subsequently, another coating of a different suspension was applied to prepare a second coating sample, again prepared in triplicate, following the same procedure. After applying 8 different coatings of different compositions, each in triplicate, the 24-well plate was placed in an oven at 80° C. for 2 hours for final curing.

Provision of antimicrobial coatings on ceramic substrates other than glass (e.g., coatings on crystalline ceramics) can be obtained using methods similar to these to provide antimicrobial coatings on glass. In some cases, the initial treatment with 10% sodium hydroxide solution can be replaced by other chemical treatments known by those skilled in the art to be effective for the specific ceramic substrates.

d) Testing of Antimicrobial Coatings

24-well polystyrene plates (Corning) containing 500 μl trypticase soy broth were inoculated with an overnight culture of P. aeruginosa to an optical density (OD600; Eppendorf Bio Photometer) of 0.05. Plates were incubated at 25° C. for 24 h. Following incubation, 100 μl of supernatant was removed from the wells and the OD600 was determined. The antimicrobial effectiveness of solid bodies coated with functionalized nanoparticles was demonstrated (FIG. 4). It is seen from FIG. 4 that coatings containing functionalized nanoparticles have a pronounced effect in decreasing bacterial populations. It is also seen that the matrix material (control sample) of the coating has a small but measurable effect on the antimicrobial behavior, as shown in the decreased OD associated with the lane marked “control”.

### Example 56

### Preparation of Coatings with CuI and their Antimicrobial Testing

Materials and Methods

For this example two sources for CuI were used. The first was bulk copper iodide powder (99.5% Sigma Aldrich) and the second nano-particles of CuI functionalized with PVP prepared from the acetonitrile process and isolated as a dry powder. For the nano-particles two high loadings of CuI in PVP were prepared namely 60 and 50 wt % CuI in PVP. The CuI used was 99.5% from Sigma Aldrich and the PVP was 10,000 MW from Sigma Aldrich. A typical high loading preparation was as follows.

To a liter pear shaped flask fitted with a stir bar was added 4.05 g of CuI powder and 300 ml of anhydrous acetonitrile. This was stirred to give a pale yellow solution. In a separate flask fitted with a stir were added 4.05 g of PVP and 200 ml of anhydrous acetonitrile. This was stirred for 2 hours to give a straw yellow colored solution. While stirring the CuI solution the PVP solution was slowly added to it to give a transparent yellow solution. Upon stirring at room temperature this solution slowly turned a light green color; this took about one hour for completion. This solution was dried under reduced pressure at 30° C. to form a light green powder with a CuI content of 50 wt %. This procedure was repeated except the initial CuI concentration was increased to 6.07 g to give a concentration of CuI in the powder of 60 wt %.

Preparation of Urethane Coating Containing CuI

To a beaker was added 5 g of an aliphatic urethane 71/N aqueous dispersions (35% solids, maximum viscosity 2000) sold under the tradename of ESACOTE obtained from Lamberti SpA, (Gallarate, Italy). To this was added 0.118 g of CuI powder (99.5% from Sigma Aldrich, particles not functionalized). This was stirred vigorously and 0.1 g of the cross linking agent PZ28 (Polyfunctional Aziridine manufactured by PolyAziridine, LLC Medford, N.J.) was added to the coating formulation. The urethane coating was applied to stainless steel substrates 2″×2″ by brush application and cured at room temperature for 12 hours followed by two hours at 70° C. The cured coating was transparent with a slight brown tint. It was durable and hard with good chemical resistance to both water and ethanol. The Cu⁺ content of the dried coating was 2.0 wt %. This procedure was repeated except using the nano-powders of CuI described above to give coated surfaces with different concentrations/types of Cu⁺. These coated substrates were tested for antimicrobial activity against P. aeruginosa using a method as described below. As a comparison point a metal coated with DuPont antimicrobial (commercial powder coating) ALESTA™ was also tested to (obtained from Dupont, Inc. (Industrial Coatings Division, Wilmington, Del.)). The antimicrobial materials in these coatings were zeolite particles (about 2 to 3 μm in size) infused with silver and zinc ions.

Test Method for evaluating Coatings (Based on Japanese Industrial Standard JIS Z 2801: 2000, incorporated by reference herein in its entirety). Further details of coatings evaluation were discussed earlier.

Test coupons (50×50 mm) were prepared by spraying with 70% ethanol to reduce bacterial background presence. Sample coupons were allowed to air dry before re-spraying with 70% ethanol and allowed to dry completely before testing. Polyethylene (PE) cover slips (40×40 mm) were sterilized via bactericidal UV for 30 minutes per side.

Testing involved preparation of McFarland number 0.5 standardized solution of P. aeruginosa bacteria in PBS from an overnight culture. The standard solution was diluted 1:100 and inoculated onto sample coupons in 400 μL volume drop-wise. Sterile PE films were placed over the inoculated area to ensure wetting of the surface beneath the film. Samples were then incubated in a sealed environment (95% relative humidity) from zero to 24 hours at 25° C. before removal. Bacteria were recovered by swabbing both the coupon surface and the PE film with a cotton-tipped swab pre-dipped in 1 ml of Dey-Engley (D/E) neutralizing broth. The swab was then submersed in a tube containing D/E broth and vortexed to resuspend the bacteria. Test samples were serially diluted in sterile PBS and enumerated with the spread plate method (Eaton et al., “Spread Plate Method,” in Standard Methods for the Examination of Water & Wastewater, 21″ ed., American Public Health Association, Washington, D.C., pp. 9-38-9-40. 9215C, 2005) for 24-48 hours at 37° C. The bacterial reductions were determined by comparison to the recovery of bacteria from control samples consisting of polyurethane-coated coupons without nanoparticles at each exposure interval.

The coating compositions and the results are summarized in Table 22.

TABLE 22

| | | | | Log₁₀ Reduction | |
|---|---|---|---|---|---|
| Wt % Cu⁺ | | Particle | | (P. aeruginosa) | |
| in Coating | Type of CuI used | size* | | 6 hr | 24 hr |
| 2.0 | Bulk Powder | 1 to 2 | μm | 0.31 ± 0.03 | 0.29 ± 0.08 |
| | (99.5%) | | | | |
| 4.3 | CuI nanoparticles | 254 | nm | >5.69 ± 0.00 | >5.69 ± 0.00 |
| | (60 wt % in PVP) | | | | |
| 3.0 | CuI nanoparticles | 241 | nm | >5.49 ± 0.17 | >5.69 ± 0.00 |
| | (50 wt % in PVP) | | | | |
| 0.0 | None | | | −0.02 ± 0.10 | −0.02 ± 0.05 |
| DuPont | None | 2 to 3 | μm | 0.89 ± 0.08 | 4.52 ± 0.00 |
| Crystal | | | | | |
| Clear AM | | | | | |
| coating | | | | | |

*Particle size of CuI or the antimicrobial material (optical microscope used to characterize bulk powder).

These results show that functionalized CuI particles delivered significantly better antimicrobial performance as compared to the commercial antimicrobial coating, especially at the 6-hour mark. It is notable that the use of CuI (as received) as non-functionalized particles in the coatings when used at about 2 μm in size did not result in any perceived antimicrobial activity (see also Table 23, where coatings containing 1% or less Cu⁺ comprising functionalized nanoparticles were notably antimicrobial).

### Example 57

### Preparation of Urethane Coatings Containing Wet Ground CuI Dispersion in Urethane (Emulsion) Resin

Aliphatic urethane 71/N aqueous dispersions (35% solids) sold under the Tradename of ESACOTE™ obtained from Lamberti SpA, (Gallarate, Italy). This was divided in two parts. In one part CuI was added and ground to a small particle size for a duration of 240 minutes as described in Example 42a so that the smaller CuI particles being formed were functionalized by the PU dispersion. These two parts were then mixed in different proportions to vary the amount of copper in the coating formulation. As an example a formulation where these were mixed in a proportion of 50% each by weight was made as follows. To a beaker was added 3 g of an aliphatic urethane 71/N aqueous dispersion was added 3 g of the CuI comprising dispersion. This was mixed well to form a homogeneous material. While stirring 0.12 g of the cross linking agent PZ28 (polyfunctional aziridine manufactured by PolyAziridine, LLC Medford, N.J.) was added to this mixture. The urethane formulation was applied to stainless steel substrates 2″×2″ by brush application and cured at room temperature for 12 hours followed by two hours at 70° C. The cured formulation was transparent with a slight brown tint. It was durable and hard with good chemical resistance to both water and ethanol. The Cu⁺ content of the dried coating was 3.51 wt %. This procedure was repeated by varying the ratio of PU71/N to CuI urethane dispersion to give coated surfaces with different concentrations of Cu⁺ as listed in Table 23. These were tested against P. aeruginosa as described in the above example, and the results are shown in Table 23. In this example, it should be emphasized that polyurethane 71/N aqueous dispersion is an emulsion of a hydrophobic urethane, as after it is coated and dried, this cannot be solvated in water.

TABLE 23

| Ratio PU:(CuI + | Wt % Cu⁺ in | Log₁₀ Reduction | |
|---|---|---|---|
| PU) (by weight) | Dried Coating | 6 hours | 24 hours |
| 10:90 | 6.33 | >6.08 ± 0.05 | >5.98 ± 0.05 |
| 50:50 | 3.51 | 3.24 ± 0.05 | >5.82 ± 0.05 |
| 75:25 | 1.76 | 3.71 ± 0.05 | >5.76 ± 0.05 |
| 90:10 | 0.70 | 3.24 ± 0.05 | >5.98 ± 0.05 |
| 100:0 | 0 | 0.55 ± 0.05 | −0.04 ± 0.08 |

The above results show that incorporation of CuI in the coatings which were prepared by grinding in a polymeric emulsion process resulted in polymer-functionalized CuI particles having high antimicrobial activity. The polymeric emulsion functionalized the CuI surfaces and stabilized the particles as it was pulverized. PU coatings without the copper-based additive did not demonstrate antimicrobial properties, as demonstrated in the 100:0 result of Table 23. Further, the antimicrobial activity increased with the increased CuI content. It is interesting to note that all of these coatings with CuI had better performance at short times as compared to the commercial coating in Table 22.

### Example 58

### Povidone-Iodine Plus Copper Iodide/Polyvinylpyrrolidone Antimicrobial Solution

A copper iodide polyvinylpyrrolidone (PVP) powder is prepared by dissolving 0.0476 g of CuI (99.999% Sigma Aldrich) in 50 ml of anhydrous acetonitrile. To this solution is added 10 g of PVP (10,000 MW Sigma Aldrich) and stirred to faun a pale yellow solution. The acetonitrile is removed under reduced pressure at 30° C. to form a pale green powder. This powder contains 0.158 wt % Cu⁺.

To 10 ml of a 10% solution of Povidone-iodine (CVS brand, obtained from CVS Pharmacy, Tucson, Ariz.) is added 0.38 g of the CuI/PVP powder previously described to give a 60 ppm concentration of Cu⁺ in the solution. This forms the Povidone-iodine-CuI/PVP antimicrobial solution.

### Example 59

### Topical Cream Comprising CuI Nanoparticles: Zone of Inhibition

To prepare this cream, functionalized CuI particles with two different sizes were prepared in PVP.

For the first preparation, the particle size was 241 nm and was made by the procedure described in Example 56 which used 10,000 molecular weight PVP from Sigma Aldrich. This is called 50% Powder (as this had 50% by weight of CuI in the dry powder).

For the second preparation, the particle size was predominantly 4 nm and was prepared in the following fashion. To a reaction flask containing 80 ml of anhydrous acetonitrile, (99.8% Sigma Aldrich Cat. #271004), was added 4.75 g of PVP (Luvitec™ K17 from BASF) and stirred to form a light yellow solution. To this solution was added 0.25 g of CuI (99.999% Sigma Aldrich Cat. #205540) and after stirring for 30 minutes this resulted in a clear pale green solution. Then the bulk of the acetonitrile was removed under reduced pressure at 30° C. to form a viscous paste. The temperature was then increased to 60° C. to completely remove the solvent to give a pale yellow solid. Dynamic light scattering on a dilute sample of the dispersion showed a mean particle size of 4 nm for 85% of the particulate volume, and the others were larger. This had 5 weight % of CuI in the dry powder, and was called 5% Powder.

The cream was prepared in a beaker by adding 0.06 g of Carbomer (obtained from Lubrizol Inc, Wickliffe, Ohio) and 2.0 ml of deionized water (18 Mohm-cm). This was mixed to give a slightly hazy non colorless liquid. To this mixture was added 0.2 g of PVP (Sigma Aldrich, 10,000 molecular weight) and the mixture stirred vigorously. The addition of PVP caused a slight decrease in the viscosity. To this solution was added while stirring 1.96 g of CuI/PVP 50% Powder followed by 1.45 g of CuI/PVP 5% Powder. The final concentration of Cu⁺ in the cream was 2.1 wt %. This cream was tested against P. aeruginosa and S. aureus using the zone of inhibition method as described below.

Petri dishes for the test were prepared by dispensing 25 ml of sterile agar medium into sterile plates. Overnight cultures were diluted to final working optical density 600 nm of 0.100 and uniformly streaked over the agar using sterile swabs. Cylindrical plugs having a diameter of approximately 5.3 mm were removed from the solidified agar plates by means of a sterile cork borer. Approximately 75 μl of cream were added to the wells. Triple antibiotic first aid ointment from Walgreens Pharmacy (Walgreens Brand, obtained from Walgreens Pharmacy, Tucson, Ariz.) was used as a control material. This cream (control) listed Bacitracin zinc 400 units, Neomycin 3.5 mg and Polymyxin B sulfate at 5,000 units as active ingredients in white petrolatum. Plates as described were incubated in a humidified chamber at 37° C. for 24 hours at which time the plates were examined for bactericidal and growth inhibition effects.

Upon examination of the plates a slight bluish-green hue halo was observed around the wells along with a zone of inhibition for CuI comprising creams. A three scale measure was used to determine the zone of inhibition, “0” for no inhibition, which was indicated by complete absence of the zone of inhibition; “1” as limited inhibition, where the zone diameter (including the well) was in the range of 6 to 8 mm; and significant inhibition designated as “2”, when this zone (including the well) exceeded 8 mm. The results are shown in Table 24 below.

TABLE 24

| | Inhibition against | Inhibition against |
|---|---|---|
| Material | P. aeruginosa | S. aureus |
| Control | 0 | 2 |
| Cream with CuI | 2 | 2 |

The control cream is known to be effective against Gram positive microorganisms, and the results show the controls inhibited S. aureus, as expected. The CuI creams of the current formulation show equal effectiveness against S. aureus. Against the Gram negative P. aeruginosa, the control creams were not expected to show efficacy, and they did not. However, the CuI-based cream did show substantial effectiveness, further bolstering the broad antimicrobial nature of the invention.

### Example 60

### Preparation of CuI Particles Surface Modified by Sodiumdodecylsulfate (SDS) by Grinding Process

CuI (99.5% from Aldrich) and SDS (Aldrich #436143) were used for this preparation. The same mill that was used in Example 42a was used to prepare this sample. The mill parameters were: 4200 RPM, Pump=600 RPM, Media used=100 μm diameter YZT, Grinding time=1260 min

Water was allowed to circulate with pump on at 25 rpm and the mill on at 1000 rpm while 94.2854 g CuI (99.5%), and 17.142 g SDS were added (85.7% CuI and 14.3% SDS). This was done to prevent overloading or clogging the mill. The pump and mill speed were then increased to 600 and 4200 respectively. This mixture was ground at these speeds for 1260 minutes using 4.13 kWh. A chiller was used to cool the slurry being ground. A pink mixture was removed from the mill and dried in a blowing furnace because the foaming action of SDS prevents drying on a rotary evaporator. The product was dried in a covered pan at 70° C. until the product was completely dry. This formed a pink/tan solid powder with a yield of 107 g (97.3% yield). Table 25 shows the particle size from dynamic light scattering measurements when this powder was redispersed in water. This table also shows the antimicrobial properties of the liquid suspension when tested at a copper concentration of 59 ppm. The particle size here is relatively large, which may have reduced its efficacy at shorter times as compared to the results in Tables 13 and 14.

TABLE 25

| Particle size (DSL) | | Antimicrobial activity | | | |
|---|---|---|---|---|---|
| Particle | % poly- | (59.07 ppm Cu), log₁₀ reduction | | | |
| Size (nm) | dispersity | Time | | P. aeruginosa | S. aureus |
| 372.2 | 59.4 | 15 | min | 3.60 ± 0.21 | 1.53 ± 0.08 |
| | | 1 | hr | 3.97 ± 0.30 | 3.57 ± 0.04 |
| | | 3 | hr | >4.66 ± 0.00 | >4.50 ± 0.00 |
| | | 6 | hr | >4.66 ± 0.00 | >4.50 ± 0.00 |

### Example 61

### Preparation of Precipitated Porous Silica Infused with CuI

(a) Copper iodide (2 g, 99.5%, Aldrich) was added to a 250 ml round bottom flask along with a stir bar and acetonitrile (40 ml) to give a saturated solution. This saturated solution was then left to stir at room temperature for several hours. The resulting solution was a pale yellow color with a pale yellow precipitate.

(b) This CuI saturated solution was filtered via vacuum filtration using a 0.8 μm MAGNA, nylon, supported plain filter paper by Osmonics.

(c) The clear, pale yellow filtered solution was added to a clean 250 ml round bottom flask with a stir bar and 3.5 g of porous silica (Sipernat 22 LS, 9 μm in size, precipitated Silica with a specific surface area of 180 m2/g, obtained from Evonik Industries). This solution was stirred at 25° C. for one hour.

(d) The solution was again filtered via vacuum filtration using a 0.8 μm MAGNA, nylon, supported plain filter paper by Osmonics (Obtained from Fisher Scientific, Pittsburgh, Pa.). A white silica and CuI containing powder was collected and was left to dry overnight at 100° C.

(e) Copper iodide (2 g, 99.5%) was added to a 250 ml round bottom flask along with a stir bar and acetonitrile (40 ml) to give a saturated solution. This saturated solution was then left to stir at room temperature for several hours. The resulting solution was a pale yellow color with a pale yellow precipitate.

(f) This CuI saturated solution was filtered via vacuum filtration using a 0.8 μm MAGNA, nylon, supported plain filter paper by Osmonics.

(g) The clear, pale yellow filtered solution was added to a clean 250 ml round bottom flask with a stir bar and 3.5 g of porous silica+CuI which was prepared in step “d”. This solution was stirred at 25° C. for one hour.

The solution was again filtered via vacuum filtration using a 0.8 μm MAGNA, nylon, supported plain filter paper by Osmonics. A white powder was collected and was left to dry overnight at 100° C. An analysis showed that this powder was 76.6% silica and 23.4% CuI. Its antimicrobial properties in a suspension at 59 ppm of Cu is shown in table 26, and it is likely that the availability of Cu⁺ ions from antimicrobial particles in porous particles is lower than from the assembly of individual nanoparticles, which leads to lower efficacy as compared to the results in Table 13

TABLE 26
Antimicrobial activity (59.07 ppm Cu), log₁₀ reduction

| | |
|---|---|
| Time | P. aeruginosa |

| | | |
|---|---|---|
| 30 | min | 3.23 ± 0.62 |
| 3 | hrs | 2.96 ± 0.35 |

### Example 62

### Preparation and Testing of Antimicrobial Powder Coatings

The coatings were prepared by first dry blending the functionalized CuI particles (SDS functionalized particles as prepared in Example 60, or porous silica infused with CuI as prepared in example 61) with a carboxylated polyester resin (Crylcoat 2471 obtained from Cytec, Woodland Park, N.J.) containing a crosslinking agent triglycidylisocyanurate (TGIC, obtained from Aal Chem, Grand Rapids, Mich.), a flow/leveling agent Powdermate 570 (obtained from Troy Chemical, Newark, N.J.) and a degasser Powdermate 542 (obtained from Troy Chemical). The concentration of CuI was varied as shown in Table 27. This mixture was then extruded in a two zone temperature process (zone 1=109° C. and zone 2=86° C.) and roller cooled to form a ribbon. This ribbon was crushed and dry blended to form a fine powder. This powder was ultrasonically fed into a Corona gun for powder coating onto 2″×2″×0.025″ aluminum coupons. The coated aluminum substrates were cured at 204° C. for ten minutes under ambient atmosphere. The various coatings had a thickness ranging from high 50 to 75 μm and had a gloss (at 60°) between 100.3 to 126.3). The antimicrobial results are shown in Table 27a. These coatings are compared with coatings deposited from a commercial antimicrobial powder material Alesta PFC609S9A from Dupont (Experimental Station, Del.) which was also deposited in a similar fashion as above on similar substrates. These coatings have silver and zinc ions to provide antimicrobial properties. All of these coatings with antimicrobial material (including the one from Dupont) resulted in antimicrobial surfaces. However, at shorter times, all of the coatings with CuI provided superior efficacy as seen by greater log reduction.

TABLE 27a

| | Log₁₀ reduction of the microbe | | | |
|---|---|---|---|---|
| | P. aeruginosa | P. aeruginosa | S. aureus | S. aureus |
| Sample | (6 Hrs) | (24 Hrs | (6 hrs) | (24 hrs) |
| 0.25% Cu | >5.63 | >5.43 | >4.77 | >5.31 |
| (with SDS) | | | | |
| 1.0% Cu (with | >5.63 | >5.83 | >5.72 | >5.31 |
| SDS) | | | | |
| 3.0% Cu (with | >5.63 | >6.03 | >5.72 | >5.31 |
| SDS) | | | | |
| 0.25% Cu (in | >5.53 | 4.34 | 5.23 | >5.31 |
| Silica) | | | | |
| DuPont AM | 1.79 | 5.73 | 3.29 | 4.65 |
| coating | | | | |
| Standard | −0.19 | −0.59 | 0.16 | 0.57 |
| polyester resin | | | | |
| (No AM) | | | | |

The samples were cleaned after the evaluation by rinsing them twice in ethanol, washing them with a dish washing liquid and followed by another two rinses in ethanol. The antimicrobial effectiveness of the samples was evaluated against S. aureus. The results are shown in Table 27b and demonstrate that the samples are durable to washing and repeated use.

TABLE 27b

| | Log₁₀ reduction of the microbe | |
|---|---|---|
| | S. aureus | S. aureus |
| Sample | (6 hrs) | (24 hrs) |
| 0.25% Cu (with SDS) | 4.58 | >4.65 |
| 1.0% Cu (with SDS) | >5.35 | >4.75 |
| 3.0% Cu (with SDS) | >5.35 | >4.65 |
| 0.25% Cu (in Silica) | 4.23 | >4.31 |
| Standard polyester resin (No AM) | −0.09 | 0.53 |

### Example 63

### Formation of Functionalized Particles by Wet Grinding

The samples were ground in a wet grinding mill produced by Netzsch Premier Technologies LLC (Exton Pa.), equipment model was Minicer®. The grinding beads were made of YTZ ceramic. The interior of the mill was also ceramic lined. The materials used for these preparations are outlined in Table 28.

TABLE 28

| Material | Description |
|---|---|
| AuI | Gold iodide, Aldrich 398411 |
| AgI | Silver iodide, 204404 |
| Bioterge | Sodium capryl sulfonate (aq); BIOTERGE PAS-8S (obtained |
| | from Stepan, Northfield, IL) |
| Chitosan | Deacetylated chitin, medium molecular weight, Aldrich |
| | 448877 |
| CuI | Copper iodide 99.5% Aldrich 03140 |
| CuSCN | Copper thiocyanate, Aldrich 298212 |
| PEG | Polyethylene glycol CARBOWAX ™ SENTRY ™ PEG 8000 |
| | NF, FCC Grade; Macrogol 8000 Ph. Eur, Granular, |
| | (obtained from Dow Chemical, Midland, MI) |
| PVP-A | Polyvinylpyrrolidone Avg MW = 10,000, Aldrich PVP10 |
| PVP-B | Polyvinylpyrrolidone Avg MW = 10,000, Luvitex K17 |
| | 57858045 (Obtained from BASF, Germany) |
| SDS | Sodium dodecyl sulfate, Aldrich 436143 |
| ZnO | Zinc oxide, Aldrich 251607 |
| H2O | Deionized water, 18 megaohm-cm |
| Ascorbic | L-Ascorbic acid >99%, Aldrich 95210 |
| Acid | |
| UV | 2-Hydroxy-4-(octyloxy)benzophenone 98%, Aldrich 413151 |
| stabilizer | |
| IPA | Isopropyl alcohol, 99.5% Aldrich 278475 |

Table 29 shows various samples which were processed along with the conditions under which these were made. During grinding operation, the grinding head was chilled using a coolant at 5° C. However, depending on the viscosity, volume of material being ground and grinding conditions the grinding liquid temperature varied between 10 and 30° C. The quantity of grinding beads was measured volumetrically as approximately 140 ml.

TABLE 29

| | Solids Proportion by | | | | | | | |
|---|---|---|---|---|---|---|---|---|
| | Weight % | | Total | | | | Media | Grinding |
| | Metal | Functionalization | Solids | Water | Mill | Pump | Size | Time |
| Sample | Compound, % | agent(s), % | (g) | (mL) | (RPM) | (RPM) | (mm) | (min) |
| 1. CuI/PEG | CuI, 15 | PEG, 85 | 10 | 100 | 4200 | 600 | 0.1 | 960 |
| 2. CuI/PEG/ | CuI, 20 | PEG, 77.61; | 10 | 100 | 4200 | 600 | 0.1 | 60 |
| SDS | | SDS, 2.39 | | | | | | |
| 3. CuI/PVP | CuI, 0.47 | PVP-B, 99.53 | 60.29 | 300 | 3800 | 500 | 0.1 | 360 |
| 4. CuI/PVP | CuI, 10 | PVP-B, 90 | 10 | 100 | 4200 | 600 | 0.1 | 60 |
| 5. CuI/PVP/SDS | CuI, 20 | PVP-A, 77.61; | 10 | 100 | 4200 | 600 | 0.1 | 300 |
| | | SDS, 2.39 | | | | | | |
| 6. CuI/SDS | CuI, 85.7 | SDS, 14.3 | 0.7 | 140 | 2500 | 350 | 0.3 | 420 |
| 7. CuSCN | CuSCN, | PVP-A, 90 | 1 | 100 | 4200 | 600 | 0.1 | 172 |
| | 10 | | | | | | | |
| 8. AuI | AuI, 0.21 | PVP-A, 99.79 | 5.01 | 100 | 4200 | 600 | 0.1 | 120 |
| 9. AgI | AgI, 10 | PVP-A, 90 | 10 | 100 | 4200 | 600 | 0.1 | 1070 |
| 10. ZnO | ZnO, 10 | PVP-B, 90 | 10 | 100 | 4200 | 600 | 0.1 | 60 |
| 11. CuI/CH | CuI, 50 | Chitosan, 50 | 2 | 100 mL + 2 g | 4200 | 600 | 0.1 | 60 |
| (Chitosan) | | | | acetic | | | | |
| | | | | acid | | | | |
| 12. CuI/CH/PVP | CuI, 10 | Chitosan, 10; | 10 | 100 mL + | 4200 | 600 | 0.1 | 60 |
| | | PVP-B, 80 | | 1.5 g acetic | | | | |
| | | | | acid | | | | |
| 13. CuI/PEG/ | CuI, 85.7 | Bioterge, 4.3; | 3 | 200 | 4200 | 600 | 0.1 | 30 |
| Bioterge | | PEG, 10 | | | | | | |
| 14. CuI/Ascor | CuI, 85.7 | Ascorbic acid, | 0.7 | 200 | 4200 | 600 | 0.1 | 30 |
| acid | | 14.3 | | | | | | |
| 15. CuI/UV | CuI, 20 | UV Stabilizer, | 2.5 | 10 mL + | 4000 | 600 | 0.1 | 1000 |
| Stabilizer | | 80 | | 190 mL IPA | | | | |
| 16. AgBr/PVP | AgBr, 10 | PVP-B, 90 | 10 | 100 | 4000 | 600 | 0.1 | 60 |

Table 30 shows the results of average particle size. Tables 31 and 32 show antimicrobial activity of select samples against P. aeruginosa and S. aureus respectively. Some of these formulations were made to verify the viability of grinding different materials with different functionalizing agents and to see if these will result in particle sizes with good antimicrobial activity. Under the specific processing conditions utilized for that sample, sometimes a bimodal or a trimodal particle size distribution was seen (measured by light scattering). In those cases where most of the mass was represented by a single fraction, other fractions are not shown. Unless stated otherwise, the antimicrobial properties were typically measured at 59 ppm of metal concentration (concentration in the testing solution). The concentrations of the functionalization agents in the testing solutions are also shown in Tables 31 and 32.

By varying the conditions of grinding and the formulation composition it was possible to vary the average particle size from about 3 to about 1,000 nm. It was also possible to obtain larger particle sizes, but attention was focused on obtaining particles smaller than about 200 nm. In general long grinding times and small, concentration of the material being ground favored the formation of smaller particles (e.g., see sample #3). It was also found, however, that it was possible to achieve attractive antimicrobial properties with modest grinding times (e.g., see samples 2, 4 and 11 to 14). It is also possible to introduce large fractions of CuI (greater than 10%) relative to the functionalizing agents, e.g., in samples 6, 13 and 14 the amount exceeds 80%. This stands in contrast to most chemical syntheses of CuI (see Examples 33 to 36a) where the percentage of CuI to the surface functionalizing agent does not exceed 5% and is typically notably smaller than 5%

When such high concentration of functionalizing materials are used as in the chemical synthesis route, then the addition of the functionalized antimicrobial material to a matrix material involves the introduction of a large amount of functionalizing material, This can often impact negatively the properties of the end-products produced, particularly for solid products.

It has also been demonstrated that it is possible to grind and functionalize other metal salts including metal halides, and metal oxides, e.g. CuSCN, AuI, AgI, ZnO and AgBr samples 7, 8, 9, 10 and 16 respectively. Sample 15 shows preparation of CuI functionalized with a UV stabilizer.

TABLE 30
Particle Size

| | Solids Proportion by Weight % | | |
|---|---|---|---|
| | | Function- | Particle |
| | Metal | alization | Size* by |
| Sample | Compound, % | agent(s), % | Mass % |
| 1. CuI/PEG | CuI, 15 | PEG, 85 | 95% is 10 nm |
| 2. CuI/PEG/SDS | CuI, 20 | PEG, 77.61; | 83% is 26 nm, |
| | | SDS, 2.39 | 17% is 140 nm |
| 3. CuI/PVP | CuI, 0.47 | PVP-B, 99.53 | 93% is 3 nm, |
| | | | 5% is 17 nm |
| 4. CuI/PVP | CuI, 10 | PVP-B, 90 | 65% is 10 nm, |
| | | | 35% is 120 nm |
| 5. CuI/PVP/SDS | CuI, 20 | PVP-A, 77.61; | 89% is 6 nm, |
| | | SDS, 2.39 | 11% is 117 nm |
| 6. CuI/SDS | CuI, 85.7 | SDS, 14.3 | 75% is 20 nm, |
| | | | 25% is 120 |
| 7. CuSCN | CuSCN, 10 | PVP-A, 90 | 75% is 180 nm, |
| | | | 25% is 50 nm |
| 8. AuI | AuI, 0.21 | PVP-A, 99.79 | 99% is 4 nm |
| 9. AgI | AgI, 10 | PVP-A, 90 | 99% is 3 nm |
| 10. ZnO | ZnO, 10 | PVP-B, 90 | 93% is 120 nm |
| 11. CuI/CH | CuI, 50 | Chitosan, 50 | 22% is 14 nm, |
| (Chitosan) | | | 78% is 1371 nm |
| 12. CuI/CH/PVP | CuI, 10 | Chitosan, 10; | 81% is 9 nm, |
| | | PVP-B, 80 | 19% is 808 nm |
| 13. CuI/PEG/ | CuI, 85.7 | Bioterge, 4.3; | 82% is 30 nm, |
| Bioterge | | PEG, 10 | 18% is 150 |
| 14. CuI/Ascorbic | CuI, 85.7 | Ascorbic acid, | N/A |
| acid | | 14.3 | |
| 15. CuI/UV | CuI, 85.7 | UV Stabilizer, | 100% is 410 nm |
| Stabilizer | | 14.3 | |
| 16. AgBr/PVP | AgBr, 10 | PVP-B, 90 | 96% 744 nm, |
| | | | 4% 165 nm |

Some of the dry powders (after grinding was over and the particles were dried in a roto-evaporator) were examined under an optical microscope. The particles of the dried cluster were found to be in the range of 570 nm to 2 microns for sample 6 and for sample 13 it was in the range of about 1 to 2 microns. This shows clusters of particles are formed upon drying, particularly when a polymeric agent (PEG in this case) is present.

TABLE 31
antimicrobial test results against P. aeruginosa

| | | | Log₁₀ reduction of | | | | | |
|---|---|---|---|---|---|---|---|---|
| | Metal, | Functionalization | P. aeruginosa after given time | | | | | |
| Sample | (ppm) | agent(s) (ppm) | 5 min | 15 min | 30 min | 1 hr | 3 hr | 6 hr |
| 1. CuI/PEG | Not tested | | | | | | | |
| 2. CuI/PEG/SDS | Cu, | PEG, (688); SDS | | | >4.77 ± 0.00 | | >4.77 ± 0.00 | |
| | (59.07) | (21) | | | | | | |
| 3. CuI/PVP | Cu, | PVP-B, (37527) | | 4.33 ± 0.34 | | 4.57 ± 0.00 | >4.42 ± 0.21 | >4.57 ± 0.00 |
| | (59.07) | | | | | | | |
| 4. CuI/PVP | Cu, | PVP-B, (1595) | | >4.64 ± 0.00 | | >4.64 ± 0.00 | >4.64 ± 0.00 | |
| | (59.07) | | | | | | | |
| 5. CuI/PVP/SDS | Cu, | PVP-A, (688); SDS | | | 4.59 ± 0.00 | | >4.60 ± 0.00 | |
| | (59.07) | (1) | | | | | | |
| 6. CuI/SDS | Cu, | SDS, (30) | | 3.60 ± 0.21 | | 3.97 ± 0.30 | >4.66 ± 0.00 | >4.66 ± 0.00 |
| | (59.07) | | | | | | | |
| 7. CuSCN | Cu, | PVP-A, (1015) | | 0.51 ± 0.04 | | 3.95 ± 0.21 | 4.88 ± 0.00 | |
| | (59.07) | | | | | | | |
| 8. AuI | Au, | PVP-A, 46034 | | | >5.07 ± 0.00 | | >5.07 ± 0.00 | |
| | (59.07) | | | | | | | |
| 9. AgI | Ag, (10) | PVP-A, (196) | | 0.10 ± 0.09 | | −0.07 ± 0.15 | 0.19 ± 0.21 | |
| | Ag, | PVP-A, (1159) | | | | | | |
| | (59.07) | | | | | | | |
| | Ag, | PVP-A, (3924) | | | | | | |
| | (200) | | | | | | | |
| 10. ZnO | Not tested | | | | | | | |
| 11. CuI/CH | Cu, | Chitosan, (177) | 1.36 ± 0.11 | >4.60 ± 0.00 | | >4.60 ± 0.00 | | |
| (Chitosan) | (59.07) | | | | | | | |
| 12. CuI/CH/PVP | Cu, | Chitosan, (177); | 1.63 ± 0.04 | >4.60 ± 0.00 | | >4.60 ± 0.00 | | |
| | (59.07) | PVP-B, (1418) | | | | | | |
| 13. CuI/PEG/Bioterge | Cu, | Bioterge, (9); PEG, | | | | | | |
| | (59.07) | (21) | | | | | | |
| 14. CuI/Ascorbic | Cu, | Ascorbic acid,(30) | | | | | | |
| acid | 59.07 | | | | | | | |

TABLE 32
antimicrobial test results against S. aureus

| | Metal, | Functionalization | Log₁₀ reduction of S. aureus after given time | | | | | |
|---|---|---|---|---|---|---|---|---|
| Sample | (ppm) | agent(s) (ppm) | 5 min | 15 min | 30 min | 1 hr | 3 hr | 6 hr |
| 1. Cul/PEG | Not Tested | | | | | | | |
| 2. CuI/PEG/SDS | Cu, | PEG, (688); SDS | | | 3.97 ± 0.00 | | >4.27 ± 0.00 | |
| | (59.07) | (21) | | | | | | |
| 3. CuI/PVP | Cu, | PVP-B, (37527) | | | | | | |
| | (59.07) | | | | | | | |
| 4. CuI/PVP | Cu, | PVP-B, (1595) | | 2.36 ± 0.06 | | >4.38 ± 0.00 | >4.38 ± 0.00 | |
| | (59.07) | | | | | | | |
| 5. CuI/PVP/SDS | Cu, | PVP-A, (688); SDS | | | | | | |
| | (59.07) | (21) | | | | | | |
| 6. CuI/SDS | Cu, | SDS, (30) | | 1.53 ± 0.08 | | 3.57 ± 0.04 | >4.50 ± 0.00 | >4.50 ± 0.00 |
| | (59.07) | | | | | | | |
| 7. CuSCN | Cu, | PVP-A, (1015) | | 0.27 ± 0.06 | | 0.56 ± 0.01 | 2.83 ± 0.07 | |
| | (59.07) | | | | | | | |
| 8. AuI | Au, | PVP-A, (46034) | | 0 | | | | |
| | (59.07) | | | | | | | |
| 9. AgI | Ag, | PVP-A, (196) | | 0.08 ± 0.05 | | 0.01 ± 0.00 | 0.14 ± 0.00 | |
| | (10) | | | | | | | |
| | Ag, | PVP-A, (1159) | | | 0.59 ± 0.02 | | 3.94 ± 0.10 | |
| | (59.07) | | | | | | | |
| | Ag, | PVP-A, (3924) | | | >4.71 ± 0.00 | | >4.71 ± 0.00 | |
| | (200) | | | | | | | |
| 10. ZnO | Not tested | | | | | | | |
| 11. CuI/CH | Cu, | Chitosan, (177) | | | | | | |
| (Chitosan) | (59.07) | | | | | | | |
| 12. CuI/CH/PVP | Cu, | Chitosan, (177); | | | | | | |
| | (59.07) | PVP-B, 1418 | | | | | | |
| 13. CuI/PEG/Bioterge | Cu, | Bioterge, (9); | 0.019 ± 0.06 | 1.68 ± 0.07 | | >4.53 ± 0.00 | | |
| | (59.07) | PEG, (21) | | | | | | |
| 14. CuI/Ascorbic | Cu, | Ascorbic acid, | >4.60 ± 0.00 | >4.60 ± 0.00 | | >4.60 ± 0.00 | | |
| acid | (59.07) | (30) | | | | | | |

The antimicrobial properties of the samples in Tables 29 and 30 are shown in Tables 31 and 32. Table 31 shows the antimicrobial properties when tested against P. aeruginosa and Table 32 shows the antimicrobial properties against S. aureus. Some materials were tested for both microbes and several were only tested for one of them. Good antimicrobial properties were obtained with the AuI suspensions. However, such suspensions were black in color and for those objects where color is an issue, this material will not meet the product requirements. The tests for AgI were carried out at 10, 59 and 200 ppm Ag and for CuI at 59 ppm Cu. These results on S. aureus in Table 32 show that AgI was quite ineffective at 10 and 59 ppm Ag, whereas it showed good antimicrobial property at 200 ppm. This shows that copper iodide is a more effective antimicrobial material as compared to silver iodide at lower concentrations (see several results on CuI at 59 ppm) in this table and also results presented previously (e.g., Tables 13 and 14).

It was also found that CuI exhibited greater antimicrobial effectiveness at short times (e.g., 15 minutes) than CuSCN (compare sample 3 vs sample 7 in Table 31), although CuSCN exhibited attractive antimicrobial properties at longer times. Chitosan is not soluble in water, but it is soluble in water when a small amount of acetic acid was added, and hence could be used as a functionalization agent in aqueous media. Chitson functionalized CuI (sample 11) exhibited high antimicrobial effectiveness in times as short as 15 minutes. CuI functionalized with ascorbic acid exhibited outstanding antimicrobial effectiveness in times as short as after 5 minutes (see sample 14 in Table 32). In several cases more than one functionalization agent was used, e.g., samples 2, 5, 12 and 13. All of these produced attractive antimicrobial effectiveness.

Although the copper concentration (as copper salt) in most formulations was 59 ppm, changes in the copper concentration would lead to changes in antimicrobial effectiveness.

For example, increasing the copper concentration would produce increased antimicrobial effectiveness at a given time and comparable antimicrobial effectiveness at shorter times.

### Example 64

### Antimicrobial Activity Against Trichophyton mentagrophytes Fungus

T. mentagrophytes is a common nail fungus. To test the efficacy of the AM material, CuI nanoparticles functionalized with PVP were made following Example 23. The proportions of the materials used were different. 300 ml of acetonitrile, 60 g of PVP along with 0.2856 of CuI was used. The particle size of the functionalized particles was 6 nm. The log₁₀ reduction in the fungus using a liquid suspension with Cu concentration at 59 ppm (as CuI) was evaluated at 6, 24 and 48, hr and was found to be 1.02, 2.93 and 2.99, respectively, which shows a high degree of effectiveness.

### Example 65

### Wound Dressing Preparation and Antimicrobial Testing

(a) Solution for Preparation of Wound Dressings without Antimicrobial Material

A solution was made with (a) 1.62 g sodium carboxymethyl cellulose (molecular weight (Mw) 700,000 obtained from Sigma Aldrich, Cat #419338) and (b) 80 g DI-H2O. This solution was stirred while heating at 70° C. to give a clear, viscous, colorless solution.

(b) Solution for Preparation of Wound Dressings with Functionalized CuI Particles (Resulted in 1 wt % Cu (as CuI) in Dry Solid)

A solution was made with (a) 0.0590 g CuI/PEG/Bio-terge Powder (28.57% Cu (as CuI) in powder), prepared as Sample 13 in Example 63 except that the grinding time was 13 minutes instead of 30 minutes (the average CuI particle size was about 320 nm with polydispersity being 168%), (b) 80 g DI-H2O. This solution was stirred at room temperature and sonicated to give an opaque, white solution. At the end of this process, 1.62 g sodium carboxymethyl cellulose (molecular weight (Mw) 700,000). This solution was stirred while heating at 70° C. to give an opaque, viscous, slightly green solution.

### (c) Preparation of Wound Dressing

One ply, white Kimtech Pure CL5 #06179, 50% rayon/50% polyester cleanroom wipes from Kimberly Clark Professional (Roswell, Ga.) were cut into 2″×2″ pieces to use as gauze pieces for coating the above solutions for testing of wound dressings. The 2″×2″ gauze pieces were first weighed before coating. They were then placed on a piece of glass and were pre-wetted by hand with 0.9 ml DI-H2O using a syringe. Solutions used for the wound dressing application were prepared as given below and 1 ml volume of one of these solutions was then evenly applied to the pre-wetted wipe by hand using a syringe.

The coated gauze pieces were then dried in the oven for 30-40 minutes at 70° C. Once dried the gauze pieces were removed from the glass and were weighed again to determine the total solids content. Applying 1 ml of the coating solutions to the gauze gave an average solids content of 0.02 g. Wipes were also prepared with solids content higher than 0.02 g, including single and multiple coating applications. After coating, the standard gauze pieces (no antimicrobial) were white in color and the copper containing gauze pieces were a pale green color. These coated gauze pieces were then tested against P. aeruginosa as follows.

(d) Testing of Dressings Against P. aeruginosa

A single colony of P. aeruginosa was cultured overnight to stationary phase in tryptic soy broth (TSB). The following day, the culture was diluted in TSB to read 0.1 optical density in a Synergy 2 reader (from Biotek Instruments Inc, Winooski, Vt.) Following this, 0.25 ml of culture was plated onto petri dishes containing tryptic soy agar (TSA). Gauze samples were then placed onto individual plates, one sample per plate. The total solid content on each gauze piece averages 0.02 g, with the copper content (in the form of CuI) being 1% of this mass. Each section was pressed firmly onto the agar on the plate to ensure homogeneous surface contact. The bacteria in contact with the gauze were allowed to grow for 72, and 96 hours, one plate per time-point. After each time-point the respective gauze sample was removed and the newly exposed area was swabbed with a sterile loop, which in turn was spread over a clean agar plate. This was allowed to grow for 24 hrs, after which visual inspection of the plate produces the following observations: 72 hrs Cu-gauze completely killed the bacteria originally plated under it, while the standard gauze displayed a heavy bacterial growth. The 96 hour gauze assay produced results identical to the 72 hr testing.

### Example 65

### Comparison of PU Coatings Made by Grinding CuI in Emulsion, Vs, Grinding CuI with SDS and then Adding these to the Emulsion

In this preparation, CuI was ground with SDS (see Example 60). The composition after grinding was dried and then added to the polyurethane emulsion described in Example 56. In this example the CuI was not ground with the emulsion, but particles functionalized (pre-functionalized) with the surfactant were added and mechanically mixed into the PU emulsion. These were then coated on 5 cm×5 cm stainless steel coupons and evaluated for antimicrobial efficacy with and without CuI additive. The samples with CuI had a copper concentration of 1% in the dry coating. The results in Table 33 show that these samples were antimicrobial. These samples can be compared to coatings prepared by grinding CuI in PU emulsion, where this data is shown in Table 34. Samples produced by both methods exhibited very attractive antimicrobial properties.

TABLE 33
Pre-functionalized CuI particles added to PU coating emulsion

| | Log₁₀ Reduction P. aeurginosa | | Log₁₀ Reduction S. aureus | |
|---|---|---|---|---|
| Time | With CuI | Without CuI | With CuI | Without CuI |
| 24 hr | 4.05 | −0.49 | >4.47 | 0.21 |

TABLE 34
Functionalized particles formed by
grinding CuI in PU coating emulsion

| | Log₁₀ Reduction P. aeurginosa | | Log₁₀ Reduction S. aureus | |
|---|---|---|---|---|
| Time | With CuI | Without CuI | With CuI | Without CuI |
| 24 hr | >5.04 | −0.49 | >5.15 | 0.15 |

### Example 66

### Nail Polish with Antimicrobial Additive and Testing

In order to demonstrate the incorporation of antimicrobial particles in to a nail polish, a commercial water based nail polish was evaluated. A water-based nail polish WaterColors Clear water-based nail enamel, was obtained from Honeybee Gardens Inc. (Leesport, Pa. The ingredients from the labels of these products were listed in Table 33.

TABLE 33
Ingredients

Water, water-miscible acrylic, polyurethane formers and thickeners, non-
ionic soaps. May contain: ultramarine blue, carmine, mica, iron oxides,
and/or titanium dioxide

The weight percent solids of the nail polish was determined by allowing a measured amount to dry in air for greater than 24 hours at ambient temperature and determining the weight loss upon drying.

The particles used were prepared by the grinding method with a composition of 85.7% CuI and 14.3% Bioterge PAS-8S. The grinding conditions are shown in Table 34. The average particle size was 320 nm. Dry copper iodide based antimicrobial powders were incorporated in the nail polishes at 1 wt % Cu (3 wt % CuI) by mechanical mixing.

TABLE 34

| Solids Proportion by Weight % | | Total | | | | Media | Grinding |
|---|---|---|---|---|---|---|---|
| Metal | Functionalization | Solids | Water | Mill | Pump | Size | Time |
| Compound, % | agent(s), % | (g) | (mL) | (RPM) | (RPM) | (mm) | (min) |
| CuI, 85.7 | Bioterge, 14.3 | 3 | 200 | 4200 | 600 | 0.1 | 30 |

Nail polish with the antimicrobial additive were coated on 2-inch square, stainless steel substrates and allowed to dry for greater than 24 hours. Nail polishes without the antimicrobial additive were coated in the same fashion to serve as standards. All of these coatings were evaluated for antimicrobial activity in the manner discussed earlier for other coatings. Over 24 hour period the control sample showed a log₁₀ reduction of −1.16 (which shows growth), while the reduction in samples with the antimicrobial additive was 5.89. This shows a strong antimicrobial activity in samples with functionalized CuI particles.

It will be understood that various modifications may be made to the embodiments disclosed herein. Hence the above description should not be construed as limiting, but merely as exemplifications of preferred embodiments. Those skilled in the art will envision other modifications that come within the scope and spirit of the claims appended hereto. All patents and references cited herein are explicitly incorporated by reference in their entirety.

We claim:

1. A method for forming a composition having antimicrobial activity comprising the steps of
(a) providing a powder comprising at least one metal oxide or metal salt; and
(b) grinding said powder in a liquid medium containing a surface functionalization agent, to produce functionalized ground particles having an average particle size of less than about 1000 nm.

2. The method of claim 1, wherein said surface functionalization agent has a molecular weight of at least 60.

3. The method of claim 2, including the step of drying the functionalized ground particles to produce dried material containing a plurality of functionalized particles.

4. The method of claim 3, wherein said dried material containing a plurality of functionalized particles has an average size of at least about 1 micron.

5. The method of claim 3, wherein said dried material containing a plurality of functionalized particles has an average size of at least about 10 microns.

6. The method of claim 2, wherein said surface functionalization agent comprises a surfactant selected from the group consisting of an anionic surfactant, an amphoteric surfactant and a nonionic surfactant.

7. The method of claim 6, wherein said surfactant comprises an anionic surfactant selected from a group consisting of sodium lauryl sulfate, sodium dodecyl sulphate, sodium capryl sulfonate.

8. The method of claim 2, wherein said surface functionalization agent comprises a polymer.

9. The method of claim 8, wherein said polymer comprises at least one of polyvinylpyrrolidone, polyethylene oxide, carboxy methyl cellulose, polystyrenesulfonic acid and chitosan.

10. The method of claim 2, wherein said surface functionalization agent comprises an acidic material.

11. The method of claim 10, wherein said acidic material comprises ascorbic acid.

12. The method of claim 2, wherein said surface functionalizing agent comprises at least one agent selected from the group consisting of a UV stabilizer, a plasticizer, a thermal stabilizer, an oxidation protector and a photoinitiator.

13. The method of claim 1, wherein said liquid medium includes a polymer binder.

14. The method of claim 2, wherein said liquid medium further includes one or more additives selected from the group consisting of a UV stabilizer, a plasticizer, a thermal stabilizer and an oxidation protector.

15. The method of claim 2, wherein said metal salt comprises CuI.

16. The method of claim 2, wherein said metal salt comprises CuCl.

17. The method of claim 2, wherein said metal salt comprises AgBr.

18. The method of claim 2, wherein said metal salt comprises AgI.

19. The method of claim 2, wherein said metal salt comprises an organic copper salt.

20. The method of claim 19, wherein said organic copper salt comprises CuSCN.

21. The method of claim 2, wherein said metal oxide comprises Cu2O.

22. The method of claim 2, wherein said liquid medium further includes one or more additives selected from the group consisting of a UV stabilizer, a plasticizer, a thermal stabilizer and an oxidation protector.

23. The method of claim 1, wherein the color of said metal salt or metal oxide has an L* value greater than 70 on a color scale of L*a*b*.

24. The method of claim 1, wherein the color of said metal salt or metal oxide has an L* value greater than 80 on a color scale of L*a*b*.

25. The method of claim 1, wherein the color of said metal salt or metal oxide has a color on the L*a*b* scale at least one of
(a) L* value greater than 65 with the a* and the b* values within ±5
(b) L* value greater than 70 with the a* and the b* values within ±15
(c) L* value greater than 75 with the a* and the b* values within ±20
(d) L* value greater than 80 with the a* and the b* values within ±25

26. The method of claim 1, wherein said liquid medium comprises an aqueous medium.

27. The method of claim 1, wherein said liquid medium comprises a non-aqueous medium.

28. The method of claim 1, wherein said powder is ground to an average particle size of less than about 300 nm.

29. The method of claim 1, wherein said powder is ground to an average particle size of less than about 100 nm.

30. The method of claim 1, including the step of adding the functionalized ground particles or the dried material containing a plurality of functionalized ground particles to a carrier selected from the group consisting of a cream, a gel, a coating solution, a foam and a solid material.

31. The method of claim 30, wherein the amount of the metal salts or metal oxides in the cream, gel, coating solution, foam or solid is less than 5 wt %.

32. The method of claim 30, wherein said functionalized ground particles or dried material containing a plurality of functionalized ground particles are added to other materials to produce
a. an antimicrobial powder coating
b. an antimicrobial anodized coating;
c. an antimicrobial coating prepared from liquid solutions;
d. an antimicrobial adhesive;
e. an antimicrobial wound dressing;
f. an antimicrobial nail polish;
g. an antimicrobial shampoo;
h. an antimicrobial body wash;
i. an antimicrobial leather product;
j. an antimicrobial plasticized PVC;
k. an antimicrobial thermoplastic;
l. an antimicrobial thermosetting resin;
m. an antimicrobial polymeric foam;
n. an antimicrobial hair care product; or
o. an antimicrobial aerosol product.

33. The method of claim 30, wherein the functionalized ground particles or the material containing a plurality of functionalized ground particles are incorporated into a carrier for use:
a. as antimicrobial agents, administer orally, via IV infusion or via inhalation;
b. in or on coatings for implants;
c. in or on constituents of implants;
d. in or on sutures and medical devices;
e. in or on pacemaker housings and leads;
f. in or on filters for water supplies and air handling systems
g. in or on clothing for medical personnel;
h. in or as coatings on or direct incorporation in components of ventilators, air ducts, cooling coils and radiators for use in buildings or transportation;
i. in or on masks;
j. in or on medical and surgical gloves;
k. in or on textiles including bedding, towels, undergarments and socks;
l. in or on upholstery, carpets and other textiles, particularly wherein the particles are incorporated into the fibers, and gaskets;
m. in or as coatings on furniture for public use;
n. in or as wall coatings of buildings;
o. in or on walls, floors, appliances, bathroom surfaces, handles, knobs, tables and seating;
p. in or as coatings on and constituents of shopping bags;
q. in or as coatings on school desks;
r. in or as coatings on plastic containers and trays;
s. in or as coatings on leather, purses, wallets and shoes;
t. in or as coatings on shower heads;
u. in or on self-disinfecting cloths;
v. in or as coatings on bathroom sinks and toilet seats;
w. in or as coatings on bottles containing medical or ophthalmic solutions;
x. in or as coatings on or direct incorporation in keyboards, switches, knobs, handles, steering wheels, remote controls, of automobiles, cell phones and other portable electronics;
y. in or as coatings on toys, books and other articles for children;
z. in or as coatings on gambling chips, gaming machines and dice;
aa. in topical creams for medical use including use on wounds, cuts, burns, skin and nail infections;
bb. in shampoos for treating chronic scalp infections;
cc. in or as coatings on handles of shopping carts;
dd. on or as coatings on cribs and bassinets;
ee. in or as coatings for infant's bottles;
ff. in or as coatings or direct incorporation in personal items/use such as toothbrushes, hair curlers/straighteners, combs and hair brushes, nail polish;
gg. in or as coatings on currency, including paper, tissue paper, plastic and metal;
hh. in or as coatings or direct incorporation in sporting goods such as tennis rackets, golf clubs, golf balls and fishing rods;
ii. in adhesives used in bandages, wound dressings;
jj. in anti-odor formulations, including applications for personal hygiene such as deodorants;
kk. in or on objects and in coatings to prevent formation of biofilms, particularly in medical and marine applications;
ll. in dental applications—coatings on implants, incorporation in primers, sealants, adhesives and composite fillings used for tooth restoration, incorporation in denture materials;
mm. in molded and extruded products including waste containers, devices, tubing, films, bags, liners and foam products;
nn. in flexible and rigid foams;
oo. in or as coatings for flowers and flower heads;
pp. in the treatment of aqueous systems, including water cooling systems, cooling towers, pulp and paper mill systems, water and slurry transportation and storage, recreational water systems, air washer systems, decorative fountains, food, beverage, and industrial process pasteurizers, desalination systems, gas scrubber systems, latex systems, industrial lubricants, cutting fluids,
qq. in preventing microbial proliferation in waste in portable toilets.

34. A method for forming a composition having antimicrobial activity comprising the steps of
(a) providing a powder comprising at least one metal oxide or metal salt;
(b) grinding said powder in a liquid medium to an average particle size of less than about 1000 nm; and
(c) blending the ground powder/liquid medium from step (b) with a surface functionalization agent to functionalize surfaces of the ground particles.

35. The method of claim 34, wherein said surface functionalization agent has a molecular weight of at least 60.

36. The method of claim 34, including the step of drying the functionalized ground particles from step (c) to produce dried material containing a plurality of functionalized particles.

37. The method of claim 36, wherein the dried material containing a plurality of functionalized particles has an average size of at least about 1 micron.

38. The method of claim 36, wherein the dried material containing a plurality of functionalized particles has an average size of at least about 10 microns.

39. The method of claim 36, wherein said surface functionalization agent comprises a surfactant selected from the group consisting of an anionic surfactant, an amphoteric surfactant and a nonionic surfactant.

40. The method of claim 39, wherein said surfactant comprises an anionic surfactant selected from a group consisting of sodium lauryl sulfate, sodium dodecyl sulphate, sodium capryl sulfonate.

41. The method of claim 35, wherein said surface functionalization agent comprises a polymer.

42. The method of claim 41, wherein said polymer comprises at least one of polyvinylpyrrolidone, polyethylene oxide, carboxy methyl cellulose, polystyrenesulfonic acid and chitosan.

43. The method of claim 35, wherein said surface functionalization agent comprises an acidic material.

44. The method of claim 43, wherein said acidic material comprises ascorbic acid.

45. The method of claim 35, wherein said surface functionalizing agent comprises at least one agent selected from the group consisting of a UV stabilizer, a plasticizer, a thermal stabilizer, an oxidation protector, and a photoinitiator.

46. The method of claim 34, wherein the liquid medium includes a polymer binder.

47. The method of claim 35, wherein said metal salt comprises CuI.

48. The method of claim 35, wherein said metal salt comprises CuCl.

49. The method of claim 35, wherein said metal salt comprises AgBr.

50. The method of claim 35, wherein said metal salt comprises AgI.

51. The method of claim 35, wherein said metal salt comprises an organic copper salt.

52. The method of claim 51, wherein said organic copper salt comprises CuSCN.

53. The method of claim 35, wherein said metal oxide comprises Cu₂O.

54. The method of claim 34, wherein said liquid medium further includes one or more additives selected from the group consisting of an UV stabilizer, a plasticizer, a thermal stabilizer and an oxidation protector.

55. The method of claim 35, wherein the color of said metal salt or metal oxide has an L* value greater than 70 on a color scale of L*a*b*.

56. The method of claim 35, wherein the color of said metal salt or metal oxide has an L* value greater than 80 on a color scale of L*a*b*.

57. The method of claim 34, wherein said liquid medium comprises an aqueous medium.

58. The method of claim 34, wherein said liquid medium comprises a non-aqueous medium.

59. The method of claim 34, wherein said powder is ground to an average particle size of less than about 300 nm.

60. The method of claim 34, wherein said powder is ground to an average particle size of less than about 100 nm.

61. The method of claim 34, including the step of adding the functionalized ground particles or dried material containing a plurality of functionalized particles to a carrier selected from the group consisting of a cream, a gel, a coating solution, a foam and a solid material.

62. The method of claim 61, wherein the amount of the metal salts or metal oxides in said cream, gel, coating solution, foam or solid material is less than 5 wt %.

63. The method of claim 61, wherein said functionalized ground particles or dried material containing a plurality of functionalized particles are added to other materials to produce
a. an antimicrobial powder coating
b. an antimicrobial anodized coating;
c. an antimicrobial coating prepared from liquid solutions;
d. an antimicrobial adhesive;
e. an antimicrobial wound dressing;
f. an antimicrobial nail polish;
g. an antimicrobial shampoo;
h. an antimicrobial body wash;
i. an antimicrobial leather product;
j. an antimicrobial plasticized PVC;
k. an antimicrobial thermoplastic;
l. an antimicrobial thermosetting resin;
m. an antimicrobial polymeric foam;
n. an antimicrobial hair care product; or
o. an antimicrobial aerosol product.

64. The method of claim 61, wherein said functionalized ground particles or dried material containing a plurality of functionalized particles are incorporated into a carrier for use:
a. as antimicrobial agents, administer orally, via IV infusion or via inhalation;
b. in or on coatings for implants;
c. in or on constituents of implants;
d. in or on sutures and medical devices;
e. in or on pacemaker housings and leads;
f. in or on filters for water supplies and air
g. in or on clothing for medical personnel;
h. in or as coatings on or direct incorporation in components of ventilators, air ducts, cooling coils and radiators for use in buildings or transportation;
i. in or on masks;
j. in or on medical and surgical gloves;
k. in or on textiles including bedding, towels, undergarments and socks;
l. in or on upholstery, carpets and other textiles, particularly wherein the particles are incorporated into the fibers and gaskets;
m. in or as coatings on furniture for public use, as in hospitals, doctors' offices and restaurants;
n. in or as wall coatings of buildings;
o. in or on walls, floors, appliances, bathroom surfaces, handles, knobs, tables and seating;
p. in or as coatings on and constituents of shopping bags;
q. in or as coatings on school desks;
r. in or as coatings on plastic containers and trays;
s. in or as coatings on leather, purses, wallets and shoes;
t. in or as coatings on shower heads;
u. in or on self-disinfecting cloths;
v. in or as coatings on bathroom sinks and toilet seats;
w. in or as coatings on bottles containing medical or ophthalmic solutions;
x. in or as coatings on or direct incorporation in keyboards, switches, knobs, handles, steering wheels, remote controls, of automobiles, cell phones and other portable electronics;
y. in or as coatings on toys, books and other articles for children;
z. in or as coatings on gambling chips, gaming machines, dice, etc.
aa. in topical creams for medical use including use on wounds, cuts, burns, skin and nail infections;
bb. in shampoos for treating chronic scalp infections;
cc. in or as coatings on handles of shopping carts;
dd. on or as coatings on cribs and bassinets;
ee. in or as bottle coatings for infant's bottles;
ff. in or as coatings or direct incorporation in personal items/use such as toothbrushes, hair curlers/straighteners, combs and hair brushes, nail polish;
gg. in or as coatings on currency, including paper, tissue paper, plastic and metal;
hh. in or as coatings or direct incorporation in sporting goods such as tennis rackets, golf clubs, golf balls and fishing rods;
ii. in adhesives used in bandages, wound dressings;
jj. in anti-odor formulations, including applications for personal hygiene such as deodorants;
kk. in or on objects and in coatings to prevent formation of biofilms, particularly in medical and marine applications;
ll. in dental applications—coatings on implants, incorporation in primers, sealants, adhesives and composite fillings used for tooth restoration, incorporation in denture materials;
mm. in molded and extruded products including waste containers, devices, tubing, gaskets films, bags, liners and foam products;
nn. in flexible and rigid foams;
oo. in or as coatings of flowers and flower heads;
pp. in the treatment of aqueous systems, including water cooling systems, cooling towers, pulp and paper mill systems, water and slurry transportation and storage, recreational water systems, air washer systems, decorative fountains, food, beverage, and industrial process pasteurizers, desalination systems, gas scrubber systems, latex systems, industrial lubricants, cutting fluids; and
qq. in preventing microbial proliferation in waste in portable toilet systems

65. The method of claim 20, wherein the color of said metal salt or metal oxide has a color on the L*a*b* scale at least one of
(a) L* value greater than 65 with the a* and the b* values within ±5
(b) L* value greater than 70 with the a* and the b* values within ±15
(c) L* value greater than 75 with the a* and the b* values within ±20
(d) L* value greater than 80 with the a* and the b* values within ±25.

66. A method for forming a composition having antimicrobial activity comprising the steps of
(a) providing a metal halide powder having a water solubility of less than about 100 mg/liter comprising at least one of CuCl, CuI, AgCl, AgBr and AgI; and
(b) grinding said powder in a liquid medium containing a surface functionalization agent with a molecular weight of at least 60, to produce functionalized ground particles having an average particle size of less than about 1000 nm.

67. The method of claim 66, wherein the color of the said metal halide has a color on the L*a*b* scale at least one of
(a) L* value greater than 65 with the a* and the b* values within ±5
(b) L* value greater than 70 with the a* and the b* values within ±15
(c) L* value greater than 75 with the a* and the b* values within ±20
(d) L* value greater than 80 with the a* and the b* values within ±25.

68. The method of claim 66 wherein said surface functionalization agent comprises at least one of an anionic surfactant, a polymer, ascorbic acid, a photoinitiator, and a plasticizer,

69. The method of claim 66, including the step of drying the functionalized ground particles to produce dried material with an average size of at least about 1 microns containing a plurality of functionalized particles.

70. The method of claim 66 including the step of adding the functionalized ground particles or dried material containing a plurality of functionalized particles to a carrier selected from the group consisting of a cream, a gel, a coating solution, a foam and a solid material, wherein the amount of the metal halides in said cream, gel, coating solution, foam or solid material is less than 5 wt %.

71. The method of claim 70, wherein said functionalized ground particles or dried material containing a plurality of functionalized particles are added to other materials to produce
a. an antimicrobial powder coating
b. an antimicrobial anodized coating;
c. an antimicrobial coating prepared from liquid solutions;
d. an antimicrobial adhesive;
e. an antimicrobial wound dressing;
f. an antimicrobial nail polish;
g. an antimicrobial shampoo;
h. an antimicrobial body wash;
i. an antimicrobial leather product;
j. an antimicrobial plasticized PVC;
k. an antimicrobial thermoplastic;
l. an antimicrobial thermosetting resin;
m. an antimicrobial polymeric foam;
n. an antimicrobial hair care product; or
o. an antimicrobial aerosol product.

72. The method of claim 70, wherein said functionalized ground particles or dried material containing a plurality of functionalized particles are incorporated into a carrier for use:
a. as antimicrobial agents, administer orally, via IV infusion or via inhalation;
b. in or on coatings for implants;
c. in or on constituents of implants;
d. in or on sutures and medical devices;
e. in or on pacemaker housings and leads;
f. in or on filters for water supplies and air
g. in or on clothing for medical personnel;
h. in or as coatings on or direct incorporation in components of ventilators, air ducts, cooling coils and radiators for use in buildings or transportation;
i. in or on masks;
j. in or on medical and surgical gloves;
k. in or on textiles including bedding, towels, undergarments and socks;
l. in or on upholstery, carpets and other textiles, particularly wherein the particles are incorporated into the fibers, and gaskets;
m. in or as coatings on furniture for public use, as in hospitals, doctors' offices and restaurants;
n. in or as wall coatings of buildings;
o. in or on walls, floors, appliances, bathroom surfaces, handles, knobs, tables and seating;
p. in or as coatings on and constituents of shopping bags;
q. in or as coatings on school desks;
r. in or as coatings on plastic containers and trays;
s. in or as coatings on leather, purses, wallets and shoes;
t. in or as coatings on shower heads;
u. in or on self-disinfecting cloths;
v. in or as coatings on bathroom sinks and toilet seats;
w. in or as coatings on bottles containing medical or ophthalmic solutions;
x. in or as coatings on or direct incorporation in keyboards, switches, knobs, handles, steering wheels, remote controls, of automobiles, cell phones and other portable electronics;
y. in or as coatings on toys, books and other articles for children;
z. in or as coatings on gambling chips, gaming machines and dice;
aa. in topical creams for medical use including use on wounds, cuts, burns, skin and nail infections;
bb. in shampoos for treating chronic scalp infections;
cc. in or as coatings on handles of shopping carts;
dd. on or as coatings on cribs and bassinets;
ee. in or as bottle coatings for infant's bottles;
ff. in or as coatings or direct incorporation in personal items/use such as toothbrushes, hair curlers/straighteners, combs and hair brushes, nail polish;
gg. in or as coatings on currency, including paper, tissue paper, plastic and metal;
hh. in or as coatings or direct incorporation in sporting goods such as tennis rackets, golf clubs, golf balls and fishing rods;
ii. in adhesives used in bandages, wound dressings;
jj. in anti-odor formulations, including applications for personal hygiene such as deodorants;
kk. in or on objects and in coatings to prevent formation of biofilms, particularly in medical and marine applications;
ll. in dental applications—coatings on implants, incorporation in primers, sealants, adhesives and composite fillings used for tooth restoration, incorporation in denture materials;
mm. in molded and extruded products including waste containers, devices, tubing, gaskets, films, bags, liners and foam products;
nn. in flexible and rigid foams;
pp. in or as coatings of flowers and flower heads;
pp. in the treatment of aqueous systems, including water cooling systems, cooling towers, pulp and paper mill systems, water and slurry transportation and storage, recreational water systems, air washer systems, decorative fountains, food, beverage, and industrial process pasteurizers, desalination systems, gas scrubber systems, latex systems, industrial lubricants, cutting fluids; and
qq. in preventing microbial proliferation in waste in portable toilet systems
